(19) United States
(12) Patent Application Publication
(10) Pub. No.: US 2012/0212375 A1
(43) Pub. Date: Aug. 23, 2012

(54) Quantum broadband antenna

(76) Inventor: William Frederick Depree, IV, Washington, DC (US)

(21) Appl. No.: 12/932,227

(22) Filed: Feb. 22, 2011

(51) Int. Cl. H01Q 1/38; B82Y 99/00

(52) U.S. Cl. 343/700 MS; 977/762

(57) ABSTRACT

The abstract core in this new antennae where acoustic surface waves strike the active surface states that are Hertzian sine cosine transparent piezoelectric and electro-optical acoustic substrate metal box springs is a Gauge transformation, invariance of Maxwell's equation under Gauge transformation is produced in this transparent nano metal box springs symmetry of two-stack design is analogues to the invariance of Einstein's equation under local arbitrary coordinate transformation's general covariance. This proved that Maxwell's equations are virtually the only equations that are both Gauge and Lorentz invariant. This Gauge/gravity duality of anti-de-Sitter/conformal field of oval loop quantum gravity coupling constance in which the use of manmade metamaterials that reconnect nature's gap to produce the folding and holding of the breaking and expanding of various symmetries of AdS 4 of these superconducting metamaterials with sectorial zoning boundary selector separators at coordinate points indicated in the overlapping dome Venn diagram design of the oval loop quantum gravity near grazing angle of an incident that is reflected into the surface at #29 and #36. The conclusion is that the Hertzian sine cosine metal box springs design and new metamaterials transforms the frequencies selectors and transporters from global to local invariance in quantum mechanics is the equivalent to the existence of the classical electromagnetic field described by Maxwell, Einstein, Lorentz, Schrodinger, Heisenberg, Dirac, Gauge, Riemann, Hall, and Gauss.

### CROSS REFERENCES TO RELATED APPLICATION

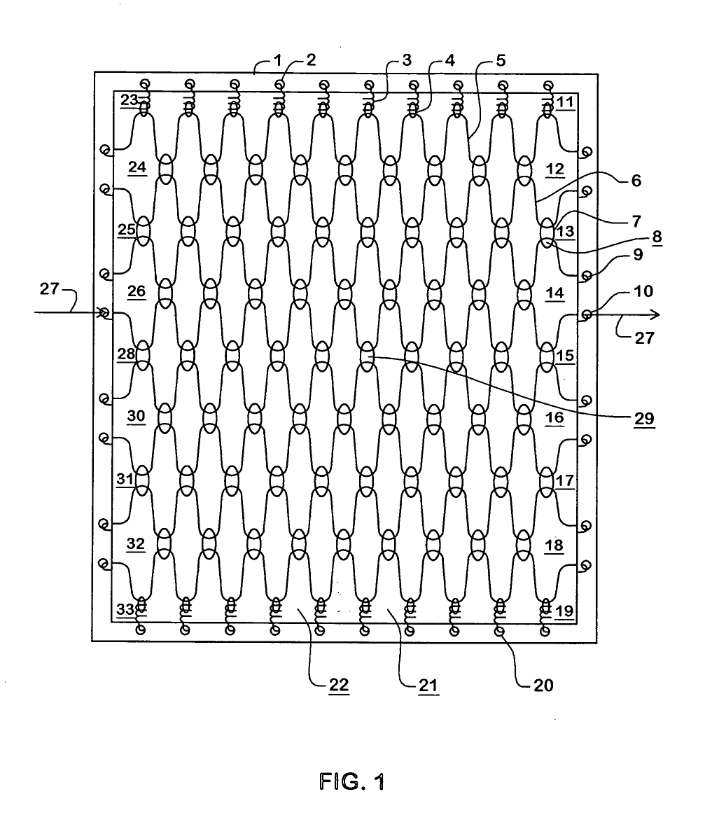

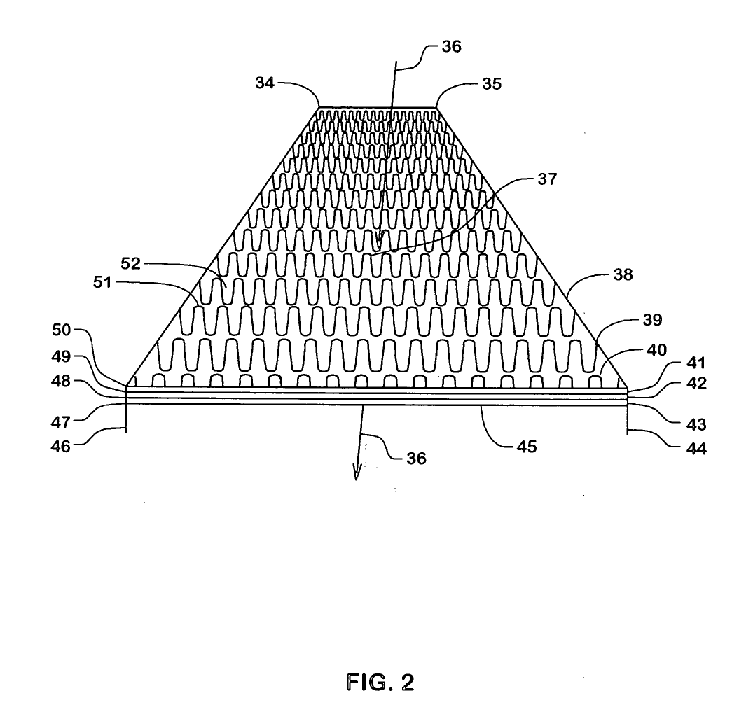

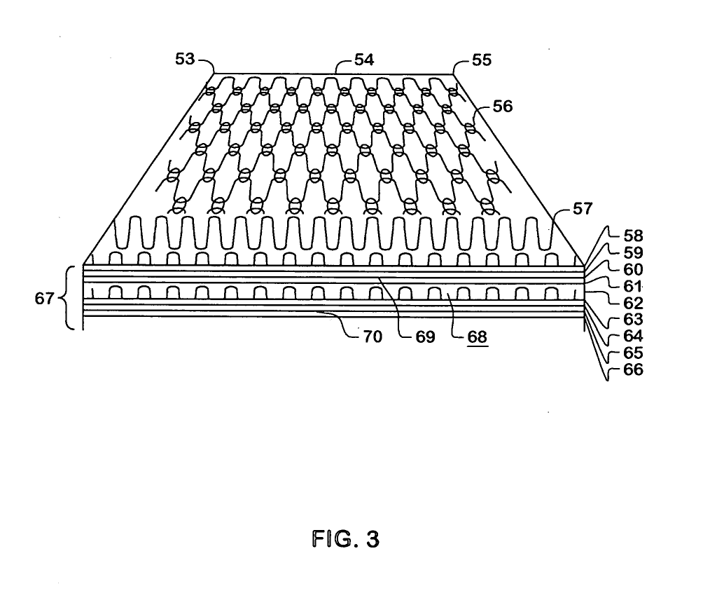

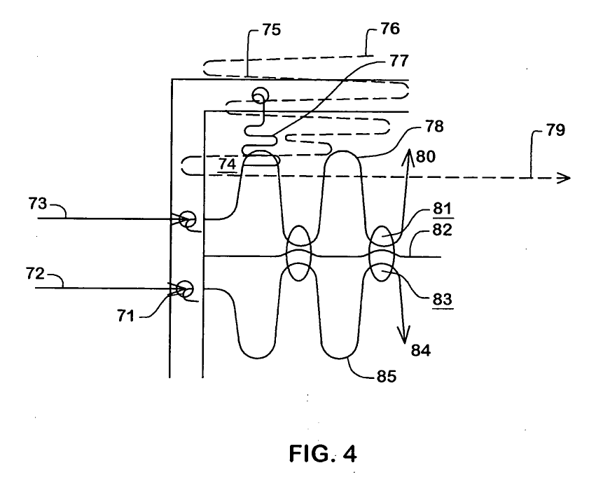

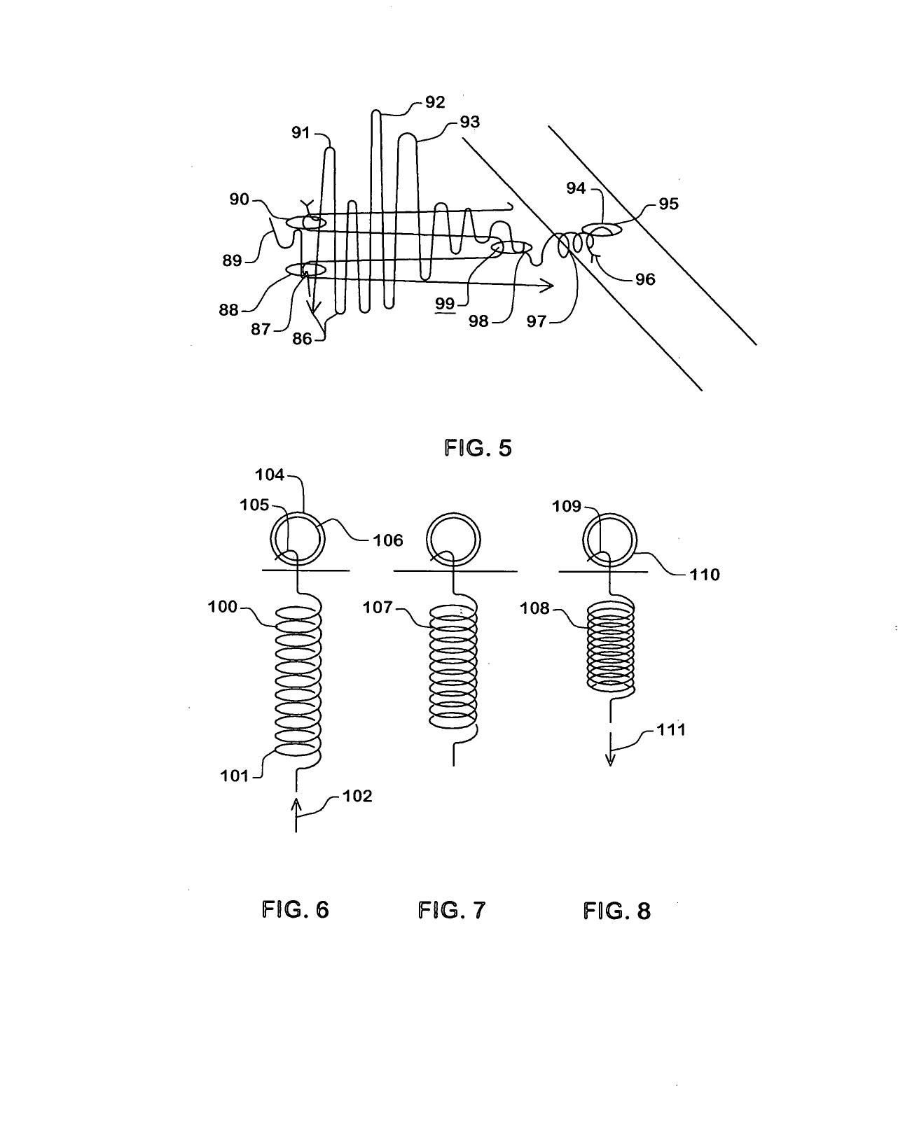

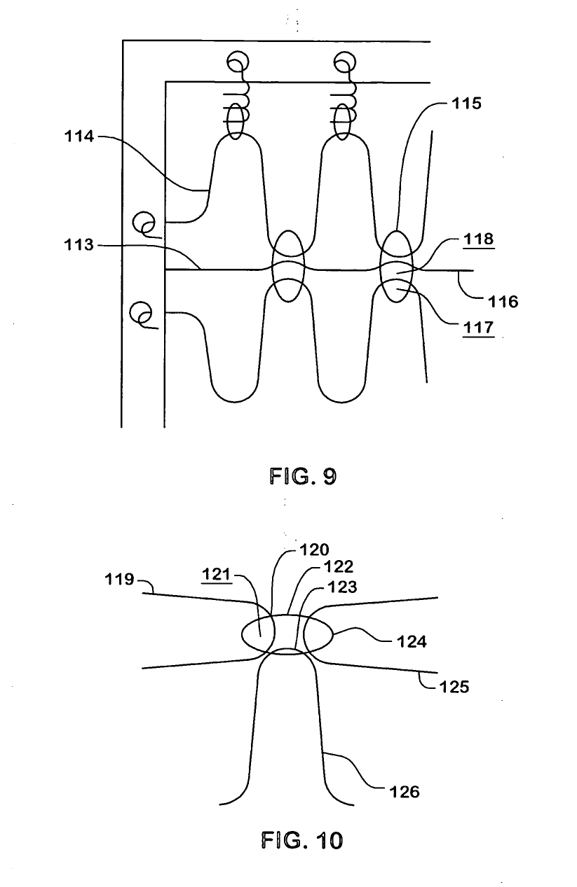

In this invention the metal box springs and constance coupling quantum oval loop design become an electron beam forming combination waveguide to the incoming collapsing light signal. This combination material action responds to the complex oxide stripes in order to produce high-frequencies radio transmission due to the design combination of man-made metamaterials. In combination with electro-magnetic superconductors, the electron beam forming waveguide is sandwiched in between helium-4 gas, which is a 1 mm thick wafer. Even though this is a complex design, it is cost effective because it is a 1 mm thick laminated manufacturing process. This metal box springs is a beam-forming waveguide of total transparency connecting onto the mirror solid state and plasma-oriented gas dual deck reflection that manipulates the high frequencies, radio waves down into the correcting phase holding and folding of the metamaterials sectorial zoning area to accomplish the manmade reconnection of the collecting electrons density that completes the constance coupling beam forming the shape of the metal box springs design. The said incoming light signal proceeds down into the quantum oval loop connective coupler transistor to reflect into the sectorial zoning area of the boundary holding and folding of the signal in place along the line edge reflective dual deck transparent beam forming waveguide for the transmission to never disconnect from the device. This new antenna invention of upper and lower decks binds ionized gas to the solid state gas helium-4, metamaterial, superconductor striped complex oxides metal electro-optical-magnetic metal box springs antenna with an aperture receiver area of 20×30 mm which is 1 mm thick which will cover this full plate area and will take in the full spectrum from low 30-to-3,000 kilohertz to 30-to-300 gigahertz transmission. The full spectrum transmission conducted onto this metal box springs waveguide will encompass 500 terahertz optical metamaterial waveguides below the metal box springs as a base substrate. The aperture distance and size of this antenna surface will eliminate any spillover of radiation or disconnect as there is with a small omnidirectional pole antennas. The first incident of the incoming light wave will be the gravity bounce onto the top plate surface beam forming waveguide connecting on to this metal box springs. This metal box springs is selecting, confining and channeling a propagating beam of light on to the surface of this rectangular antenna receiver frequency relay scanner which uses acoustic surface waves made of complex oxides utilizing a transparent left-handed negative refractive metamaterials substrate in which the metal box springs and dual receiving deck traps, holds, computes, and folds into the edge of the crystal layerings of the directional metamaterial manmade in order for the input gravity light wave to never disconnect from the applied device, such as a cell phone. The concept of coupling constant relating to design parameters that are used to characterize the strength of forces in this invention are actually coupling constant that vary with the distance scale coordinates of the physical process in which they are measured. This phenomenon is both well established experimentally and predicted by current theories and is known as traveling coupling constance. This is found in this invention that claims the incoming incident wave will not disconnect from the apparatus of the metal box springs and establishes that this design is a running of the coupling constance down to distance scales much shorter than can be accessed experimentally. This design invention model is within this running of the coupling constance model of particle physics. This design is in the description of the Abelian gauge theory of strong and weak forces which is described by non-Abelian gauge theories. This invention describes the nano-unified field design theory that is applicable at subnuclear distances in the parameter scale of a rectangular 20 mm×30 mm flat aperture form. This is established in articles in Nature Vol. 468, 4 Nov. 2010 News & Views, Gravity's weight on unification by Giovanni Amelino-Camellia pages 40-41 and the article, Quantum gravitational contributions to quantum electrodynamics, by David J. Toms, pages 56-59. This design produces a wide frequency band with low losses because the use of transparent complex oxides crystal fiber properties creates extremely large bandwidth that gives the ability to transmit very short 10-12 seconds optical pulses; this makes the metal box springs capable of carrying vast amounts of spectral signals. The Physics Today Oct. 2010 article Shaping optical space with metamaterials by Martin Wegener on pages 32-36 describes the two legs of the electrical and magnetic process of this design. This Hertzian sine and cosine wave in Fourier analysis depicts the design of metal wires of this layering system in which the multiple wires reinforce each other and where each particle wave is parallel cladded complex oxides are superposed upon the prior-to-1940-old-style metal box springs design used as a nano oxide complex wire guide system induced by electrical current to flow onto this design pattern to guide the wave incident onto this antenna system. The Physical Review Letters, Vol. 102, 17 Apr. 2009, pages 1-4, Experimental and Theoretical Evidence for Subwavelength Imaging in Phononic Crystals by A. Sukhovich, supports the design concept of the device presented in this invention for a metal box springs design which consists of multiple phononic crystals exhibiting negative refraction. The article in the October 1972 issue of Scientific American, Vol. 227, No. 4, pages 50-68, Acoustic Surface Wave, by Gordon S. Kino and John Shaw, and this invention exhibit multiple complexities that concern processes such as hold, fold, receive and disentangle signals in communication receiving antenna systems. In this device electrical signals are used to excite Rayleigh waves, as they are now called, on the surface of a crystal a few centimeters long and one or two millimeters thick. The acoustic surface waves excited in this manner can be employed to filter one signal from another, to amplify weak signals and to store signals for use at a later time. It is also possible to do certain things with acoustic surface waves that are difficult to do with simple electronic components, such as recognize a signal of known form. Physical Review Letters, Vol. 93, 14, 1 Oct. 2004 Trapped-Particle Instability Leading to Bursting in Stimulated Raman Scattering Simulation by S. Brunner concerns design of ion-acoustic waves in electron plasma waves that distribute on a fixed Cartesian mesh grid which are the metal box springs in phase space. All waves are ruled by phase process of a kinetic effect nonlinear trapping of particles by the longitudinal waves in the plasma ion-acoustic and electron waves and predict Fourier space by the presents of this sideband macro-particle model as presented in this article and in the design of this antenna device. This design proves the effectiveness of the wave transport receiver of this metal box springs antenna process. The metal box spring is flat but when the incident light hits the surface it bends to a curved metal box springs movement. In this design process it is necessary to delay and fold the incoming incident wave in order to hold in the metamaterials which is to be put in a refluxtivity process. The incoming acoustic-surface-wave refluxtivity delay holding and folding excels in this metal box springs design. Not only can it be used to store the signal; it can also be coded to recognize certain signals and to compare one signal with another because of folding, holding and refluxtivity of the incoming wave between the rectangle crystal metamaterial layerings. The reason why this metal box springs design is the simplest type of elastic waveguide is that in the longitudinal wave the directional negative refraction metamaterial substrate is ideal to alternately direct, compress, expand, separate, and select on a sharp line magnetic boundary level. Also in this metal box springs design a second type of acoustic wave is the transverse, or shear wave, in which directional negative refractive metamaterial particles oscillate from side to side at right angles in the direction of the acoustic signal. The third principal type of wave, which is the Rayleigh wave, exists only near the free surface of a solid. The Rayleigh is a composite wave incorporating both shear and longitudinal components—which are required to satisfy the boundary conditions—and the force normal to the surface is zero. This metal box springs waveguide enables the waves to travel along the metal box springs surface design of the solid substrate flat crystal, much like the rippling surface of a pond. This quantum oval loop where gravity responds to the presence of surface energy density on a higher-to-a-lower position which connects on this metal box springs wire fabric. This design in nano space-time begins to curve on the connective bounce of the incoming light signal as fluctuations in energy decohere, gravity responds to the fluctuations in the energy of the quantum metal box springs bands that radiate down into the cavity of the quantum oval loop center as the light signal becomes a superposition antenna process. Thus the rapidly changing electrical signal is applied to the directed negative refractive metamaterial and the sandwich piezoelectric material. This material will vibrate in unison with the electrical signal, generating a sound wave that will bounce at the center of gravity, as shown in FIG. 1, #29 zero order rediffracted beam zero order rediffracted beam, and spring back into the refluxtivity position onto its folding and holding edge under the rectangle crystal layerings of the metal box springs design. As reported in Science, Vol. 329, 27, August 2010, pages 1043-1047, Strange Metal Transport Realized by Gauge/Gravity Duality by Thomas Faulkner and as shown and stated in this new antenna invention, FIG. 1, #29 zero order rediffracted beam zero order rediffracted beam and FIG. 10, #119 through #126, exotic systems such as the strange metal phase of cuprate superconductors and heavy fermion materials near a quantum phase produce the effects onto the waves that are ruled by phase transitions. FIG. 10 is the core in the embodiment, specifications, and claims in the invention as is applied to all FIG. 10's noted in this invention. As stated in Nature article, Vol. 468, 11 Nov. 2010, pages 184-185, Mind the pseudogap, by Chandra Verma, and the Letter article, Vol. 468, 11 Nov. 2010, pages 283-285, Hidden magnetic excitation in the pseudogap phase of a high-Tc superconductor by Yuan Li, that on pages 184 and 283 of these issues, Li, et al., reports observing a special kind of intense collective electronic fluctuation in the most mysterious phrase of matter exhibited by high-temperature superconducting iron and copper oxide materials. As shown in FIG. 1, page 184, phase diagram of the cuprates depicts the strange-metal region of a quantum critical point of sectorial zoning areas between antiferromagnetic materials and neighboring spin points in opposite directions. This is depicted in the invention FIG. 10, #121, #124 and between the crossover at #123. This crossover line in FIG. 10, #123, is a combinational transitional phase connecting all three connective designs to produce the electric holding of the incoming incident wave that is being directed by the Saint Andrews cross energy phase across the surface of the crystal plate and down on to the metal box springs and on to the quantum oval loop shown in FIG. 10, #122 and constance coupling to the lower deck of the quantum electrical vertical loop connection in FIG. 10, #123 and #126. This is shown in the article Two-dimensional electron gas with universal subbands at the surface of SrTiO₃ by R. Weht, Nature, 13 Jan. 2011, Vol. 469, pages 189-193. In this two-dimensional phases of electron matter an oxide interfaces creates the coming together of #126 through the oval at #123 and #122 which is also shown in the above-mentioned article on page 190, FIG. 1 diagrams. This gap transition is a gradual crossover between all quantum oval loops of thermodynamic and electric transport properties. As stated in this invention, the dome yttrium barium in which the quantum critical point is cladded on to the top of the oval, creating a double overlapping in which to create a loop dome-shaped superconducting design region of this phase, as depicted in FIG. 10, #122. This dome extension point placed on the loop region would occur at zero temperature and would involve a change in symmetry expansion of the material's electronic structure as shown in FIG. 10, #119 through to #126. This double overlapping dome creates the expansion and collapse between the upper deck of the metal box springs and the contraction of the lower deck into the quantum oval loop of this counterforce of this full field combination of attracting gravity which drives the expansion coupling constance inflation that sandwiches the incoming light signal off of the complex oxides metal box springs wave guide. Because the high-Tc superconductor is determined by the materials collective electronic excitations combinations in the non-superconducting state which is the constance coupling of electrons downward into the connective design to this excitation in the strange metal region which is the connection to the metal box springs and the quantum oval loop as shown in FIG. 10, #119, #120, #125 and in the lower deck quantum electrical vertical loop, as shown in #126. This produces a long-range order phase in which pairs of quantum electrical vertical loop flows within each of the materials unit cells or upper and lower deck which is called quantum oval loop connection to the quantum electron current vertical loop and produces a pair of oppositely directed magnetic movements, as shown in FIG. 4, #80 and #84 which is the lower deck crossover. The change of symmetry is indicated in the metal box springs ability for expansion movement; therefore these modes of fluctuations from these design materials across the sectorial zoning of opposite magnetic flow in nature are being controlled by the energy of Saint Andrews cross finite movement across the quantum oval loop and lower deck quantum electrical vertical loop, as shown in FIG. 4, #76, #79 overlapping #80. As shown the Chandra Varma, et al., article, FIG. 2, loop-current electronic order unit cell shows a negative one side and a positive on the other side on each end of the cell. This is also shown in the quantum oval loop showing a negative Venn diagram overlapping connection shown in FIG. 10, #121 and a positive Venn diagram overlapping connection shown in FIG. 10, #124. Both the article diagram and this invention's diagram are one and the same, showing the connection of the complex iron and copper oxide CuO material onto the metal box springs overlapping the quantum oval loop depicted in the overall design of FIG. 10 and the electron current vertical loop shown in FIG. 10, #126. This metal box springs design is being used as an anti-de-Sitter/conformal field theory correspondence, making the framework for non-Fermi liquids no longer a theory but a reality. The loop oval quantum gravity in FIG. 1, #29 zero order rediffracted beam and oval loop quantum gravity in FIG. 10 are the connection to the lower energy behavior and the two decks in this antenna are found to be governed by a nontrivial infrared fixed point shown in FIG. 1, #29 zero order rediffracted beam. This metal box springs is a nano-miniature universe which includes profound connection between gravity and unified field many-body systems, resulting in the emergence of a new metal box springs design that produces strongly coupled many body unified design systems which this article calls the anti-de-Sitter/conformal field theory AdS/CTF correspondence that relates to the electrical, the optical and gravity in a design curved flat dimensional anti-de-Sitter AdS d+1 dimensional quantum field theory defined on this directional negative refractive metamaterial boundary. The oval loop quantum gravity in FIG. 1, #29 zero order rediffracted beam is a miniature nano oval curved geometry dynamic of the boundary theory at finite temperatures and density. By using metal phase of the cuprate high-temperature superconductor wires with applied unified field design creates unusual transport properties different from those of a normal metal and is dubbed a strange metal fluxuation design. This metal box springs is governed by a quantum critical point at low energies and curved design point behavior at the rim of the loop quantum gravity oval design as shown in FIG. 10, called interdigital electrodes oval loop quantum gravity design, #121, #123, and #124. The use of AdS/CFT correspondence space-time conformal symmetry in this metal box springs design and metamaterial substrate boundary manipulation of suppressed superconductors complex oxides placed alongside cladded on to the wire design create a miniature global multiple striped parallel Hertzian nano-universe in which the gauge field can be identified with the box spring superstring multi-striped design spatial aperture antenna. This oval loop quantum gravity is filled with AdS, which pulls all matter towards it center of gravity; thus the particle will eventually fall back toward the quantum gravity's oval loop and lower deck quantum electrical vertical loop wave which connects to the oval hole, as shown in FIG. 1, #29 zero order rediffracted beam and FIG. 10, interdigital electrodes oval loop quantum gravity, #123. Using AdS4, the boundary scaling and Lorentz symmetries are broken and allows the Saint Andrews cross to pass across the breaking of boundary symmetries enabling a free path for the energy to be transported and involves the time and radial direction of each oval loop quantum gravity oval transistor. As shown in the above-cited article reported on page 1044, diagram FIG. 1, this vertical axis is in the same redial direction as the oval loop quantum gravity shown in this invention FIG. 1, #29 zero order rediffracted beam and the line #27 horizontal arrow line across the metamaterial substrate boundary in the lower deck of this antenna are both one and the same. Also this same article, on page 1045, diagram FIG. 3 (a)(b) depicts this oval loop quantum gravity oval propagator specifically numbered in this invention in FIG. 10, interdigital electrodes oval loop quantum gravity, #119, #125. This oval loop quantum gravity and the box springs are similar to a Venn diagram overlapping dome where the X's are marked in this article in diagram (b) which shows the near horizon AdS2 region and associated connective symmetries of this many-body field, indicating that at low frequencies (w, <<u), boundary system develops an enhanced symmetry group including scale invariances and, in particular, the oval loop quantum gravity is controlling the binding, releasing and refluxtivity folding phases of this conformal metal box springs. This power source of direct current being applied along a universal scaling phase is fixed by time reversal symmetry to a slower refluxtivity Lorentzian miniature nano large class of unified field many-body elements brought together in this design. The unified field many-body design elements encompass this AdS gravity dual connective quantum metal box springs design system. Therefore, the near-horizon AdS2 region and the fluctuations are critical for momentum in this strange superconducting state in the boundary of this oval loop quantum gravity oval design that brings gravity down into its optical cavity and the electrical vertical Hertzian connective processes to connect to suppress the superconducting transition into this design transistor process. This phenomenon is related to the coupling between FIG. 1, #8 and FIG. 10, interdigital electrodes oval loop quantum gravity, #121 the line metal box springs and the oval loop quantum gravity combined make an interdigital electrodes system. This incident evanescent waves and a bound slab mode of photonic crystal lens and metal superconducting wires leads to amplification of evanescent waves by the design slab mode. These electromagnetic wave wires are imbedded between flat substrate crystal lens exploiting negative refraction of the incident waves in left-handed refractive directional metamaterials and photonic complex oxide wire imbedded in substrate crystals. These crystal metal box springs wire guides have a multiple layerings made of complex oxide coatings cladded on both north and south sides of the metal box springs wire waveguides and are attached to the metamaterial crystal substrate and immersed between this upper deck and lower deck is a helium-4 gas because helium-4 has a frictionless behavior, as shown in FIG. 3, #62. This article in Physical Review Letters, Vol. 102, 17 Apr. 2009, Charge Excitations in the Stripe-Ordered by S. Wakimoto explains the parallel strip cladded complex oxides that are attached to the metal box springs wire design as La_{5/3} Sr_{1/3} NiO₄ and La₂ negative x(Ba,Sr)ₓ, CuO₄, the superconducting complex oxide compounds on both north and south line of the metal box springs. In explained in the article Light-Induced Superconductivity in a Strip-Ordered Cuprate, by T. Takayama, Science, Vol. 331, 14 Jan. 2011, pages 189-191, the reason this invention is using these high-temperature culprate superconductors is the interplay between one dimensional striped spin order and charge order compound inner layer of coherent transport in the c-axis optical properties. The metal box springs will be composed of many complex oxide stripes placed on the north and south alternating sides of each Hertzian wave metal box springs. The charged excitations in stripe-ordered in 214 compound La_{5/3} Sr_{1/3} NiO₄, in order to create a higher pitch, is place on the north side of each of the repetitive metal box springs wire design located in FIG. 1, #5 and ⅛ doped La2−x (Ba,Sr)ₓ, CuO₄ is on the south side of the metal box springs wire design shown in FIG. 1, #5 which correspond to the momentum transfer corresponding to the charge stripe spatial period both for the Saint Andrews cross diagonal energy flow nickelate and parallel cuprates stripes cladded alongside the Hertzian waveguide line. The concept stripes used in this invention is conveyed in Letters, Nature, 2 Dec. 2010, Vol. 468, pages 677-680, Fluctuating stripes at the onset of the pseudogap in the high-T_{c} superconductor Bi₂Sr₂CaCu₂O₈₊ₓ by Colin V. Parker. These complex superconductors are mentioned in the article Observation of Half-Height Magnetization Steps in Sr₂RuO₄, by V. Vakaryuk, et al., Science, 14 Jan. 2011, Vol. 331, pages 186-188. As explained in this article and as demonstrated in this invention, the Meissner effect is producing a phase of superfluid helium combination which is the combination which produces a Meissner response of the superconductor placed in this design and is also depicted in the visual component in the FIG. 1 diagram in this Science journal article. The analysis of these stripes establishes the phase selective coherent properties that are produced in the design metal box springs layering cladding for multiple frequency waveguides for the correct selection modulation behavior that produces the multiple selection position of the spectrum frequency light signal classification production. The metal box springs design is a multiple layering striped cladded coatings on the nano-crystal superconductor wire system. The superconducting core wire system alternates alongside of each other with nano-size silver and gold wire systems as shown in FIG. 1, #5 throughout the entire wire mesh grid metal box springs located on the top deck of antenna. These multiple transparent strip coatings are placed on the alternating north and south sides of the metal box springs of superconducting complex oxide crystals that are only separated by each different complex oxide boundary because each complex coating interacts with each other's chemical oxide to enhance the process. This coating lamination cladded on to superconductors on the north and south sides of the wire will be repeated with alternating different chemical complex oxide transparent metals to superconductors for different transmissions pick-up process. According to Physical Review Letters, Vol. 102, 16 Jan. 2009, Perfect Mirror Transport Protocol with Higher Dimension Quantum Chains by Gerardo A. Paz-Silva, and also in this invention, the borderline mixing of the complex oxide scheme works on a continuous variable nearest neighbor of each oxide closest to the Hertzian wave running parallel to the coupled system of the metal box springs design, producing a final transference selection quantum state which is perfectly spatially mirrored midpoint of the waveguide transport. This waveguide is a continuous variable quantum design state driven by superconducting complex oxides attached to coplanar waveguides transport when coupled with switchable Cooper pair boxes, as shown in FIG. 3, #57 and FIG. 4 #82, #80, #84, FIG. 5, #89, #92, FIG. 9, #118, #116, FIG. 10, interdigital electrodes oval loop quantum gravity, #119 through #126. This multi-complex oxide metal box springs layering quantum transport will be capable of transporting large full-range frequencies entangled broadband spectrum of quantum information frequencies with perfect fidelity and operate with the minimum of external or internal control on this crystal higher dimensional quantum system. The use of directional negative refractive metamaterials will create a perfect lens mirror transport that will retain the incident wave coming into the aperture of the entire surface of the metal box springs design antenna. As shown and discussed in 2007 article Physical Review-E, Vol. 75, Curved Structures in Recurrence Plots: The role of the sampling time by A. Facchini, pages 1-8, depict the same design structure as in this metal box springs pattern design. The refluxtivity recurrence plot in this phase space where all waves are ruled by phases and backward folding movement at the edges of this rectangle produces recurrence in the strange superconducting nonlinear phenomena that will be used for high dimensional dynamics in this nano-broadband two-dimensional gas and solid state deck system antenna. The signals with periodic modulation of the carrier frequency or of the phase shows circular and curved patterns with nano-pattern macropattern coated recurring patterns. Page 4 of same article shows in (a) diagram the basic hook which shows that the motion of the state vector path is a helix which indicates the time at which a new correct recurrence happens in all 36 empty holes, that are 250 nm in size, around the frame of the rectangle, as shown in FIG. 1, #9, #10, #27. These 36 empty holes are toroidal dipolar magnetic holes used to produce toroidal rotation symmetry to rotate polarization of the incoming light signal, coupling constance connection of negative index of refraction, interacting between electrical currents producing toroidal monopoles in the 36 empty holes on the frame of the metal box springs grid that now is connected to and by the spring hooks. This was reported in the Science article, “Toroidal Dipolar Response in a Metamaterial by T. Kaelberer, 10 Dec. 2010, Vol. 330, pages 1510-1512. The article on page 1510 specifically depicts the empty hole in FIGS. 1, A, B and C and this empty hole is confirmed in Physical Review Letters, Vol. 103, 2 Oct. 2009, pages 1-4, Magnetic Ground State of Single and Coupled Permalloy Rectangles by S. Hankemeier, and in this invention, the metal box springs antenna will be using this magnetic domain structure in Permalloy rectangles, revealing flux-closure domains configurations which are called refluxtivity folding and holding in the micromagnetic simulation process. These structures will be fabricated from blocked crystals at 20 nm thick Permalloy flux-closure domain structures. This optically objectifies the rectangle down on to a nanodimension system. The diagram in FIG. 2 on page 2 of the same article depicts (a) and (b) magnetic structure of Permalloy rectangles and on the same page of the same article FIG. 5 depicts the two polarization lines which will be placed above the substrate as shown in FIG. 1, #11 through #33 and FIG. 3, #59. This area in the rectangle will become the reflux-folding closure structure in the first magnetic microstructure along the edge in this metal box springs design. This is also shown in patent drawings FIG. 4, #72, #73, FIG. 5, #96, FIG. 6 #105, #109 as the edge and the 36 empty holes connected to the box springs frame and hooks. These 36 empty holes are toroidal dipolar magnetic holes used to produce toroidal rotation symmetry to rotate polarization of the incoming light signal, coupling constance connection of negative index of refraction, interacting between electrical currents producing toroidal monopoles in the 36 empty holes on the frame of the metal box springs grid that now is connected to and by the spring hooks to the grid. This was reported in the Science article, “Toroidal Dipolar Response in a Metamaterial by T. Kaelberer, 10 Dec. 2010, Vol. 330, pages 1510-1512. The article on page 1510 specifically depicts the empty hole in FIGS. 1, A, B and C. The recurrences of this state vector recur with itself and other hook vectors of the same size macro-stripes at 25 Hz. This vector design hook is loosely placed as a gravity wave bounce process release on the metal box springs and is associated with the combination of size width band connection, shown in FIG. 1, #4, FIG. 4, #72, #73, FIG. 6, FIG. 7, FIG. 8, #105. The resonant frequency of the parallel combination is a geometrical factor, having the dimensions of the reciprocal length, depends on the geometry of the inductor wire and empty holes and capacitor oval loop quantum gravity design and substrate layerings. In both cases the velocity of a wave—in the one case acoustic, in the other electromagnetic—can be found without recourse to wave techniques. When it is possible to ignore wave theory and to assign separately the two properties of matter that are needed for waves—inertia and springiness in the case of elastic waves, inductance and capacitance in the case of electromagnetic waves—to elements that have dimensions small compared with a wavelength, it can be said that these elements constitute lumped-together parameters. In contrast a continuous medium in which waves can propagate is said to have disturbed parameters. This is related to the use in this invention that nano-size wire that stretches across a rectangular square that is 20 mm×30 mm and 1 mm thick which creates an Einstein miniature universe on gravity space time like curve and connect to nano electro-optical conductance of a unified field design. As stated in Physical Review Letters, Vol. 103, 2 Oct. 2009, All Optical Metamaterial Circuit Board at the Nanoscale by Andrea Alu, pages 1-4, this metal box springs will pave the way for optical nanocircuits for transformative advancements in selectivity nonentanglement in communications reception antenna. This rectangle nanocircuit board aperture gas and solid state oriented is constituted of layered metamaterial double deck with low effective permittivity, over which specific traces channeling the optical displacement currents producing phase folding in a curved inwardly into the edge of the rectangular board. This allows the optical local connections among nonlocal sizes and distances along the metal box springs multiple complex oxide nanocircuits elements in this metal box springs printed circuits to realize the full spectrum being manipulated by chemically parallel stripes of complex oxides cladded to superconductors in the grooves to be accessed and selectively separated in this antenna design. These rectangularly stacked plates which house the metal box springs will realize the bridge between silicon-based circuits and the plasmonics. This will allow the interconnection between signal processing and optical communications technology in this metal box springs design. This creates the design that produces nanoinductors, nanocapacitors and nanoresistors which are put together in this metal box springs design arrangement of size-distance miniature nanoparticals with specifically arranged directional sectorial zoning left-handed metamaterial permittivity which creates the separation magnetically and refluxtivity folding and holding at the edge of the rectangular and the center of the loop quantum gravity. A set of laws analogous to Kirchhoff's current and voltage laws has been derived for such nanocircuits' elements and simple impedance definitions used in regular electronic circuits are applied to the light interactions with natural design along with optical nanoparticals. This size-distance miniature universe will now allow processing optical receiving antenna signals at the nanometer scale. This design dimension is smaller than the low-frequency electronic waves, with several potential advantages in terms of speed, bandwidth, and compactness. This antenna will enhance the process because this entire device is 1 mm thick. This design overcomes the uncontrolled wave limitations of large unwanted incoming couplings on to a single nano-element which makes use of optical design edge between the parallel striped complex oxide superconductors nanoinsulators that produce shields made of zero-permittivity metamaterials, confining each wave to a magnetic displacement. This metal box spring design line layering of parallel striped complex oxides on to this rectangular board of metamaterials as a substrate base creates an effective epsilon-near-zero process. This introduces a new size-distant concept in nanocircuit selective boards which are called the parallel striped complex oxides. It is worth noting that the concept of circuit modeling of light interaction with plasmonic structures is well established in the science literature. For example in Physical Review Letters, Vol. 100, 23 May 2008 Defect-Free Surface States in Modulated Photonic Lattices by Ivan L. Garanovich shows and explains the interfaces of periodically curved waveguide arrays can support a novel type of surface states associated with the band flattening with no restrictions on Bloch wave symmetries characteristic of Shockley and also as shown in this article curved array (d) (e) (f) beam dynamics in a sinusoidally modulated lattice and also depicted in this invention design, metal box springs. Depicted in Physical Review Letters, Vol. 98, 12 Jan. 2007 and Physical Review Letters, Vol. 93, 17 Dec. 2004, is a perfect example waveguide design performance of metal box springs. Also in the book Physics of Wave, William C. Elmore, on page 160 in the chapter Acoustic Waves in Fluids states that standing waves are ruled by phases in both upper and lower decks of the crystal layering as shown in FIG. 3, #67, in this rectangular aperture metal box springs design for an antenna. The various standing waves that can occur satisfy the boundary condition that the displacement component perpendicular to a wall of the Hertzian striped parallel complex oxides vanishes which is shown in FIG. 1, #27. The combined energy motion parallel to a wall is not restricted, since viscosity is ignored. The result of the present analysis of the metal box springs is useful in connection with the full field design of the acoustic properties that are involved in this metal box springs antenna. One of these field theories is the combination of the standing electromagnetic waves in this metal box springs elastic movement of these waves are brought together and controlled through the processed connection on the edges of this rectangular crystal block. These dual decks have a sandwiched of liquid helium-4 gas that has a controlled temperature that is changed through lowing temperature that creates a solid which produces the connective method which is of fundamental importance; this importance is a Bose-Einstein condensate and is comprised of a layering of helium-4 gas mixture which is shown in the article, Helium-4's many phases, in Science News, page 25. Superfluidity arises when the atoms in superfluid helium-4 join up in a quantum state called a Bose-Einstein condensate, allowing them to exhibit collective behavior as shown in FIG. 10, interdigital electrodes oval loop quantum gravity, #119-#126 in this design that which is associated with one part of the connection in the quantum full field design which is now a proven fact in quantum physics. The collection gathering of the negative refraction of acoustic waves by this antenna directivity diagram grid of phononic crystals results from Bragg scattering and occurs in pass bands with negative group velocity-group velocity are opposite to the wave vector which we call refluxtivity of focusing of sound by either negative refraction or by a channelization mechanism as shown in FIG. 10, interdigital electrodes oval loop quantum gravity design, #126, #119, and #125. Physical Review Letters, Vol. 97, 1 Dec. 2006, pages 1-4, in Fixed Points of Higher-Derivative Gravity by Alessandro Codello, states that constructing a quantum field theory of gravity was based on the application of perturbative methods to Einstein's theory being applied to this new metal box springs design and as stated in Physical Review Letters, Vol. 102, 15 May 2009, pages, 1-4, “Focusing Ultrasound with an Acoustic Metamaterial Network” by Nicholas Fang. This article shows the demonstration of focusing ultrasound waves through a flat acoustic metamaterial lens composed of a planar network of sub-wave lengths Helmholtz resonators. This transparent metal box springs design uses this perfect lens based on focusing the propagating wave and recovering evanescent field through a flat negative index crystal slab plate. This artificial media refracts waves in negative direction and has several different magnetic metamaterial boundaries that are being used in this metal box springs design for magnetic boundary separation selection process. The beams are being steered along the metal box springs complex oxides in this photonic crystal that is achieved by Bragg scattering on the surface of this metal box springs leading to enhanced diffraction in a negative direction for frequency relay folding and frequency scanning holding that is produced by the use of this directional metamaterial photonic crystal slab as shown in FIG. 1, #1 and FIG. 2, #41 and FIG. 3, #58 through #66. The upper deck as shown in FIG. 3, #58 through #61, depicts the fishnet metal box springs repetitive design, shown in #56, the substrate of the top deck which is a new type of polariton in a piezoelectric superlattice. In Physical Review Letters, Vol. 90, 17 Feb. 2003 an article by Yong-Yuan Zhu describes this new type of propagation of an electromagnetic wire wave design superlattice which results in the creating a new type of polariton that does not exist in ionic crystals. This will encompass the forbidden band associated with the polariton and is not due to Bragg reflection but rather to the constance coupling of both decks of this antenna through the oval loop quantum design, as shown in FIG. 10. This metal box springs uses real transparent crystal processes that activate the couplings between the motions of electrons, photons, and phonons in this substructure in between the spaces of these stacked plate rectangle crystal decks. This metal box springs design upper deck encompasses infrared absorption and polariton excitation results from the couplings between these two deck lattices vibrations that transverse optical phonons and electromagnetic waves in this ferroelectric domain coefficient which is modulated in this superlattice deck from a transparent point of view and coupling both decks between the lower deck superlattice vibrations of the electromagnetic wave that is established underneath the top deck as shown in FIG. 3, #63. FIG. 3, #67 shows both upper and lower decks of the coupling between these multiple superlatices. As shown in FIG. 3, upper deck, line #61 is comprised of a very thin layer of graphite. As stated in Physical Review Letters, Vol. 103, 11 Sep. 2009, Searching for the Fractional Quantum Hall Effect in Graphite by Y. Kopelevich, the thin graphite layering produces a very strong magnetic field that will be used to connect the lower deck with the upper deck of this metal box springs. FIG. 3, #60 is a layer of ionic Al₂O₃ and as stated in Physical Review Letters, Vol. 103, 11 Sep. 2009, by H. J. Xiang that puts the combination of Si and Al₂O₃ together to form this thin film with high carrier mobility in this top-deck structure of the box springs. In all of the specifications being stated in this invention concerning the metal box springs, the upper and lower deck will be composed of many layered transparent crystal formations placed above the line, on the line, and below the line as shown in FIG. 3, #58 through #70. As shown in Nature Letters article, Vol. 466, August 2010, pages 735-738 in Loss-free and active optical negative-index metamaterials by Shumin Xiao, deep subwavelength resolution and nanophotonics creating optical negative-index metamaterials using nanostructured metal-dielectric composites, near-infrared and visible wavelengths ranges in optical designs of metal box springs fishnet designs are not out of the realm of fabrication reality. It can be fabricated with extremely low-loss and active optical nanostructure that require metamaterials such as designed granules of silver and gold substrate placed at strategic size distance thicknesses of active material that will be kept nano-small to preserve the negative refractive index superfine boundaries to produce separation selection holding placement and spillover in this Lorentz-Einstein-Bose condensate as an oscillator which will produce a spectral range between 722 and 738 nm and a refractive index which is negative in a broader range between 720 and 760 nm. This fabrication process will be used to develop this metal box springs structure immersed in a medium of left-handed negative metamaterials as spacers accomplish the developmental post-processing method. First, the metal box springs are fabricated with Al₂O₃ as a spacer in association with electron-beam lithography with a Leica VB6 writer and lift-off processes as shown in FIG. 1, the north side of line wave #6 which is repeated on all north side of line waves of metal box springs shown in #11 through #33. Then chemical etching is used to remove the Al₂O₃ spacer and, finally, epoxy with dye molecules is used to fill the vacated space. This is a part of the fabrication assembly process. In FIG. 3, #59 is a thin film of FeSe₁₋ₓ. As stated in Physical Review Letters, Vol. 103, 11 Sep. 2009 Crystal Orientation and Thickness Dependence of the Superconducting Transition Temperature of Tetragonal FeSe₁₋ₓ Thin Films by M. J. Wang, this thin film of FeSe₁₋ₓ films on orientation of 001 on MgO substrates that will produce the structural transformation and magnetic ordering that will produce the underlying frequency coupling and folds and holding of the redirect wave of the incident wave that is coming in to the horizontal waveguide of the metal box springs design. This thin film mentioned above, south side of metal box springs waveguide indicated as shown in FIG. 1, #11 through #33. FIG. 3, #63 is comprised of a layering of helium-4 gas mixture as discussed in the article in Science News page 25, Helium-4's many phases when superfluidity arises when the atoms in superfluid helium-4 join up in a quantum state called a Bose-Einstein condensate, allowing the helium-4 to exhibit collective behavior. FIG. 3, #62, is comprised of a liquid crystal plate combination with gold granular designed rods. This is stated in Physical Review Letters, Vol. 103, 18 Sep. 2009, in Bloch Oscillations in Complex Crystals with PT Symmetry by S. Longhi, pages 1-4, namely that this metal box springs exhibits the optical Bloch oscillation in photonic lattices with gain or loss regions. This novel dynamical design material combination phenomena has no counterpart in ordinary lattices. This exhibits a Bloch oscillation that depicts the metal box springs oscillation of coherent oscillatory motion design waveguide of a quantum design particle in a periodic potential driven by an external direct current force which this metal box springs represents the most striking metamaterial design of waveguide mechanics of periodic systems. The Bose-Einstein condensates in tilted optical lattices relates to the transition of energy spectrum from continuous energy bands to a nearly a super narrow formation of Wannier Stark ladders when the direct current is applied. This transparent metal box springs is able to translate through the multi-layerings of complex rare earth oxides crystals lattices. This particle movement is in real-valued potentials which occurs in the presents of metal box springs nonlinearity, lattice disorder, or particle interaction process. The metal box springs has two complex resonant interaction of light on two deck levels systems. This includes optics design with metamaterial slab structures substrate for the waveguide propagation in lossy and/or active waveguides described by a complex negative refractive index. As depicted in above-mentioned article diagrams on page 2 FIG. 1 and page 3 diagram FIG. 3, the complex-binary lattice is made of one of many lattice layerings of AlGaAs optical coupler capable of performing all the functions needed to feed and retrieve information from the crystal fibers that this material performs both electrical and optical which is shown in this pattern submission located in FIG. 1, #5 and the entire metal box springs layerings as shown in FIG. 3 #56, FIG. 4, #85, FIG. 5, #99, FIG. 9, #114, FIG. 10, interdigital electrodes oval loop quantum gravity, #119, #125. These complex binary lattice refractive indices are already realized in these metal box springs engineered arrays of active semiconductor waveguides with selective pumping to achieve gain and low-loss regions at optical near-infrared wavelengths in this broadband antenna optical amplifier selector metal box springs. The lower deck of the quantum electrical vertical loop wire is positioned on top of a layered substrate, as shown in FIG. 2, #43 and #47, the vertical design of which is also shown in Physical Review Letters, 103, 18 Sep. 2009, Magnetic-Field-Induced Superconducting State in Cladded Zn Nanowires to Carbon Driven in the Normal State by an Electrical Current by Yu Chen, pages 1-4. This quantum electrical vertical loop wire specifically concerns the lower deck region as shown in FIG. 2, #34 and #44 is the incoming electrical connection to the power source of the device connected to the antenna and #46 and #35 are the transmitted cable connection of the radio waves entering the antenna device and into the cell phone device which encompasses the entire antenna rectangle #34, #35, #36, #44, #46 and FIG. 3, #57 through #70 the quantum electrical vertical loop wire wave. This is the connection between the electrical current and the optical-magnetic loop quantum gravity system. The use of Zn nanowire layerings cladded to carbon wire substrate is formed using electron beam lithography. When current is applied on to these quantum electrical vertical loop wires the energy reenters into the superconducting state upon connective application of small magnetic fields as shown in FIG. 10, interdigital electrodes oval loop quantum gravity, from #126 to and through the oval loop quantum gravity connectiveness between the dual decks system. The particles synchronize with the Saint Andrew's cross energy surface sensitive active movement across this spaces of this metal box springs design top plate as shown between Venn diagram overlapping the loop quantum gravity's which will be holding both decks magnetically to the metal box springs together in FIG. 1, #29 zero order rediffracted beam, FIG. 4, #80, #81, #82, #83, #84, FIG. 5, #86, FIG. 9, #117, #118, FIG. 10, interdigital electrodes oval loop quantum gravity structure, #122, #123. The Saint Andrew's cross pulls in between the oval loop quantum gravity design connecting wave energy propagation between the two decks running parallel and diagonally across the Saint Andrew's energy movement on the top deck of the crystal surface of this aperture window of this antenna. The comparisons in this article confirm that the enhancement of superconductivity strangeness is a mixture between electrical and magnetic pull to control the incoming wave that travels along with the radiational gravity fields which is a counterintuitive phenomenon but when applied to nanosize and distance in this miniature universe it brings together a full unified field design to produce an antenna process which is being presented for a patent application. The usual dual-deck scenario is that electric fields suppress superconductivity by either orbital or spin effects on to its lattice structure for the contraction holding of incoming light signal. This metal box springs design exhibits multi-transparent rainbow-striped layering of complex oxide compounds parallel to the superconductivity wire box springs will be enhanced in this mixture through the compensation of applied magnetic fields by the exchange field of the striped-oxide multi-layerings in conjunction with directional metamaterials to create negative refractive magnetic movements that travel along the sectorial zoning of negative indexing boundaries. These nano Zn and carbon wires quantum electrical vertical loop Hertzian wave placed on the lower deck as low-field negative magneto-resistance or as a relatively high-field enhancement of the connection with the upper deck oval loop quantum gravity connection, as shown in FIG. 10, interdigital electrodes oval loop quantum gravity, #119 through 126. This lower deck of the metal box springs has an even more counterintuitive phenomenon, called the antiproximity effect, which is where and when the temperature resistance which effects the wires are found to enter the multi-layering of the superconducting state from the normal state when the electrodes are driven normal by the oval loop quantum gravity oval magnetic upper deck field which is the reentrance refluxtivity fold being processed by the superconductive phase upon the application of small magnetic fields coming from the quantum electrical vertical loop wire waveguides that make connection to and through the oval loop quantum gravity equilibrium and into a resistive state by highly supplied currents quantum electrical vertical loop, as shown in FIG. 2, #44, #46, #34, #35, which is the connection to its dual power source of this device's Zn and carbon substrate electrodes. Page 2, FIG. 3 (b) (c) of the Chen article shows the cloud rising in which an applied magnetic field generates two effects: it suppresses superconductivity in the wire, in that it decreases the temperature when resistance returns to its normal state value which is called refluxtivity in this invention and the second effect the energy follows the boundaries between the normal state and the transition regime. The fluctuation of temperature suppresses and enhances the coupling effect between the two decks of this antenna, in that it increases the threshold temperatures for the zero resistance to follow the metamaterial boundary between the superconducting state and the transitional regime. In this antenna this enhancement gives rise to a magnetic-field-induced reentrance called folding and holding refluxtivity process that all waves are ruled by phases into the superconducting edge state of the lower deck which is now connected to the upper deck oval loop quantum gravity connection transition regime which is a miniature universe unified field process and magnetic-field enhanced superconductivity charge conversion process at the normal boundaries of phase Venn dome overlapping centers called oval loop quantum gravity as shown in FIG. 10, #120, #121 and #124. The nano-size and micro-distance within this quantum box springs design creates phase fluctuation folds that fold the waves through the crystal edge layerings of both decks which can enhance the control and dissipation by increasing the quasi-particle density. The temperature placed on the superconductor will suppress the fluctuations on the fold under the east side is the louder acoustic volume of the antenna's full length of the bar plate of the edge located FIG. 1, #27. The parameters of the lithographically produced wire configuration in the multi-layered oxides crystals include lengths, widths, and thicknesses of wires at universal distances that can be systematically changed because of its complex oxides Hertzian parallel striped cladding layers which interact with the electrical current being applied. The electrical current will change the direction of the center of gravity located in FIG. 1, #29 zero order rediffracted beam which will include all the loop quantum gravity ovals on the deck of the metal box springs surface. This is shown in Physical Review Letters, Vol. 100, 16 May 2008, Bifurcations to Diversify Patterns of Shear Bands on Granular Material by Kiyohiro Ikeda which states that granular material displays diverse geometrical patterns which are used in this metal box springs substrate shown in FIG. 2, #47 in order to produce the second and third crystal layerings in rows phases, as shown on page 2, to be used as the substrate platforms shown in FIG. 3, #70, #69. In this crystal layering shown in FIG. 2, #43 and #47 is a thin layer of square-shaped granular gold atoms which covers the entire rectangle platform that is a highly polished mirror connected to #34, #35, #44 and #46. As stated in Physical Review Letters, Vol. 104, 26 Mar. 2010, pages 1-4, Asymmetric Optical Second-Harmonic Generation from Chiral G-Shaped gold Nanostructures by V. K. Valev as shown in this invention, FIG. 2, #47 and FIG. 3, #66, is the highly polished metamaterial that effects the electromagnetic phenomenon in asymmetric second-harmonic generation form planar chiral structures. This metamaterial will be used as the substrate base that will possess a double refracting linearly polarized light for multipolar radiation mechanisms for the build-up of structural resonances of the collective oscillations of the metal electron plasma being injected from each layered folding edge of the plate. In FIG. 2, line #42 and line #48 are composed of a layer of InGaAs that is 17 nm thick. In Physical Review Letters, Vol. 96, 17 Mar. 2006, pages 1-4, the article Motion of an Electron from a Point Source in Parallel Electric and Magnetic Fields by Christian Bracher, depicts wave particle dualism patterns on macroscopic concentric interference fringes patterns which were recorded experimentally by Blondel and is being shown in comparison with the metal box springs design. In the same article on page 2 FIG. 1 (a), (b), (c) and (d) specifically depicts the visual dual movement that occurs in FIG. 1, #1 metal box springs design when the light wave runs along the metal box springs design structure. It also depicts the specific center loop quantum gravity shown in (a) as a center design form of a diamond shaped structure which are the oval loops. This classical trajectory field expands and contracts in the rhythm of the layered wiring waveguides in the metal box springs design which will produce coherent separation of multiple frequencies on the spectrum scale line. These Hertzian wavy lines, which in this invention are called metal box springs, on the upper deck are demonstrated in Physical Review Letters, Vol. 103, 2 Oct. 2009, Quasi-Bloch Oscillations in Curved Coupled Optical Waveguides by C. Martijn de Sterke. In this article Quasi-Bloch Oscillations as shown on page 2 diagram 1 (a), (b), (c), (d), (e) specifically shows the schematic of the waveguides in a slab of crystal that is coupling between each wave modes with a grading vector due to the periodic curvature grading complex oxide stripes being acted upon by propagating light wave. This depicts specifically the repetitive parallel complex oxide stripe waveguides in FIG. 1, #5, of this invention and also shows the input waveguide on FIG. 1, #27. This polariton condensates movement in this metal box springs as stated in the article Polariton condensates by David Snoke August 2010 Physics Today and shown in FIG. 1, #29 zero order rediffracted beam #27, FIG. 2 #36 indicates the special properties of the Bose-Einstein condensates in a vacuum of superfluid helium-4 which is placed in between the two-deck layerings in this microcavity and are strongly interacting as shown in the diagram #1 (a) on page 46 half vortices showing the movement of FIG. 1, #27 from west to east on the metal box springs rectangle antenna which in the path around this vortex at the leftmost point of the outer dashed ring at #27 is the phase of the polariton wave function which rotates in a 180 degree movement at the top surface of the first fold. This is used in this invention metal box springs to produce coherent polariton in this microcavities for this nonlinear optical gated folding amplification, optical spin Hall transport, and optical parametric entangled photons pairs and optical pumping folding on the boundary edges of this metal box springs. When the incident light movement travels inside the cavity of the metamaterial matter on the negative left-handed boundary line, the Z folding under effect of refluxtivity happens on the west side of FIG. 1 and shows the output of the reversing of an incoming incident wave. All of the waveguides in FIG. 1 of the line wave wire layerings will be placed on the north side of each line wire made of a cladded AlGaAs that is 30 nm thick that will change the amplitude of the wave guide mode in this metal box springs. The next layering is shown in #48 and #42 which is comprised of a transparent mirror that is comprised of bismuth selienide top line and bismuth antimony bottom line. In layers #41 and #50 is a layer of mercury delluride which will be used in this device to detect far-infrared radiation. This complex oxide composition of layering is shown in FIG. 2 and FIG. 3, #63 through #66, which is the lower deck and the substrate of the electromagnetic quantum electrical vertical loop connection to the top deck metal box springs design through to the each oval loop quantum gravity. This lower deck quantum electrical vertical loop wire is mentioned in Geometry and Light by Ulf Leonhardt and Thomas Philbin pages 29 and 30 discussing Feynman's interference of the paths in FIG. 2.13. These paths and the pathways in this Hertzian sine cosine metal box springs carry oscillating amplitudes with a phase that is proportional to the optical path length as opposed to the cloaking application would cause interference, but in the use in this broadband metal box springs it creates the interference necessary to connect to the upper deck of the oval loop quantum gravity region because of the red line bending as shown in the article on pages 29 and 30 which in this metal box springs wants this to happen because the path way connects with the top deck oval loop quantum gravity structure to trap the incoming light wave in between the oval loop hole. As stated on page 43 optical conformal mapping, et al., Leonhardt [2006 a] that profile is designed in this Hertzian sine cosine metal box springs such that gravity light rays form closed in upon the Venn dome overlapping oval loop quantum gravity as depicted in FIG. 10, interdigital electrodes oval loop quantum gravity, #119 through #126. Here the light is retroreflected, regardless of direction on both sides of Venn dome overlapping in the oval loop quantum gravity, shown in FIG. 10, #121, #120, #124, #123, respectively, and as stated in Leonhardt, et al., page 48, in this Einstein theory containing terms quadratic in the curvature tensor is renormalizable in flat space perturbation theory. In Physical Review Letters, Vol. 97, 20 Oct. 2006, Asymmetric Propagation of Electromagnetic Waves through a Planar Chiral Structure by V. A. Fedotov discusses transmission of circularly polarized waves through the lossy anisotropic planar chiral structure is asymmetric in the opposite direction. This lossy dielectric can make an effective quasioptical load, but minimizing the reflection coefficient is still a major design consideration because the line wire thickness of the dialectic layers is typically closed to a quarter wave length in the medium, called in this invention refluxtivity. The article in Physical Review Letters, Vol. 102, 20 Feb. 2009, on pages 2-3, specifically indicates the antenna field directivity diagram grid of the waveguides that are elastically flexed and interweaving modes in curved binary arrays of single waveguide excitation dynamics. Page 3 of the same article depicts the same design wave guides in real time process of oscillation modes in binary wave guide arrays which depict specifically this new metal box springs invention. This metal box springs design structure is two co-rotating stripe complex oxide bleeding across the elliptic bleeding Hertzian polarizations design structures. This planar chiral metal box springs structure is reversed when it is observed from opposite sides of the rectangular frame bar angles. Consequently, if a planar chiral structure were to exhibit a transmission polarization effect at normal incidence, the effect would be reversed for an electromagnetic wave propagating in opposite directions. This is a total new way of producing the collection and separation of the light wave in a nano-size negative-refractive metamaterial development design. This refluxtivity is previously known but not widely used as a fundamental phenomenon of electromagnetism. It is a polarization sensitive transmission effect asymmetric with respect to the direction of the wave propagation due to the Hertzian waves which are ruled by phases and parallel striped complex oxides. The new complex oxide design effect and metamaterial resembles the famous nonreciprocity of the Faraday effect in magnetized medium but requires no magnetic field for this method to work. This results from the interaction of an electromagnetic wave with a planar chiral structured patterned on a sub-wavelength scale that selects the spectral ranges. Both in the Faraday effect and that produced by planar chirality, the transmission and retardation of a circularly polarized wave are different in opposite directions. In both cases the polarization eigenstates, i.e., polarization states conserved on propagation, are elliptical and which are called oval loop quantum gravity in this invention. The asymmetry of the Faraday effect applies to the transmission and retardation of the incident circularly polarized wave itself, and the eigenstates of an anisotropic Faraday medium are two elliptically polarized wave of opposite handedness. The planar chirality effect leads to partial conversation of the incident wave into one of opposite handedness, and it is the efficiency of this conversion that is asymmetric for the opposite directions of propagation. The article in Physical Review E, Vol. 75, 2007 Influence of parametric forcing on the nonequilibrium dynamics of wave patterns by S. I. Abarzhi, states that the first principles for a variety of physical systems, such as optical systems, Faraday ripples, and rotating fluids are designs which is the same pattern depicted in the metal box springs which conducts matter into electrical energy of this driven convection in nematic crystals as depicted in the Ginzburg-Landau equation. The Abarzhi article depicts visual diagrams on pages 4-9 showing the wave length amplitude and group velocity in design which specifically depicts the domain around the wave sources that are associated with this metal box springs antenna directivity diagram when it is placed at the time the incident wave hits the surface which undergoes transitional mode in these multiple wavelength designs. Therefore, the metal box springs design is the truest parallel pattern dynamic change in the way in which waveguide propagation direction and process of incoming light wave signals are processed. The Abarzhi article is a landmark in the discussion of design process associated with the metal box springs. The top plate surface of this metal box springs is composed of a thin layer of calcite-opal prism in order to separate white light through the double line refraction that will produce a color prism refraction that will run north to south and down into the cavity of this antenna. This first separating, dividing and selecting of incoming multiple frequency signals to sectorial metamaterial zones on to the transparent crystal surface are through the quantum oval loop connection down to the mirrored lower deck of this antenna. This is related to the article in Physical Review Letters, Vol. 100, 15 Feb. 2008, pages 1-4, Wave-Front by Huygens-Fresnel Principle for Nonlinear Optical Interactions in Domain Engineered Structures by Yi-qiang Qin. The use of ferroelectric domain structures being placed on the north and south of the lines of the metal box springs nonlinear multifunctional properties controls the wave-front through the use electrical carriers through optical lens and prism-like domain morphology. The frequency scanning is processed on this two-deck antenna directivity diagram in order to direct the separating white light into color frequencies for hooking the refluxtivity backward movement in the wave form substance of this metal box springs. The medium is described by a complex energy transmission matrix X for the field amplitudes of the incident of the energy wave which could be either right positive or left negative circular polarization. The introduction of X-wave and Saint Andrew's cross of this energy transmission matrix is transparent cutting diagonally through the separation of the Hertzian wave disconnection in the rectangle horizontal movement of the metal box springs in FIG. 1, #5, #6, FIG. 4, #78, #84. The opposing X directions of propagation will be mutually transposed for the direction of propagation equality of the diagonal design element of the X's left line which is negative and the X's right diagonal line which is positive right. This implies that losses and retardation are identical for left to right waves as the energy passes along the X and down through this transparent structure. The two diagonal lines of the X make connection as shown in FIG. 2, #34 and #41 which are also connected to the electrical power source. The other two diagonal Xs located in FIG. 2, #35 and #50 are the frequency modulation which glide across the rectangular deck which connects with the downward mode as shown in #36. This X or Saint Andrew's cross is connected to the quantum oval loop gravity as shown in FIG. 1, #29 zero order rediffracted beam which is the controlling point of the incident surface wave. The movement from left to right is switching between left to right diagonally of the incident waves, leads to a change in the intensity band phase of the corresponding left to right on all oval loop quantum gravity design which converts the design wave components. This new propagation phenomenon described by the matrix in the above-mentioned article is a fish-scale planar structure but in this invention it is called metal box springs planar refluxtivity dual structure. This metal box springs design wave sidewall will have a north and south and east and west side wall of complex oxides attached to copper substrate strips alongside superconducting layering. The metal box springs platform scale size is 1 mm thick and is housed in a 20 mm×30 mm rectangle square which ensures that the periodic broadband movement is being manipulated through a macro, micro, nano size dimension that will produce the right connective rhythm and depth for holding and folding the incoming gravity light wave signal. Page 2 of the Abarzhi article visually describes enantiomeric forms that conclusively proves the truth of the metal box springs design and also the connection of FIG. 1, #2, #3, #4, #27, FIG. 4, #72, #73, #77, FIG. 5, #94, #96, #97, #98, FIG. 6, #100, #101, #105, FIG. 7 #107, FIG. 8, #109, #108, #111 show the planar chiral relaxed position, expanded position, and maxim expansion position of the springs pattern connection that is a unit vector of twist springs that connect the metal box springs wire grid all the way around the rectangle metal frame. These springs, as mentioned above, are discussed in Science, Vol. 311, 14 Jan. 2011, in the articles, A New Twist for Electron Beams, by Rodney Arthur Herring, page 155-156 and Electron Vortex Beams with High Quanta of Orbital Angular Momentum, by John Unguris, pages 192-194. As in this invention spring apparatus is also being described in these articles concerning spiral wave fronts of the electron vortex beam carriers. These helical wave fronts carrying orbital angular momentum are vibrational expanding springs which enhance the phase contrast along the edges of the frame that are diffracted beams from the hologram that rotate in the opposite direction and which are made of a combination of strained gallium arsenide crystal. This is shown in FIG. 6, FIG. 7, and FIG. 8 and are visually shown on page 192, FIG. 1, of the Science journal article. These new types of electron beam lithography will enable the building of this three-dimensional nanostructure in which atoms are packed up, moved, and set in place rapidly and accurately which brings this invention into reality. The 36 empty holes and 36 spring hooks are synchronized along the rectangular pattern rim and each hole point according to the cork-screw law. This cork screw connection rotates in the same direction as the chiral pattern. Then the connection moves along in the same direction as the chiral pattern and then it moves along W vector W invariant to which the side of the pattern definition is applied to the twist vector of the enantiometric patterns antiparallel to the edge of the frame. Now the vector W points along the direction of the structure which is perceived to be clockwise. Similarly, it is perceived to be anticlockwise if W points toward the observer. This metal box springs shows a new asymmetric polarization conversion effect linking together these loosely designed links because the modulations of the light wave correspond exactly to the phase design presentation of this reconjunction amplitude conversion. This concept of using light gravity in a four dimensional rectangle square 20 mm×30 mm 1 mm thick flat space that is using an oval loop quantum gravity connection, is shown in FIG. 1, #29 zero order rediffracted beam. The book, Time, Space and Things by B. K. Ridley, page 95, concerning electromagnetic interactions, states that the magnetic interaction of moving charges produced a bunching effect in the oval loop quantum gravity of the magnetic fields. Also, as stated in Physical Review Letters, 103, 13 Nov. 2009, pages 1-4, Junction to Prove Antiphase s-Wave Pairing in Iron Pnictide Superconductors by Wei-Qiang Chen, the series of multiple complex oxides that are mentioned below are connected to the north side of the wire Hertzian line box springs metal wire. As supported in this article and in this invention these complex oxides, shown in FIG. 1, #5, #6, repetitively parallel striping on the north side of the metal box spring wires in the same pattern formation in FIG. 4, #78, FIG. 5, #87, FIG. 9, #114, FIG. 10, interdigital electrodes oval loop quantum gravity, #119 are all shown on the north side in a repetitive layerings cladded alongside the metal box springs design in transparent complex oxide crystals, as listed here, is placed on the first line closest to the metal box springs is Gd₃Ga₅O₁₂, then the next oxides are TbMnO₃, and then followed by and cladded to Ni₃V₂O₈, CoCr₂O₄, Ca₃Co₂₋₂x, MnxO₆, URu₂Si₂, YBa₂Cu₃, O_{6.5}, Tl₂Ba₂CuO₆+, Nd2−x, CexCuO₄, Pr₁₋ₓ, Ca1+x, MnO₄, PyNi₈₆Fe₁₄, FeSa, NdFe, AsO, BaFe₂Sa₂, LaFeAsO, and UGe₂. These complex oxides are all strong ferromagnetism uniaxial, magnetic anisotropy, affected by electrical current and the incoming gravity light wave are cladded on to the north side of the metal box springs wire. The next set of complex oxides, listed below, are on the south side of the metal box springs wire and are layered in this order, closest to the metal box springs wire: URhGe, CeNi₂Ge₂, Sr₂RuO₄, CeCu₂Si₂, PbTiO₃, SrTiO₃ that constitute polarization reversal as described in Physical Review Letters, Vol. 102, 30 Jan. 2009, pages 1-4, Reversible Chemical Switching of a Ferroelectric Film by R. V. Wang, all the south side layerings are placed alongside on the Hertzian metal box springs and Hertzian multiple wire system as north and south borders of parallel stripe cladded to superconductors and antiferromagnetism separators. The greater concentration of striped layerings of complex oxides gives a greater resulting curvature of space and time combined with the bending of the light wave gravity distortions produced by all the complex oxides and the metamaterial mass of matter, causing the continuum at the edges of this rectangular box springs to bend back on itself and into the folding in a Z phase of the crystal plates. All of these complex oxide parallel stripes and all incoming incident waves are therefore ruled, collected, and selected by these crystal plate edge phases. This is shown in FIG. 1, #27, FIG. 2, #36, #41 through #44, FIG. 3, #58 through #66 and FIG. 4 #72, #73, FIG. 5, #94, #95, #96 and FIG. 9, #114. This overall symmetric metal box springs design form is a combination of a s-wave singlet state and a two folding and holding between the double deck symmetry in p-wave spin triplet state. Also, in an overall view the four-fold west-to-east movement of this symmetry refluxtivity of a d-wave spin state superconducting Tc in a phonon mediated interaction between this metal box springs design creates this realistic mode phase of electronic structural construction of the Ruthenates copper oxides and is the substrate crystal plate located in FIG. 3, #58, the s-wave and p-wave of which is described in Nature, Vol. 450 20/27 Dec. 2007, page 1178. These complex oxides are transparent crystal compounds that are the connection to the second overlapping dome optical oval loop quantum gravity in the tri-junction of these oval loop quantum gravity that make an overlapping Venn diagram connection between the gravity of the incoming signal, the optical crystal metal box springs and the optical-electric connection from the lower deck folding process as shown in FIG. 3, #67 and a close-up of this process in FIG. 10. This electrode design connection of magnetic fields exerts a combinational electrical suppression and expansion force on these two decks to produce the holding of the light waves moving charges. These coordinate oval loop quantum gravity design and wavy wires attract one another, accelerating or decelerating charges radiate electromagnetic waves as shown in diagram A on page 95 depict the oval loop quantum gravity oval design that are shown in FIG. 9, #117 and line #116 shows the force of the wire carrying electric currents through the center of the oval loop quantum gravity at #118. According to The Applicability of Mathematics as a Philosophical Problem by Mark Steiner the oval loop quantum gravity at FIG. 1, #27 and FIG. 10 are interdigital electrodes oval loop quantum gravity; #124 will be expanded dome and shrunk double continuously to a point to the second deck as shown in FIG. 2, #37, arrow at #36. The oval loop quantum gravity, punctured through their inner sphere, are simply connected to the quantum electrical vertical loop wire on the second deck. This psi-function is multiple-valued; this oval loop quantum gravity configuration space, such that traversing the oval loop quantum gravity, causes the function to switch values, i.e., adding a phase factor in which all waves are ruled by phrases and parallel complex oxide stripes. Then this oval loop quantum gravity contacts to a point, making the function switch values in an infinitesimal oval loop quantum gravity point, violating continuity. These mirror and material double dome oval loop quantum gravity can be contacted to a point only if it goes around the same oval loop quantum gravity again; then it comes back to its original design value on the surface of the metal box springs. Its original value is to hold together the vast bundle of light waves that are being folded and held in between the metal box springs design and the electrical energy matrix as shown in FIG. 2, #39. Specifically stated in Physical Review Letters, 104, 19 Feb. 2010, pages 1-4, Strong Field Interactions between a Nanomagnet and a Photonic Cavity by Ö, Soykal, this article diagram image depicts the oval loop quantum gravity that are used in the metal box springs connection to the waveguides and the energy source and the gravity that is connected to the electro-optical form; the article further states that in this quantum-mechanical treatment that produces large quantum-coherent magnetic-photon coupling can be achieved in the range of terahertz. Each oval loop quantum gravity produces strong constance coupling between light and electronic transitions permitting coherent transfer of quantum information between two systems, as well as a host of exotic phenomena, including slow light, lasing without population inversion, and index enhancement via quantum coherence, achieving strong coupling between light and electronic transition in solids. Each one of these oval loop quantum gravity as shown in FIG. 1, #2, FIG. 4 #81, FIG. 5, #88, FIG. 9, #118 and the close-up in FIG. 10, interdigital electrodes oval loop quantum gravity, #119 through #126 depicts the strong ferromagnet nanomagnet quantum loop quantum gravity electric dipole transition state design that is made of a transparent optical yttrium ion garnet layered across the oval loop quantum gravity on the first overlapping ring. The quantum wire length, width, and multiple layering guides the light wave in horizontal, parallel, vertical and crisscross paths that control the refluxtivity folding and holding of the movement of the incoherent incoming light wave and the re-diffraction coherent outgoing wave frequency that captures the full broadband along the stationary wire metal box springs design that re-captures the outgoing light wave in the full frequency spectrum of light wave. In Physical Review Letters. Vol. 98, 2 Feb. 2007, pages 1-2, Controllable Coupling of Superconducting Flux Qubits, by S. H. W. van der Ploeg, the key coupling between the oval loop quantum gravity as shown in FIG. 1, #7, and FIG. 10, interdigital electrodes oval loop quantum gravity, #124 is the electromagnetic connection between the lower deck electric wave wire guide shown in #126. This metal box springs oval loop quantum gravity and wave connection contain the three Josephson junctions that produce shared strong qubit-coupler interaction through this quantum Josephson mutual inductance and the use of ferromagnetic materials in this metal box springs pattern is a well-defined antenna directivity diagram grid wave shaping circuit hooking the refluxtivity of the frequency relay system in this antenna process. The Nature article, 28 Oct. 2010, Vol. 467, pages 1084-1087, Detecting excitation and magnetization of individual dopants in a semiconductor by Alexander A. Khajetoorians relates to the magnetic atom doped iron-cladded metal box springs and the double dome oval loop quantum gravity surface-dopants embedded with in a two-double-deck dimensional electron helium-4 gas confined to an indium antimonide 110 surface X Mn—GaAs plate on lower deck #63 results, as shown on page 1084 FIG. 1 (a), depicts the oval loop quantum gravity connection electrode of Fe double overlapping atoms surrounding InSb 110 surface FIG. 10. FIG. 10 is the core in the embodiment, specifications, and claims in the invention as is applied to all FIG. 10's noted in this invention. As stated in Nature article, Vol. 468, 11 Nov. 2010, pages 184-185, Mind the pseudogap, by Chandra Verma, and the Letter article, Vol. 468, 11 Nov. 2010, pages 283-285, Hidden magnetic excitation in the pseudogap phase of a high-Tc superconductor by Yuan Li, that on pages 184 and 283 of these issues, Li, et al., reports observing a special kind of intense collective electronic fluctuation in the most mysterious phrase of matter exhibited by high-temperature superconducting copper-oxides materials. As shown in FIG. 1, page 184, phase diagram of the cuprates depicts the strange-metal region of a quantum critical point of sectorial zoning areas between antiferromagnetic metamaterials materials and neighboring spin points in opposite directions. This is depicted in the invention FIG. 10, #121, #124 and between the crossover at #123. This crossover line in FIG. 10, #123, is a combinational transitional phase connecting all three unified field designs to produce the electric holding of the incoming incident wave that is being directed by the Saint Andrew's cross light-sensitive energy phase across the surface of the light sensitive crystal plate and down on to the metal box springs and on to the quantum oval loop shown in FIG. 10, #122 and coupling to the lower deck of the quantum electrical vertical loop connection in FIG. 10, #123 and #126. This gap transition is a gradual crossover between all quantum oval loops of thermodynamic and electric transport properties. As stated in this invention, the yttrium barium in which the quantum critical point is cladded on to the top dome of the oval, creating a double overlapping in which to create a loop dome-shaped superconducting design region of this phase, as depicted in FIG. 10, #122. This dome extension point placed on the loop region would produce a zero temperature and would involve a change in symmetry expansion of the material's electronic structure as shown in FIG. 10, #119 through to #126. Because the high-Tc superconductor is determined by the materials collective electronic excitations combinations in the non-superconducting state which is the constance coupling of electrons downward into the connective design to this excitation in the strange metal region which is the connection to the metal box springs and the quantum oval loop connecting to electron current vertical loop as shown in FIG. 10, #119, #120, #126, #125. This produces a long-range order phase in which pairs of electron current vertical loops flow within each of the materials unit cells or upper and lower deck which is called quantum oval loop connection to the electron current vertical loop and produces a pair of oppositely directed magnetic movements, as shown in FIG. 4, #80 and #84 which is the lower deck crossover. The change of symmetry is indicated in the metal box springs ability for expansion movement; therefore these modes of fluctuations from these design metamaterials across the sectorial zoning of opposite magnetic flow in nature are being controlled by the energy of Saint Andrews finite movement across the quantum oval loop and lower deck current quantum electrical vertical loop order, as shown in FIG. 4, #76, #79 overlapping #80. As shown the Chandra Varma, et. al., article, FIG. 2, loop-current electronic order unit cell shows a negative one side and a positive on the other side on each end of the cell. This is also shown in the quantum oval loop showing a negative Venn diagram overlapping connection shown in FIG. 10, #121 and a positive Venn diagram overlapping connection shown in FIG. 10, #124. Both the article diagram and this invention's diagram are one and the same, showing the connection of the complex copper oxide CuO material onto the metal box springs overlapping the quantum oval loop depicted in the overall design of FIG. 10 and the electron current vertical loop shown in FIG. 10, #126. This overlapping double on the oval loop quantum gravity, as shown in FIG. 10, that this oval effect due to protrusion expanse surrounded by circular depression which is the coupling up and down of the electric effect on to antiferromagnetic complex oxides and onto the superconductors that will compress the connection between both decks and surface incident beam through the use of these commercial n-doped In Sb single crystals in this doubling oval shaped electrodes into double Lorentzian amplitude. These complex oxides in this invention are all iron-based superconductors, antiferromagnetic, and paramagnetic in nature, sharing the layered structure. The article, Iron in the mix, by Gwyneth Dickey, et al., physicist Johnpierre Paglione at the University of Maryland in College Park, Md., In Science News Nov. 6, 2010, pages 18-21 states that it is always the layer with the iron that does the electron shuttling that connects each complex oxide that is connecting to the metal box springs design pattern. The other layers provide some structural support and keep unneeded electrons out of the way. The very top surface plate separates the white light into its color prismatic perspective of the rediffracted color forms down into the metal box springs waveguide system. The surface incident wave will cover the entire 20 mm×3 mm and 1 mm thick surface and will travel down to the nanowidth size of the wire design in which the light gravity vibration bounces on the metal box springs circuit wire system which gives the quantum play on Einstein's theory of space-time continuum as the floating wire design grid interacts with the multi-ferromagnetic and antiferromagnetic complex oxide superconductor crystal. This new metamaterial matter in a unique left-handed metamaterial way separates and disentangles, holds and folds the incoming light wave signal that will tell each entangled frequency where to go according to the metamaterial geometrical dual design substrate being implemented in this broadband antenna receiver system. As discussed in Physical Review Letters, Vol. 103, 28 Aug. 2009, pages 1-4, Radiation Characteristics of Electromagnetic Eigenmodes at the Corrugated Interface of a Left-Handed Material by Mauro Cuevas, this novel electromagnetic surface waves at a periodically corrugated interface between a conventional and a negatively refracting left-handed material that this surface polaritons radiate on both sides of this dual deck metal box springs rough interface along which they propagate. This unusual phenomena is characteristic of electromagnetic wave propagation in left-handed materials, such as negative refraction or backward refluxtivity wave propagation. The boundary separations between the sectorial zoning metamaterials and the metal box springs parallel complex oxide strip layerings help to create this electromagnetically impenetrable nonconventional process which exhibit a real negative electric permittivity—related to metals or plasmas frequency in these metamaterials which show their capacity to allow competing frequencies to guide along surfaces of plasmon polariton unimpeded to glide in opposite directions along their boundary separations lines. This metamaterial guidance property is also shared by separation of transparent materials with negative refractive indexes that allow the unintangled frequencies to modulate without interference. The boundaries areas in this metal box springs has multi-detailed separating layering of waveguides which have both negative electric permittivity and magnetic permeability materials which are characterized by an unusual negative refraction. The incoming incident wave and refracted beams at the surface interface between the negative refractive index and ordinary media lie on the same side of the split beam to the interface that creates a perfect lens with Hertzian sine cosine subwavelength waveguide resolution that has memory capabilities. In this same article in the diagrams depicted on page 2 (a) (b) and page 3 (a) (b) show the waveguides metal box springs design flux lines moving backward which is called refluxtivity in this new metamaterial process. The design of this new antenna takes total advantage of its perfect design and distance and multiple variations in nanosize that produces coherence out of incoherence of the traveling multiple radio light waves and incoming gravity waves coupling to this metal box springs formation design is related to three Physical Review Letters articles. The first is Physical Review Letter, Vol. 103, 13 Nov. 2009, pages 1-4, Edge-State Velocity and Coherence in a Quantum Hall Fabry-Pérot Interferometer by Yiming Zhang. This article relates to the idea of Coulomb blockade with a checkerboard like design conductance oscillations that utilizes a perpendicular magnet field on the edge-state velocities of the dual use of the wire waveguide. As stated in Physical Review Letter, Vol. 100, 25 Apr. 2008, pages 1-4, Nonlinear \check{C}erenkov Radiation in Nonlinear Photonic Crystal Waveguides by Y. Zhang, article and this invention of a metal box springs is an example of a nonlinear \check{C}erenkov radiation generated from a nonlinear photonic crystal waveguide where the nonlinear susceptibility tensor is modulated by the ferroelectric domain, as shown in FIG. 1, #5, #6. These wire waveguides and metamaterial substrate design particles which will be traveling faster than the speed of light can drive the medium to emit coherent light called \check{C}erenkov radiation. In such a process the coherent radiation is observable at a conical wave front defined by the \check{C}erenkov angle. This metal box springs invention is a nonlinear polarization driven by an incident light field which will emit coherently harmonic waves at new frequencies along the direction of the \check{C}erenkov angles which are shown in FIG. 2, #51 in sequential repetitive Hertzian wave quantum electrical vertical loop mode. This sinusoidal wave line waveguide shape of oscillations seen in this article suggests that coherent transportation is dominated by two trajectories that differ in length by one transversal of a hole perimeter. On page 4 of the same article the pattern design function is identical and gives conclusive proof that the metal box spring device being presented for a patent application is true. The article in Physical Review Letters, Vol. 103, 13 Nov. 2009, pages 1-4, Crossover Induced by Spin-Density-Wave Interference in the Coherence of Singlet Electron pairs in Cr by J. W. A. Robinson, is being introduced because the metal box spring design uses antiferromagnet substrates of Nb—Cr—Nb Josephson junctions and coupling is achieved across this antiferromagnetic crystal substrate that is a 250 nm thermal oxide layer on the entire surface deck of the metal box springs FIG. 2, #50. The last article in this series concerning coherent broadband radiation in the form of Rabi sidebands appears in the Physical Review Letters, Vol. 103, 13 Nov. 2009, pages 1-4, Observation of Broadband Time-Dependent Rabi Shifting in Microplasmas by Ryan Compton. Also in Physical Review Letters, Vol. 103, 27 Mar. 2009, pages 1-4, Experimental Observation of Rabi Oscillations in Photonic Lattices by Ksenia Shandarova: these articles are typical examples of a two-level atomic system, where an electromagnetic wave whose frequency is tuned to the energy gap between the two states causes periodic population exchanges accompanied by emission and reabsorption of a photon which in this article is called an indirect Rabi oscillation which in this invention is called refluxtivity. The Rabi sidebands and the Hertzian sine cosine metal box springs quantum line wire are one and the same as shown in FIG. 1, #11, #12, #13, #14, #15, #16, #17, #18, #19, #23, #24, #26, #28, #30, #31, #32, #33, from left west to right east producing mobile atomic transitions of a coherent and turnable radiation source phenomena. In this article on page 1, FIG. 1, the dynamic drawing indicating the state energy level scheme for a two-level system is being used in this invention of the metal box springs design. As in this article, this invention uses in the metal box springs multiple wave complex oxides along the sidebands which give rise to bandwidths on the order of 200 meV. The coherence is maintained across this spectral range and the light could be shaped and manipulated for this new metamaterial application for this new metal box springs design. It is true that the high degree of superposition will create the necessary coherence for the separation of the entangled radio sine waves that are being received by this new refluxtivity process. According to nonlinear science Series A, Vol. 31, Synchronization in Coupled Chaotic Circuits and Systems by Chai Woh Wu, World Scientific Publication, the wave mechanics of refluxtivity in the design form of this invention is generally associated with on-the-faster-you-move-the-more-distance-contracted basis of the Lorentz Fitzgerald contraction and Einstein's special theory of relativity. The reason for this is the electrical current is being applied on to a superconductive material which causes a Lorentz invariance that postulates that all observers measure exactly the same speed of light in a vacuum of photon speed with energy on the direction of its motion associated with Einstein's special theory of relativity of a body warping the space of center of gravity's magnetic formation design. The reason for this warping in this invention is brought down into electrical current passing through complex oxide superconductors. These new metamaterial and complex oxides will become the abstract core in this new antennae. This Hertzian sine cosine metal box springs is an Abelian-gauge transformation in combination with invariance of Maxwell's equation under an Abelian-gauge transformation is the metal box springs symmetry in this two-stack design which is equal to the invariance of Einstein's equation under local arbitrary coordinate transformation and general covariance. This proved that Maxwell's equations are virtually the only equations that are both Abelian-gauge and Lorentz invariant. In this metal box springs design symmetry becomes what these men produced in physics which now becomes an antenna between general covariance and gauge invariance which is the key to the unifying electromagnetism with gravity in this miniature nano unified field universal design. Therefore, the gauge transformation together with Lorentz transformation of special relativity determined Maxwell's equations. The conclusion is that the metal box springs moves from global to local invariance in quantum mechanics and is the equivalent to the existence of the classical electromagnetic field described by Maxwell. Specifically, this design feature in the metal box springs is directly related to the Dirac confined process the radiation in a box. This metal box springs is the box associated with Dirac energy that crisscrosses diagonally in Maxwell's theory which gives the radiation as a superposition of countability. This superposition layered wiring of complex oxides modes is the layered superconducting Hertzian sine cosine metal box springs mode design and is equivalent to a vibrating harmonic oscillator which is controlled by this metal box springs vibration cushion from the force that gravity placed on to this surface of a Lorentz's universal matrix. Each vibrating harmonic oscillator can be quantized, according to Schroedinger's equation or Heisenberg's equivalent approach. The quantized field, then, is the flat multi-dimensional superposition of countability of many flat horizontal layered complex oxide crystal superconductor. This quantum oscillator produces a phrased transition on each crystal fold traveling from west to east which produces the new refluxtivity folding and holding antenna. This process of refluxtivity motion phase is the folding back in upon its dual deck stacked layering on the nano metal box springs, according to P. Dirac's idea. The crystal complex oxides contains a second derivatives of empty space between its lines symmetry of Hertzian sine cosine symmetry and the miniature nano size wire in order to produce a chemical reaction between complex oxides and the incoming signal and the different chemical complex oxide spacing. As shown in FIG. 1, the entire design diagram and in FIG. 10 shows this metal box springs design function of the traveling of the coupling constance down to distance scales much shorter than can be accessed experimentally. This traveling of the coupling constance waveguides in the energy movement in this band gap across the wire design and plane wave wire layer of superconductor is being shown as the coupling constance to this metal box springs design shown in FIG. 10, which are called interdigital electrodes oval loop quantum gravity, #119-#126. In the middle of these continuous oval loop quantum gravity the Saint Andrews X matrix energy movement breaks diagonally, crossing the metal box springs symmetry alongside the coupling constance on the top surface crystal connecting both the metal box springs and the oval loop quantum gravity as shown in FIG. 1, #29, center oval loop quantum gravity and all loop quantum gravity in the rectangle box grid. In Physical Review E, Vol. 62, #3, September, pages 4189-4245, the article by A. Bourbier, Dynamics of a charged particle in a circularly polarized traveling electromagnetic wave, proves and states the reality dynamics of charged particle in a transverse circularly polarized electromagnetic wave based on Hamiltonian system. In this article and in this invention antenna design is negative index of refraction is a unity of synchronous metal box springs. The light wave is synchronized on the surface deck that connects the energy movement across this rectangle space in this metal box springs connection of the coupling constance to the loop quantum gravity under pinning and holding the top surface of the metal box springs together in FIG. 1, #29 which is a zero order rediffracted controlling beam guide. This connective beam is shown in FIG. 4, #80, #81, #82, #83, #84, FIG. 5, #86, FIG. 9, #117, #118, FIG. 10, and is called an interdigital electrode and oval loop quantum gravity structure. As shown in FIG. 10, #122 and #123 connect the lower deck to the center of the oval loop quantum gravity design wave energy that produces the coupling constance down to distance scales much shorter than can be accessed experimentally. The coupling constance wave connection propagation on to the two decks produces a scanning selecting process geometrically in a parallel diagonal X across the top deck of the crystal surface window. As specifically shown in the article on page 4241 top diagrams (a) (b) (c) (d), the line crossing the loop quantum gravity is a Fourier transformation as shown in FIG. 10. As stated in Physical Review E, 19 May 1999, Vol. 59, No. 5, pages, 5862-5870, Electrostriction of a near-critical fluid in microgravity, by G. A. Zimmerli, the metal box springs design is the same low gravity environment in the electrostriction fringe patterns that change the optical path length of a wave passing through fluid which is calculated by integrating the density increase along the light path, using the Lorentz relation to relate the change in fluid density to a change in index of refraction. And as stated in Physical Review Letters, Vol. 104, 12 Mar. 2010, Subwavelength Plasmonic Lattice Solitons in Arrays of Metallic Nanowires, by F. Ye, stable subwavelength plasmonic lattice solitons are formed in nanowires as shown in FIG. 1, #5, antenna directivity diagram grid combined with a strong nonlinearity induced by enhanced field at the metal surface as shown in FIG. 2, #37 which is the frequency division on the lower stack that is a frequency doubter that provides the main coupling physical mechanism for balancing the wave diffraction and the formation of the plasmonic lattice solitons as shown also in FIG. 4, #82, FIG. 5 #89, FIG. 9, #116, FIG. 10, combine to the interdigital electrodes oval loop quantum gravity structure, #126 in this subwavelength nanophotonics which will optically manipulate with nanometer accuracy the power flow in ultracompact photonic system such as in this metal box springs design. The article Solitons by Claudio Rebi in Scientific American, illustrates where the lower deck Hertzian sine quantum electrical vertical loop wire system as shown in FIG. 2, #37 is a repetitive pattern of solitons that hold the refluxtivity in a folded position in this rectangular antenna. The article in Physical Review Letters, Vol. 103, 6 Nov. 2009, pages 1-4, Spin Hall Drag in Electronic Bilayers by S. M. Badalyan predicts a new effect in electronic bilayers in the spin Hall drag effect. Both this article and in this invention this double layer structure consists of two parallel quantum wells separated by a potential barrier which is on a nanoscale electronic process scale. Each edge of the rectangle on the surface layer has 36 empty holes with 36 springs hooked holding the metal box spring structure grid. The same article on page 2 diagrams A, B, and C indicates that the edge of the metal box springs rectangle is comprised of ten empty holes on the north area of the rectangle and the south top layer is comprised of ten empty holes which are negative in the metal box springs rectangle square plate frame area. In the metal box springs are ten empty holes in the north side of the rectangle as shown in FIG. 1, #2, and are all positive Coulomb drag current modulators. Also in the south end of the metal box springs design are ten empty holes that are all negative, causing electron opposite spin orientation. In diagram B of the same article cited above, on the west side of the rectangle of the metal box springs are eight empty holes indicating a downward spin interaction through the empty holes and on the east side of the rectangle of the Hertzian sine cosine metal box springs is eight empty holes of the spin orbit interaction going up. FIG. 1, #29 is the quantum oval loop connected to the horizontal repetitive box springs wave guide and FIG. 2, #36 is the vertical incoming light signal on a zero order rediffracted beam. This is the universal gravity drag of this miniature universe that has been created for frequency relay folding and frequency scanning holding to occur on the first incident of the light wave hitting the surface of the antenna. The entire light beam spreads across the entire directivity diagram rectangle grid for frequency modulation and frequency divider that produces the white light into color prismatic separation of all incoming entangled radio waves to bounce into the center of the metal box springs when the movement travels from the south to north of the electromagnetic force field that separates the frequency relay system to scan it through to the calcite opal crystal in order to do a separation collection frequency scan. In this active region where wave-shaping circuits phase modulation occur in this nano-scale that traverses the 20 mm×30 mm inch rectangle and penetrates into the 1 mm thick wafer. As this continuous coupling constant multi-scale transverses distance and size of said waveguides is equal to or is smaller than the wave guide but the distance it travels within the 20 mm×30 mm square now becomes a small universe which is essential for retrodiction refluxtivity mode amplitudes which start from the unconjugated form of the Lorentz reciprocity theorem. This layered gas and solid state stacked antenna directivity diagram grid in combinations soliton with the amplitudes are independent of the vertical energy wave, shown in FIG. 10 # between #126, which become staggered and staggered soliton on the lower deck but on the top deck connection becomes staggered and become refluxtivity movement backwards hooks the phrase process parallel complex oxide stripes fringe on all bandwidths of the complex oxides that the frequency scanner glides along the antenna phase array for selection process. This also takes into account the valley current collection in this multi-state quantum-confinement of this metal box springs device which will not turn off or trap the current completely when they are off-resonance. Since this device hooks and holds the backward movement that produces an on-and-off phrase state in this antenna, the coupling constance will be clearly distinguishable because the circuit architecture in this metal box springs is built to be tolerant of this potential sensitivity of the peak-to-valley current ratio that will be as large as possible within the distance of nano meter length and width of the parallel complex oxide stripes fringe of this large scaled level of multiple ferroelectric and antiferromagnetic layerings. In this nano-miniature unified field universal design, as stated in Overview of Nanoelectronic Devices by David Golghaber-Gordon April 1997, The proceedings of the IEEE pages 10-13, the exchange in fringe order at a lateral distance between nanosize and the complete distance of the nano wire has to travel the full square of 20 mm×30 mm in a micro-macro scale. As stated in the above-mentioned IEEE article as well as in the Physical Review Letters, Vol. 102, 17 Apr. 2009, pages 1-4, Cross Conversion between Surface Plasmon Polaritons and Quasicylidrical Waves by X. Y. Yang, transparent metallic surfaces that are nano-textured play a central role in the emerging field of plasmonics as nano-micro-and-macro collective optical properties are governed by two distinct elementary waves that are excited by individual nano-shaped objects and then propagate on the surface, before eventually interacting electro-optically with nearby nano-particle objects. The well-known surface Plasmon polariton surface mode and a residual quasiclindrical wave are acted upon by the use of metamaterials of said electromagnetic fields with radiative and evanescent components that persists along the surface over a few wavelength propagation distances. Many complex oxides will be layered in this metal box springs fringe parallel striped design in order to equally excite and divide at visible frequencies at a longer wave length which is associated with nano-size widths and 20 mm×30 mm distances and 1 mm thickness of this surface antenna which provides an unique folding phase refluxtivity of the hundred meter light wave bunching that occurs on a nano-scale level of the incoming light wave. The size, the distance, the thickness and multiple parallel complex oxide fringe stripes creates the volume of the surrounding space of the photon which occupies a well-defined chemical frequency by the use of specially prepared crystals which converts the light wave separation and bunching up of the incoming and connective electromagnetic field that corresponds to the lower deck wire design and the nano-size single photon which is a thousand times higher inside the cavity than outside. As a result the photon is worked by the dual phase folding refluxtivity in the antenna surface and cavity stacked plates for a smooth interacting guiding coupling constance along the wire pathways that separate and selects the frequency into the refluxtivity phase folding and refluxtivity holding position. The distance between the peaks of the wave is related to the particle's speed and broadband process. The smaller the distance from the peak to peak, the faster the particle is going; the wave's frequency is proportional to the energy of the particle. In fact, the particle's energy is exactly equal to the frequency times Plancks. The Kirchoff law of electrical circuits in relation to currents at a junction of the metal box springs and the quantum electrical vertical loop lower-deck voltage wrap around the oval loop quantum gravity design function as shown in FIG. 10. The Physics of Waves, by William C. Elmore, page 347, depicts a comparable aperture of the metal box springs invention of a flat rectangular aperture of 20 mm×30 mm in dimension which the surface plane screen is like a Cartesian coordinate system with its oval loop quantum gravity origin at the center of the aperture located in FIG. 1, #23 through #29 and FIG. 2, #36 is the connective incoming light wave but is also related to the Reimann hypothesis of the critical line and the mystical ley line running through the landscape which is creating the coupling constance in this metal box springs design at a zeta function zero order rediffracted beam in a repetitive form. The electrical current suppression on to the superconductor materials and the resulting vibration are the inverse square factor of a full Kirchhoff integral. This will also encompass Lenz's law which is a form of the law of conservation of energy. Since it states that a change cannot propagate itself, the coupling constance between electrical and gravity movement change is the motion of conduction through the magnetic field and the induced current must be in such a direction as in this invention design produces a force opposing the motion produces the wave phase line in the direction as opposed to the change is the phase folding refluxtivity holding the signal in place. The Physical Review Letters, Vol. 100, 6 Jun. 2008, pages 1-4, Anti-crossing of Spin-Split Subbands in Quasi-One-Dimensional Wires by A. C. Grahams confirms the varied and complex physics of the quantum Hall ferromagnetic-a 2D electron and hole system tuned to bring two Landau levels into coincidence which depend delicately on interaction strength, carrier density, and the forms of the wave function and the interaction of the spin in the two-deck levels. This design process of quantum Hall ferromagnetic in this metal box springs is a Zeeman-split sub-band conductance structure, in this invention of a metal box springs antenna is the finite duration of the wave train traveling with a photon, causing a natural line width which waves can always be superposed on one another. The reason for this is that the Hertzian sine and the cosine curves for various parameters can be chemically activated upon one another. The duration of the wave train coupling constance is related to the lifetime of the two atomic energy states. These two atomic states are connected with the emission of the photon. Hence light waves passing a point in a Hertzian sine cosine wave field from such as quasi-monochromatic source retain a reasonably definite phase and amplitude, known as analogs, which have the same temperature dependencies crossing at zero. These definite phases, with an abrupt change in the magnetic polarization of the quantum wire of this anti-crossing magnetic phase transition, as specifically shown on page 2 in the Graham article cited above in a real-time diagram depict the visual reality truth of this new antenna directivity diagram grid in this Hall system. This spin-orbit coupling will play a role in the multiple parallel layering of complex oxide stripes cladded alongside of each wave wire on the metal box springs design that will be made of many cladded north and south randomly placed layering of GaAs on the south side of the metal box springs shown in FIG. 4, #85. This produces a unified field design effect transistor amplifiers waveguide and modulators selectors in the metal box spring crystal Hertzian formation. The GaAs layerings will be separated but cladded so that the electron energy in different orbits cannot be arbitrarily close because of the fixed wave length separating the wave function's crests; changing the energy slightly causes the wave to crest, to go out of synch. The metal box springs will hold the energy in a finite amount in order to ensure that the crests fall on crests again. As reported in Guided-Wave Optics in Scientific American, January 1979, by Amnon Yariv, Whenever a light wave traveling through one material strikes a flat interface separating it from another material that has a lower refractive index, the discontinuity in the refractive index causes part of the wave to be reflected back into the first material which is the refluxtivity fold and hold. The rest of the beam is refracted, transmitted at an angle into the second metamaterial substrate cavity. The critical angle of incidence is measured from a line perpendicular to the interface. The phase folding refracted wave will emerge parallel to the interface and at a great angle of incidence cutting along the edge. The phenomenon of total internal reflection takes place only if the double negative refractive index of light is reconnecting in a perfect match. This metal box springs embodiment, specifications and core claims that said broadband antenna will not disconnect from the incoming signal which will reverse the Mossbauer effect which is now being corrected through the use of unnatural manmade sectorial zoning of metamaterials and complex oxide superconductors embedded into the metamaterials substrates sandwiched between helium-4 gas which is converted into a solid. The substrate superfinely selectively tuned frequencies for emission and absorption of light into this receptive metamaterial is reconnecting nature's abnormality in the process traveling of the frequencies. The metamaterial atoms emit and absorb light differently near the frequencies in the quantum matter being developed in this invention using metamaterials. The light is emitted and absorbed not at fixed and precise frequencies, but in frequency intervals of separation finite width which is now being trapped by the sectorial zoning of the metamaterials and complex oxides to produce the reconnection holding and phase folding of said interval of the incoming light signal. In the Mossbauer effect, emission and absorption happens not at the single atom but the entire cavity of the crystal which in this invention produces this effect and goes a step further to re-correct, connect and reconnect the separation emission and absorption on the entire crystal structure's sectorial zoning of the metamaterials which corrects nature's natural gap in the frequency mismatch. The light emitting crystal and an absorbing one of the same type are position at different broken altitudes, thus, general relativity comes into play plus the negative refractive indexing of metamaterials. Time progresses differently for the emitting crystal than it does for the absorbing one, causing a frequency mismatch disconnection in the light that reaches the absorbing crystal in nature. But the re-construction of sectorial zoning created by a manmade optical metamaterial to re-connect to the emitting broken mismatch for reconnecting and holding of said light signal in place. This also re-connects to the absorbing sectorial zoning to this reversal of this natural mismatch connection that completes the light that passes into the absorbing crystal. This mismatch is now corrected through the unnatural metamaterials sectorial zoning on the crystal optical media re-reversing done by the metamaterials' opposite which is now its reconstruction and re-connection to this altitude mismatch. The correction re-connection to the separation in the negative left-handed refraction reversal is now connecting to nature's mismatch that was preventing the light signal from being absorbed and held correctly into the middle cavity which is made of helium-4 gas vacuum. The completion of the traveling coupling constance in this dual deck of the metal box springs and the lower deck emission and absorption process occurs in different states in continuous traveling mode through all the transparent crystal cavity layerings. This simple fact between nature's dysfunction and manmade unnatural metamaterials corrects this disconnect to reconnect, hold, and reverse this mismatch which is by the use of left-handed negative refracted sectorial zoning metamaterials, solving the frequency mismatch by which the light wave signal can be re-connected to the light signal that absorbs, holds and never disconnects from the device such as a cell phone. The light-conducting metamaterial is greater than that of the adjacent transparent material. As stated above, this transparent metamaterial slab waveguide, GaAs, is grown on a thin crystalline layer of gallium aluminum arsenide which is Ga₁₋ₓAlₓAs. This layer is surmounted by a thin layer of pure gallium arsenide which is in turn surmounted by another layer of gallium aluminum arsenide. The index of refraction of gallium arsenide is greater than that of the gallium-aluminum arsenide, and so light can be guided in the intermediate gallium arsenide layer as shown in FIG. 3, #63, #64, #65, #66. In this phenomenon known as electrical-optical effect of wave guiding properties, these layered metamaterial depend strongly on the index of refraction. The application of an electric field on to a transparent waveguide can drastically modify the nature of the propagated light beam. This electro-optic control method is used in this metal box springs design to harness the rapidly modulating, switching and coupling Hertzian sine cosine sine light beams. This waveguide is the process call antenna directivity diagram coupling grid. The basic effect here involves eight parallel horizontal waveguides which is the reconnective dysfunction that the metamaterials correct which are not close enough to each other for the outlying portions as shown in FIG. 1, #11 through #33 of the light propagating in one waveguide to reach across to the other waveguide and vice versa. Under these conditions a wave propagating in one waveguide will gradually leak into the second waveguide, provided the velocity of the Hertzian sine cosine waves in both waveguides is the same as long as both crests fall on crests again, even if the design crest is flat and perpendicular to the quantum electrical vertical loop crest, as shown in FIG. 4 dash lines #76 and #79 and FIG. 5 #91, #92, #93, #86, #87, and #89. The equality of the wave velocities ensures that the excitation of the waveguide's leaky field of waveguides is in the exact pulse phase with the wave propagation in metal box springs waveguide. The north and south layerings on the metal box springs design will be comprised of many microcrystalline complex oxides that will align themselves parallel. The different crystal layerings such as the layering of the south side of the metal box springs wire will be composed of multiferroic system combination of RuSr₂Nd_{0.9}Y0_{0.2}Ce_{0.9}Cu₂O₁₀ layerings, as shown in FIG. 1, #20. This edge brings the two decks together on a proper high fidelity and high selectivity before the mechanical manipulation of the dual design folding and holding process. The oval loop quantum gravity position is a circular boundary frequency attractor that pulls and pushes the incoming signal down through the coupling constance system of the metal box springs. This set of complex oxides, RbFe (MoO₄)2, KFe(MₒO₄)₂, ZnCr₂O₄, Na₂₄Si₁₃₆, Cs₈Na₁₃₆, Rb₈Na₁₆Si₁₃₆, YBaFe₂O₅, is at 1 nm thickness each is sequentially layered parallel cladded alongside in no particular order of the south side of the metal box springs waveguide. These complex oxides mentioned above are the thermal transport charge carriers in conjunction with what is stated in Physical Review Letters, 104, 8 Jan. 2010, pages 1-4, “Intrinsic Electrical and Thermal Properties from Single Crystals of Na₂₄Si₁₃₆” by M. Beekman and the wave striped layerings will be used in the metal box springs quantum design conductivity. This is the reason for the repetitive Hertzian symmetry of the complex oxides, as shown in FIG. 1, #6. This is due to crystal inversion asymmetry to chemically and electrically alter, change, and guide each mode frequency process. The article, Guided-Wave Optics, Scientific American by Amnon Yariv, page 126, depicts in the diagram the string displacement which is exactly FIG. 10, interdigital electrodes oval loop quantum gravity design, shown in the top view of FIG. 10, #119 through #126. Also Yarvi's article, on page 127, shows the diagram depicting mode frequencies connections of the Saint Andrew's Cross and the oval loop quantum gravity as shown in FIG. 10, interdigital electrodes oval loop quantum gravity, #24. This design couples the waveguides through the use of this magnetic oval loop quantum gravity resonators as stated in Nature, Vol. 440, 23 Mar. 2006, Channel plasmon subwavelength components including interferometers and ring resonators by Sergey I. Bozhevolnyi. The use of photonic components are superior to electronic ones in terms of operational bandwidth of this miniaturization high-density integration of optical circuits called metal box springs, as shown in FIG. 1, #29. This is a zero order rediffracted beam, as shown on Bozhevolnyi's pages 509-510 in the diagram, depicting the resonating metal box springs and oval loop quantum gravity that both designs—is in this article and in this invention—are one and the same. As stated in Bozhevolnyi's article, the Zeeman effect 1 depends on the square of the field strength and is of two kinds, first result from second order terms, the second from the diamagnetic reaction of the electron when revolving in large orbit. 2. inverse rotation of plane-polarized light by matter situated in the magnetic field associated with the Faradays effect. This will also involve the Paschen-Back effect on spectral lines obtained when light sources are placed in a very strong magnetic field. And the design will overall have a pyroelectrical broadband cavity mode spectrum span potential. This metal box springs design is on a line wire nanosize form which connects to the surface of a phone device, radio signal device or any receiving device which uses an antenna is attached on to the outside surface of devices such as phones, radios, TVs. The metal box springs design magnetically and electrically pulls the incoming radio wave and then the magnetic center of gravity traps and couples the incoherent sine Hertzian sine cosine light wave and sinks under its own weight and pulls towards the center as it bends the metal box spring. This coupling constance forces the light wave in a natural curved line which now glides on to the Hertzian sine cosine wave frequencies without disconnecting its connective reception from a refluxtivity folding backwards hooking and holding at the edge of each crystal plate phase, as shown in FIG. 1, #27. The other side of the wave guide travels from right to left and the shape of the wave has been turned left to right of a side band which starts at FIG. 1 #27 at #26 arrow through the entire device. The critical line of the incoming light signal is passing through the center loop quantum gravity oval and all repetitive ovals on this design at #29. This zero order rediffracted beam coming out horizontally at #14 and #27 and all numbered listings #11 through #33 substrate underneath the space area that creates a broader substrate wave line wire band which is called refluxtivity sectorial zoning of metamaterials that guides and holds the incoming wave. This strong coupling for the electronic carrier moves slowly enough for it to become self-trapped in the sectorial zoning area of the metamaterials substrate and held in the center of gravity at FIG. 1, #29 and all looped quantum gravity ovals on this metal box spring. The north and south direction of this flat rectangular antenna, as shown in FIG. 1, #1, #2, #3, #4, #20, FIG. 4, #77, FIG. 5, #86, #97, #98, FIG. 6, #100, #101, FIG. 7, #107, FIG. 8, #108 are the chiral metal springs connective link between the north, south, east and west into the 36 empty holes holding the metal frame to the metal box springs grid. These 36 empty holes are toroidal dipolar magnetic holes used to produce toroidal rotation symmetry to rotate polarization of the incoming light signal, coupling constance connection of negative index of refraction, interacting between electrical currents producing toroidal monopoles in the 36 empty holes on the frame of the metal box springs grid that now is connected to and by the 36 spring hooks. This was reported in the Science article, “Toroidal Dipolar Response in a Metamaterial by T. Kaelberer, 10 Dec. 2010, Vol. 330, pages 1510-1512. The article on page 1510 specifically depicts the empty hole in FIGS. 1, A, B and C. The wave function of the coupling constance connects loosely between the metal frame and 36 empty holes and 36 hooking chiral springs to the metal box springs grid. As stated in Physical Review Letters, Vol. 102, 17 Apr. 2009, Coherent time Evolution of a Single-Electron Wave Function by M. Kataoka, the connective moving quantum empty hole as shown in drawing FIG. 1, #2 and FIG. 6, #104 are defined by surface acoustic waves. When the light wave passes between this region of circular holes confinement, the electron is excited into a superposition of states and oscillates unitarily from side to side through this static gate-defined circuit connecting to the springs chirial movement as shown in this article on page 2 illustration (c). This wave frequency travels through this design hole and carries through its spring wave frequency relay to the spring transport direction because the direction north to south is much stronger than the confinement by the springs alone. In Physics of Wave by William C. Elmore, on page 91, in the chapter Helical Springs, Elmore states that a helical spring can be used either as a linear elastic member, which generates an axial restoring force proportional within limits to the amount of stretch, or as a torsional electric member, which generates an axial restoring torque proportional within limits to the angle of the twist. This design spring and hole connector have a greater purpose in this invention of a metal box springs antenna because of the quieted acoustically zero reduction vibration that now produces less friction. Also as stated in Solitons in Scientific American by Claudio Rebbi and as shown in a diagram on page 126, concerning helicity movement, the top diagram shows movement arrows from the left to the right and the bottom diagram shows arrows right to left. This depicts the corkscrew springs that are shown in FIG. 1 north and south and the larger broadband springs that are from left to right as indicated in #27. Both of these corkscrew designs help to fold the incoming wave signal between the top deck into the lower cavity deck of this nano technology flat layered antenna. Also in Physics of Waves by William C. Elmore, page 228, the chapter Elastic Waves and Solids indicates that in this metal box springs invention, or longitudinal, waves involve a vibration in only one direction, and are said to possess one degree of freedom. Solenoidal, or transvers, waves can vibrate independently in two directions of polarizations and therefore possess two degrees of freedom. Longitudinal and transvers waves have different velocities in an elastic medium as being used in this new metal box springs design. In Geometry and Light by Leonhardt, pages 128-129, is an explanation of the chirial springs as shown in FIG. 6, FIG. 7, FIG. 8 that creates the coupling constance movement of this transparent wire chirial spring in an embedded liquid substrate. Because of the nano size it appears as a flat space but in truth it is a chiral four-dimensional design embedded in metamaterial medium and because of its expanding ability it appears to become linearly flat. And also as depicted in Leonhardt, et al., page 179, chiral springs tiling of the expanse and reposition of the relaxed position of these electric field vector of gravity movement are induced by the incoming light wave and gravity force field. These mass springs oscillators are being used in FIG. 1, #4 and in FIG. 6, FIG. 7, FIG. 8, #100 for stretched moment shown in #100 and #107; the compressed mode is #108 and the relaxed mode is for the frequency independent amplitude. Almost All About Waves by John R. Pierce, page 91, states that the springs supply restoring forces so that the masses oscillate independently with the frequency and the moving force of momentum of the wave generated or absorbed sets up the wave for process into the metal box springs system. This system's momentum requires that the wave exert a longitudinal force in this metal box springs design. Elements of Statistical Thermodynamics by Leonard K. Nash on page 87 in the chapter Internal Degrees of Freedom concerning Vibration of a Diatomic Molecule compares the design concept of the metal box springs to the so-called harmonic oscillator. Imagine a weightless spring, with relaxed length, which obeys Hooke's law. This spring mechanism when stretched or compressed to some length resists further stretching or compression with a force proportional to the force constant of the spring which controls the massive gravity vibration of millions of light waves hitting the metal box springs at the same time which creates a frictionless horizontal surface linked by the springs relaxed stretched and compressed movement in the metal box springs design grid. Science, Vol. 323, 13 Mar. 2009, Inducing Chirality with Circularly Polarized Light by Robert J. Cave states how the shape and symmetry size distance connection affects that the use of right versus left which involves electron transfer will depend on the width and height of the barrier between the empty holes hooks and plate distance between the sites that are loosely connected, as shown in FIG. 6, FIG. 7, FIG. 8, called vibrational medium bridges and are located to the north and south of this rectangle aperture design. As in this metal box springs model of atoms on a hole hook shown in FIG. 6, FIG. 7, FIG. 8, #106 excitation with circularly polarized light yields equal electron density at each empty hole ring site. These 36 empty holes are toroidal dipolar magnetic holes used to produce toroidal rotation symmetry to rotate polarization of the incoming light signal, coupling constance connection of negative index of refraction, interacting between electrical currents producing toroidal monopoles in the 36 empty holes on the frame of the metal box springs grid that now is connected to and by the spring hooks. This was reported in the Science article, “Toroidal Dipolar Response in a Metamaterial by T. Kaelberer, 10 Dec. 2010, Vol. 330, pages 1510-1512. The article on page 1510 specifically depicts the empty hole in FIGS. 1, A, B and C. Then reversing the polarization of the light reverses the direction from the hole ring to the hook to the springs shown in FIG. 6, 7, 8, #100, #107, #108. This becomes a helical bridge. As stated in Physics Today. October 2010, Shaping optical space with metamaterials by Martin Wegener, pages 32-36, shown on page 32, FIG. 1c, and in this patent in FIG. 6, FIG. 7, FIG. 8, is a three-dimensional metal helix. Eugene Hecht's famous textbook, Optics, uses chiral metal helices as a model for explaining optical activity on a classical basis that shows a three-dimensional helices such as those shown in FIG. 1c and in the box springs. These bridges are made of metamaterials. The article in Physical Review Letters, Vol. 102, 20 Mar. 2009, pages 1-4, Metamaterials: Optical Activity without Chirality by E. Plum states that chirality is a contradiction in design and materials but in this metal box springs both are utilized to rotate the polarization state of light. This is an oval loop quantum gravity design that controls wave propagation direction of multiple frequencies in a two-deck metamaterial molecular system, manifesting resonant circular negative refraction of sectorial zoning of polarized electromagnetic waves. As discussed in Geometry and Light by Leonhardt in the chapter, Negative Refraction and Perfect Lenses, Pendry, et al., and depicted in this invention for an antenna, discusses a perfect image by the use of negative refraction being applied to a Cartesian coordinate transformation in this invention design as shown on page 217, in FIG. 5.5. Inside this fold and in this invention the beveled edges become negatively refractive as they flow into the coordinate system of the metal box spring that changes the folding handedness. The electromagnetic left-handedness of the negative-index metamaterial transports through a transformation to a left-handed coordinate system in the metal box springs. The layering-deck plates are vertically separated by frictionless liquid helium-4 which gives the standard folding line of negative refraction and folding on the horizontal negative edges of this physical space that will be folded under each plate in virtual space starting along the beveled edges. As stated by Pendry, 2000, physical space seems to run backwards inside the negatively refracting medium which is called in this invention refluxtivity folding, as shown in FIG. 1, #27 horizontally and FIG. 2, #36, vertically and from the beveled edges north to south folding under and into the next crystal edge for backwards refluxtivity, shown in FIG. 3, #58 through #70. This refluxtivity folding under is effectively implemented by the chemical oxide crystal layerings of sub-wavelength sheets of transparent silver mirror crystal plates combined with a substrate sheet of highly polished gold metamaterials, as shown in FIG. 3, #70. The bottom of line #64 is made of transparent gold oxide and the top of line of #69 is also made of transparent gold oxide and top of line of #61 is made of a transparent silver oxide sheet. Also, as stated in Leonhardt, pages 255-257, the folds of the silver and gold plates in space-time have become reflective in this multi-valued antenna, as illustrated by the Penrose diagrams 5.18 and 5.19 on pages 256 and 257, physical space-time seems to be cut into two distinct regions of this dual deck antenna. Because the waves are confined to either one of the two sides they would never interact with each other but, since this invention is using transparent crystals, both of these dual decks are electro-optic and magnetically unified for frequency gathering and holding the signal in place. In locally co-moving frames the wave would oscillate with negative frequencies. The complex waves with positive frequencies are always shadowed by negative-frequency waves. Therefore in this metal box springs rectangle there are reflective waves bouncing between the multiple plates. The oval loop quantum gravity design in this invention has a conversion from positive-to-negative frequency waves in the classical way behind the spontaneous movement of energy movement across the quanta horizons as stated by Hawking. This point overflow of radiation, shown in FIG. 1, #29, is a zero order diagonally rediffracted beam across the plate surface of two polar regions of the oval loop quantum gravity design as shown in FIG. 10, #122. The unusual design and sectorial zoning of the application of metamaterials and complex oxides related to size and distance in this antenna produces the waveguide structures to hold in place the broadband frequencies. The oscillating magnetic and optical-electric dipoles emit electromagnetic waves of the same polarization that propagate along the direction of the incident wave. Both Babinet's principle and the use of metamaterial, which are complementary structure to the now multi-layered superconductors oxides wires that are a Hertzian repetitive parallel fringe pattern that will work together in the strangeness of nano distance of this miniature universe to produce a frequency chemical reaction upon the incident wave. This 36-springs device helps to modulate the bad vibration that causes entanglements of incoming light waves on a configurationally gravitational bounce on to all oval loop quantum gravity movement continuously across the surface of the crystal plate. This connection of the metal box springs wire design moves light to the right to left-handed of the crystal surface to the edge of this rectangle, as shown in FIG. 1, #3, #5 and the left-to-right is the substrate composite antenna directivity diagram grid that encompasses the entire rectangle square base shown in FIG. 1, #11 through #33. The wave which hits the metal box springs which is reflected first and must come back because of the size of the electromagnetic field and redirected to the middle incoming incident wave. Physical Review Letters, Vol. 90, #5, Feb. 7, 2003, by Yong-Yuan-Zhu states that a new type of polariton in a piezoelectric super lattice produces transverse polarization which can be induced by a longitudinal direction which couples strongly to the electromagnetic wave in the frequency region, shown in FIG. 10, between #121 and #124 which is #122. These polarizations shown in FIG. 10 have four movements that contradict one another but are separated by sectorial zoning metamaterials while the oval wire is electrically compressed at the center of gravity at FIG. 1, #29 is a zero order rediffracted beam which is related to dark matter particles at 10¹² that conducts a radio wave at 10³ resulting in a totally new type of polariton based upon this new metal box springs design grid. This electrically induced contraction expansion of light gravity process connects onto the complex oxide metal box springs design. This concept is explained in Physical Review Letters, Vol. 102, 30 Jan. 2009, Deep Sub-wavelength Terahertz Waveguides Using Gap Magnetic Plasmon by Shuang Zhang: this subwavelength terahertz waveguide based on magnetic plasmon polariton mode guided by narrow gap in negative permeability metamaterials in this sectorial zoning redirecting the continuous constance coupling on to the metal box springs design. As in this article it is also in this invention that the metal box springs confining and steering electromagnetic waves at dimensions much smaller than the wavelength compacted in a miniaturization of Einstein's universe of space and time integrating new optical metamaterials on a nanoscale to produce a new antenna device which improves the spatial resolution in optical imaging, holding the incoming light wave and separating the incoming white light signal at the same time. The size of this metal box springs wire optical waveguide is smaller than half of the wavelength in this sectorial zoning imbedded in the new metamaterial medium. These unnatural magnetic metamaterials can extend the magnetic responses to the terahertz and optical frequencies well beyond the limit of what natural materials offer. The reconnective process stated in the claims and the embodiment conclusively proves that these magnetic activities are enhanced by sectorial zoning that provides unique electromagnetic guiding configurations to manipulate the refluxtivity of light wave more efficiently through these magnetic metamaterials in conjunction with the multi-parallel transparent metal-plate waveguides that realize the two-dimensional confinement and guiding of these terahertz waves in deep subwavelength scale. The unique design, as can be seen in FIG. 1, #1, is flat and horizontal but the incoming wave is vertical and then is guided down to the flat metal box springs configuration. In conjunction with the metal box springs design is a multi-dual flat-sided metamaterials made of silver wire core which is the chosen metal and a coating of Ba₂Nd₅Ti9O₂₇ and benzocyclobutene, which are high- and low-permittivity dielectrics corresponding transmission spectrum of the electric field in this lamination along the arrayed right angles to the metal box springs plane, as shown in FIG. 1, #5 and #6, repetitively, FIG. 3, #56, FIG. 4, #80, #84, #85, FIG. 10, #119, 125. This process is a transformation optics idea of controlling the fabric of sectorial zoning as a substrate of electromagnetic space and therefore light propagation by filling it with substrate metamaterial, as mentioned above, requiring media metal box spring with coordinate-dependant parameters such as quantum oval loops to complete the coupling constance which is the most important connection to the electron. These coupled oscillations of electrons and light are known as plasmons in the metal box springs design of complex oxide nanostructures which produce the broadband frequencies on a terahertz spectral range. These metamaterials can slow light, thereby increasing the interaction time with nonlinear medium imbedded in it, such as quantum oval loop design which helps concentrating the local field and thus enhancing a nonlinear response. These metamaterial substrates in a sectorial zoning arrangement create the folding phase change on each west-to-east edge and north-to-south edge which causes the folding under and switching for the process that will not cause the breaking and disconnecting the incoming signal connection of the incoming signal. As stated in the specifications, embodiment and claims of this invention, this switchable and holding are controlled by the sectorial zoning metamaterials. This is conclusively based on the metal box springs arrays of micro-macro-nano electrochemical/mechanical design. The above statements are related to the Science article, 30 Apr. 2010, Vol. 328, pages 582-583, Applied Physics, The Road Ahead for Metamaterials by Nikolay I. Zheludev. This is due to the manmade unnatural metamaterial sectorial zoning trapping and coupling effect between the layered box spring design that produces the distinct feature of the 2-subband dual-deck system of this metal box springs as depicted in FIG. 1, FIG. 2, and FIG. 3. This process involves the new metamaterial sectorial zoning boundary separators between each electromagnetic field of layering crystals that are stacked in a substrate plate design that creates the transport of more than one frequency for the nonentanglement gathering component in the incoming oscillation signal. This will produce a special broadband wire cavity performance movement mode that utilizes broadband, wideband, and passband onto the metal box springs that is imbedded in the substrate coupling movement from left to right, right to left, and east to west and north to south, according to Physical Review Letters, Vol. 102, 27 Mar. 2009, article Selection Rules for the Nonlinear Interaction of Gravity Waves by Chung-Hsiang concerning two intersecting beams of internal gravity waves which will generically create two wave-packets by nonlinear interaction. And as stated in Physical Review Letters, Vol. 99, 6 Jul. 2007, Terahertz Frequency Standard Based on Three-Photon Coherent Population Trapping, by C. Champenois, pages 1-4 terahertz signals can be propagated over long distances, the useful information being carried by the relative frequency of three optical photons. With the use of these atoms, Ca+, Sr+, Ba+, Hg+, made in a narrow dark wire line cladded onto the metal box springs in FIG. 1, #6, on the north side of every metal box springs wire line whose frequency lies in the terahertz range. This is the electric-dipole forbidden line as shown in FIG. 9, #116 and FIG. 10, #126, interdigital electrodes oval loop quantum gravity process. This dual deck layering is where the transition stands in the optical domain in this magnetic-dipole transition which comes from the second-order Doppler shift, the quadruple shift, and the Zeeman shift because of the play performance reaction on size, distance and thickness of the metamaterials and superconductors point placement that is exposed to the electrical current and onto the Hertzian sine cosine box springs for the contraction of both lower and upper decks of this antenna in order to hold and process the light signal. Such a level of stability is being claimed. The chemically changing frequency of one packet will be the sum and that of the other packet will be the difference of the frequencies of intersecting beams shown in FIG. 10. On the south side of the line Hertzian sine cosine wave in FIG. 2, #40, FIG. 3, #57, FIG. 4, #82, FIG. 5, #89, FIG. 9, #113, and FIG. 10, interdigital electrodes oval loop quantum gravity line system and #126 is an electrical circuit wire that connects and runs on to the lower deck of the sandwich antenna loop which runs through the center of the connective loop quantum gravity structure and is called memristor resistors with memory. The memristor resistor is a part of the usual reconfiguring of the backward folding characteristics which resistance increases as current flows through in one direction and decreases when the current is reversed. If the current is cut off the memristor line passing through it completes its connection with or without current. The reason for this is that voltage exerts a slight chemical tracing force, subtly redistributing the atoms in the crystal structure of a semi-conductor altering its degree of resistance in the quantum oval loop region of the metal box springs continuous coupling because of the scaled down in size and distance design. These mencapacitors and meninductors passive components with memory between charged, current, and voltage produces the necessary flux at conjunction of the mencapacitors and meninductors, as stated in Jonathon Keats' book Virtual Words, page 49, and is illustrated in this invention in FIG. 4, #82, FIG. 5, #89, #87, FIG. 9, #113, #116, FIG. 10, 122. This memristive phenomenon is also described in Nature magazine, Vol. 464, 8 Apr. 2010, pages 837-876, article concerning ‘Memristive’ switches enable ‘stateful’ logic operations via material implication, by Julien Borghetti, which these vertical line wave-wires are called Memristor arrays comprise one layer of platinum wires that sandwiches a 50 nm thick side active later of TiO₂, as shown in FIG. 4, #82 and FIG. 9, #116 that crosses over in FIG. 10 and connects to #123. On the north side of the vertical waveguide, as shown in drawing FIG. 2 #40, #39, #38, #52, and all north side of the waves is a large arrays of antennas in the lower deck of this system as stated in Physical Review Letters, Vol. 103, 18 Dec. 2009, Efficient Nonlinear Light Emission of Single Gold Optical Antennas Driven by Few-Cycle Near-Infrared Pulses by T. Hanke. The metal horizontal and vertical nano-antennas have been demonstrated to work as optical analogues in conjunction with the metal box springs waveguides to connect to the light emitters of the connective oval loop quantum gravity coupling constance connected to both the lower and upper deck compression in order to hold and trap the incoming signal attached to the metal box springs as shown in FIG. 1, #7, #8, FIG. 9, #118, #116, #117, FIG. 10, #121, #123, #124. The quantum oval loops are elliptically shaped structures which are fabricated via electron beam lithography on fused silica substrate. The thicknesses of the gold film chromium adhesion layer and dielectric substrate amount to 40 nm×2 nm and 170 um thick. These quantum oval loops are electrically compressed and connect the frequencies to both decks and controlled by metamaterial sectorial zoning as a substrate shown in FIG. 3, #66, #70, as also stated in Physical Review Letters, Vol. 104, 8 Jan. 2010, pages 1-2, Long-Wavelength Optical Properties of a Plasmonic Crystal by Cheng-ping Huang. Both the upper deck and lower deck plates have a layer of plasmonic crystal which is composed of gold nano-rod-shaped particles because of the strong coupling between the incident light of the upper deck and now the lower deck of the metal box springs. By the use of this plasmonic photonic crystal gold nano-rods to produce a photonic stop band opens up this new metal box springs way of manipulating the motion of photons This is the strong couplings between the photons and lattices vibrations as shown in FIG. 10, 119 through #126, interdigital electrodes oval loop quantum gravity process. The surface plate system is a set of parallel and horizontal design waveguide structures that form an X axis of energy control. The refluxtivity energy emission is collected in this transmission geometry with an electro-optic lens on the substrate surface of the crystal plate, as shown in FIG. 3, #58. In the article The Confinement of Quarts by Yoichiro Nambu in Scientific American, page 56, in the diagrams depicting arrows, the first arrow is a low energy line arrow which is also shown in the invention in FIG. 1, #27. In the same article the next arrow depicts a medium energy for the light path, as shown in the invention in FIG. 1, #11 through #33, from right to left. The next phase mode of high energy arrow is depicted in FIG. 4 under the reversing reflux fold in #79 and #76. The next geometric energy mode is infrared containment, depicted in FIG. 4, #80 up and #84 down, the last energy mode of ultraviolet expanse, as shown in FIG. 9, #113, #114, #116. This electromagnetic spectrum range produced on the layered wire complex oxide parallel fringe coatings of the metal box springs and crystal superconducting metamaterials substrate provides the transformation waveguides for the wavelengths in meters from 10⁻¹⁵, 10⁻²⁰, to 10⁻¹⁰, 10⁻¹² which goes to the frequency in hertz from ultraviolet through infrared at a frequencies of 10⁻¹⁵ to 1 to 10⁵ range that encompasses microwaves, radar, TV, FM radio and all radio waves which will encompass the forbidden zone. Even though these specific spectral ranges are a positional contradiction, this metal box springs will accommodate this full range of electromagnetic spectrum because of the use of manmade metamaterials and superconductor and complex oxide fringe design placement. These quantum electrical vertical loops and quantum oval loops connective wave circuits are quasi-direct-current waveguides. In the book Almost All about Waves by John R. Pierce, pages 129-130, the chapter on Polarizations support the concept of the metal box springs vibration being controlled in both north and south, east and west and in a polarized vertical wave direction. When this antenna is used as a transmitting antenna, it may produce a wave whose strength varies over the aperture. When this wave glides along the metal box springs substrate, it has an effective area as shown in FIG. 1, #11 through #33 which is the substrate platform in the same area of this metal box springs antenna that utilized both receiving and transmitting antennas that has the same effective process. As shown in Almost All About Waves by John R. Pierce, page 173, Antennas and Diffraction, Diagram 16.8, depicts the geometrical aperture or area of transmitting antenna process. This light-sensitive transparent X-design opening or Saint Andrew's cross opening between the wire wave guide and the travel light signal that passes in between the design structure, as depicted in FIG. 9, #118, center oval loop quantum gravity that connects the two waves from #115 to #117. In the quantum oval loop gravity design, FIG. 10, that is connected to the light-sensitive transparent Saint Andrew's cross linear energy transmission field over the constant repetitive aperture of the metal box spring that is repeated by complex oxides throughout the entire antenna directivity diagram grid, as shown in FIG. 1 of this invention. Also, as support in Physical Review Letters, Vol. 99, 14 Dec. 2007, pages 1-4, Cerenkov-Vavilov Formulation of X Waves, the metal box springs design is establishing a connection between the X waves and the well-studied physics of observed superluminal phenomena such a Cherenkov-Vavilov radiation in the electromagnetic context or supersonic effects such as bow waves in an acoustic context. In this invention these X waves become a phase-folding process. The first quadrant high frequency in the same article on page 4, FIG. 3, shows a Saint Andrew's cross, a standing X wave field and the electromagnetic consequences of this motion concerning Maxwell's equations are therefore conclusive proof that establishes the metal box springs design that will produce selective frequency bandwidths that flow into the Hertzian parallel complex oxide stripes cladded to superconductors and to be held to sectorial zoning of manmade metamaterial boundary layers that hold and fold and set up for bump the light signals between the spectral zones. This energy cross movement is produced when the incorporating beam propagates on the surface and downward into the center of gravity which is called the quantum oval loop of this traveling coupling constance design, as shown in FIG. 1, #29, and FIG. 10, zero order rediffracted beam process electrode and the incoming vertical light signal being flopped or collapsed on to its waveguide side horizontally oriented Hertzian metal box springs, as shown in FIG. 2, #36 This vertical beam and Saint Andrew's cross are the first connecting to the incoming crystal surface plate and then the two outgoing reflective beams—one propagating upward and the other downward into the center of gravity in this design device antenna. Both incoming and outgoing beams collapse according to the horizontal metal box springs design horizontally in repetitively complex oxide layerings molded in the same direction as the incorporating beam with the higher absolute value of its frequency. The frequencies of the two incoming beams have the same frequency but propagate in opposite directions, as shown in FIG. 4, #80, #84 and #82. As illustrated in Principles of Terahertz Science and Technology by Yun-Shik Lee, page 106, Lithium niobate, LiNbO₃, will be used in this invention because of its unique properties such as its high optical transparency over the broad spectral range of 350-5200 nm and its strong optical nonlinearity, ferroelectricity and piezoelectricity properties and large electro-optical coefficient d33=27 pm/V, as shown in FIG. 1, #11-#33, used as a platform substrate below the metal box springs which creates the negative composite repetitive form. The Terahertz Science and Technology book, on page 141, section 4.7, shows the backward folding wave oscillators in which the metal box springs uses this same process where the electrons are slowed down by the metal frame of the box springs edge where the 36 empty holes and 36 hooks that connect the metal box springs structure is connected to the Saint Andrew's cross which controls the light-sensitive kinetic energy of the electrons around the metal rectangle frame. These 36 empty holes are toroidal dipolar magnetic holes used to produce toroidal rotation symmetry to rotate polarization of the incoming light signal, coupling constance connection of negative index of refraction, interacting between electrical currents producing toroidal monopoles in the 36 empty holes on the frame of the metal box springs grid that now is connected to and by the spring hooks. This was reported in the Science article, “Toroidal Dipolar Response in a Metamaterial by T. Kaelberer, 10 Dec. 2010, Vol. 330, pages 1510-1512. The article on page 1510 specifically depicts the empty hole in FIGS. 1, A, B and C. This dual movement of upper to lower deck travels right to left and then left to right forming an axis of a Saint Andrew's cross which produces the surface energy for the first folding refluxtivity process. This folding phase in this rectangle controls the waves that move in opposite directions that are folded also at the same time west to east at the inner rectangle edge of the box springs antenna located in FIG. 1, #27. This continuous coupling constance of gravity's connection to the south magnetic pole on the west side and the north magnetic pole on the east side which creates the flipping phase of the backward folding under movement down into the lower deck crystal layering plate is the second folding of the light signal. This becomes the coupling constance folding phase of the electromagnetic field which is made of a manmade metamaterial that creates a sectorial zoning that produces an unusual quantum Hall-like phenomenon, as stated in Nature, Vol. 452, 24 Apr. 2008, pages 970-974, A topological Dirac Insulator in a Quantum Spin Hall Phase by D. Hsieh. This manmade metamaterial mentioned in both articles has a zero external magnetic field made of BiFeO₃ which is used in this invention and also is explained in Physics Today, October 2010, Multiferroics: past, present, and future by Nicola A. Spaldin, pages 38-43. The BiFeO₃ mention in the articles cited above is being used in this invention for two or more transition transparent metal cations, usually 3-D, and oxygenated because these complex oxides are chemically inert and nontoxic and because the elements are abundant that produce strong polarizability. These material elements are desirable properties in ferroelectronics and also desirable in this invention, as shown in FIG. 3, top plate, #64. In these ferroelectric materials, as mentioned in article in Physical Review Letters, Vol. 103, 18 Dec. 2009, pages 1-4, in Selected for a Viewpoint in Physics Electrical Field Switching of the Magnetic Anisotropy of a Ferromagnetic Layer Exchange Coupled to the Multiferroic Compound of BiFO₃ by D. Lebeugle, this magnetic-electric effect links the antiferromagnetic spin to the local polarization in BiFeO₃ of the Fe3+, and more specifically as stated in Science, Vol. 329, 2 Jul. 2010, pages 61-64, as stated on page 63, explains the results, that the dopants are nearly in the 3+ valence state and always obtain the high-spin state because of the large Hund's rule coupling of the 3-D transition metal ions. This will directly lead to the insulating state of Fe-doped samples, because the Fe 3+ has five 3-D electrons, favoring the 5 up and 0 down configuration in a high spin state and resulting in a gap between the majority and minority spins as shown in the invention in FIG. 1, wire line #6 to #24, #16 to #30, #18 to #32. Both articles cited above and below, namely, the two Physical Review Letters. Vol. 102, 6 Feb. 2009, the Dynamics of Multiferroic Domain Wall in Spin-cloidal Ferroelectric DyMnO₃ by F. Kagawa and Physical Review Letters, Vol. 103, 13 Nov. 2009, The Nature of the Magnetic Order and Origin of Induced Ferroelectricity in TbMnO₃ by S. B. Wilkins support use of these metamaterials and complex oxides. In this invention these complex oxides formulas, mentioned above, are shown in FIG. 1's repetitive Hertzian sine cosine wave line wire guide made of DyMnO₃, as shown in line wire guide #17 and #19 and alternatingly cladded together in this border TbMnO₃, YMnO₃ and CaMnO₃ as cladded layerings alongside each repetitive Hertzian sine cosine metal box springs wire, as shown in line wave wire guide #14. These complex oxides create a parallel striped layering fringe effect which is composed of these multiple mixture placements of multiple cladded stripes of superconductors oxide design cladded alongside of the metal box springs that is controlled and initiate through the use of electrical current that effects all of the stripes that are placed alongside of each other and the incoming incident signal radiation forms a chemical reaction producing a different process width in the bandwidth creating multiple spectrum frequencies that react to the electro-magnetism chemical formula of the combined complex oxides. In this striped parallel design of the metal box springs are multiferroics, in which electric and magnetic orders co-exist between the sectorial zoning areas of the metamaterial holding phases. These gigantic magnetic electric dielectric phases layerings of metamaterials will be 1 nm in size cladded on the north side of the wire metal box spring as shown in FIG. 1, #11 and #23. In conventional ferromagnetic or ferroelectric materials, the motion of the domain walls are key to the directional functions of holding and folding; it provides a huge-response, i.e., magnetic or dielectric susceptibility as well as low field control of the multiferroic, i.e., concurrently anti-ferromagnetic and ferroelectric domain walls in multiferroics of large magnetic-electric coupling in these metamaterial substrate which is placed below the path of the multiple striped Hertzian sine cosine waves wave line complex oxide waveguide selectors. The concept stripes used in this invention is conveyed in Letters, Nature, 2 Dec. 2010, Vol. 468, pages 677-680, Fluctuating stripes at the onset of the pseudogap in the high-T_{c} superconductor Bi₂Sr₂CaCu₂O₈₊ₓ by Colin V. Parker. The analysis of these stripes establishes the phase-coherent properties that produce the design metal box springs layering cladding complex oxides of the waveguides for the correct modulations behavior that produces the multiple spectrum frequency position of the light signal production. Also as stated in Physical Review Letters, Vol. 103, 13 Nov. 2009, pages 1-4, A Ferroelectric with Multiple Inhomogeneties by Desheng Fu, in these metamaterial sectorial zoning areas, as shown in FIG. 2, #41, #49 this metamaterial component plate is composed of Relaxor Pb, Mg ⅓Nb ⅔, O₃ that is in combination layering with FIG. 1, #17 #19 combination with Magnesium+ that forms a giant dialectic and electromechanical responses in relaxors or as a colossal magnetoresistance. This giant dialectic as shown in FIG. 1 #15 to #28 and line arrow #27 to the center of gravity will be made of Sr₃Cr₂O₈. As stated in Physical Review Letters 103, 13 Nov. 2009, Field-induced Bose-Einstein Condensation of Triplons up to 8K in Sr₃Cr₂O₈ these optical lattices are used as superconductors in this center of gravity process design. In FIG. 1, #1 the top square frame is made of LuFe₂O₄ that produces a giant magnetic coupling frame between the upper deck and lower deck in FIG. 3 #56 and #66. FIG. 1 #11 to #23 is made of Na₂₄Si-136 which is stated in Physical Review Letters, Vol. 104, 8 Jan. 2010, pages 1-4, which are intermetallic clathrates in the north position frame of this design square. This thin calcite opal gem layering plate which separates white light into color spectral components is made of a calcite crystal prism CaCo₃K, NaAl, Fe, Li, Mg, Mn₃Al, Cr, Fe, V₆BO3₃Si, Al, B₆O₁₈ OH, F₄ layering. This line of calcite opal crystal prism is a frequency standard for timing devices, radio transmitters and receivers that are piezoelectric in design in material development that is shown in FIG. 3, plate #58. According to Physical Review Letters, 100, 11 Apr. 2008, pages 1-4, Hierarchical Assembly of Nano-particle Superstructures from Block Copolymer-Nano-particle Composites by Huiman Kang, these nano-particles can now be synthesized with remarkable control over shape, composition, and surface functionality leading to new metamaterials with well-defined properties. This is the new application for the metal box springs refluxtivity development of magnetic, electrical, and optical properties in a nano metamaterial sectorial zoning in the scale thickness of 20-40 nm which will provide an unprecedented level of influence over the local distribution of nano-particles within the arrays at the scale of a few nanometers over this vast landscape of 20 mm×30 mm rectangle square patterned surface aperture of this antenna that will give a first order particle to the metal box springs stripes interpolation scheme of end-to-end, north-to-south scale model of Einstein's gravitational model on a miniature universe scale. The general approach to fabricating nano-particle arrays non-regular device oriented structures of annealed nano-composite metamaterials and the corresponding nano-particle arrays consists of an assembly repetition stripes alongside of the metal box springs waveguide made of a ferromagnetic and antiferromagnetic chemical nano-pattern consisting of wave bends of 90°. The next plate layering is 0.01 mm thick synthetic photonic band-gap material made of an opal gem developed by Dr. Alexander Bulatov, Russian Academy of Sciences, Chemogolovka in order to channel the specific wave lengths of refluxtivity light by diffraction, as shown in FIG. 3, #59. As stated in Physical Review Letters 102, 15 May 2009, Anomalous Refraction of Light colors by Metamaterial Prism by Mario G. Silveirinha, the top plate of this antennae, as shown in FIG. 3, #59, will be a prism-opal combination with calcite layered on top of the crystal gem that separates white light into spectral components in such a manner that the colors associated with the shorter wavelengths are more refracted than the colors associated with longer wavelengths according to the connective coupling constance of the color light radiating through the transparency of the crystal connecting onto the metal box springs complex oxide waveguide design. Physical Review E, 74, 2006, “Broadband diffraction management and self-collimation of white light in photonic lattices” by Ivan L. Garanovich, gives the reason for the calcite and the gemlike quality prism that the calcite-opal is being used on the top plate. This calcite combination of opal gemlike prism crystal produces the correct separations of the white light and super continuum separation of the double prismatic multicolor Talbot effect that runs north to south in FIG. 1. The calcite double refractive line will move from north to south as an optical separator that governs the scattering of waves from modulations of refractive indexes and their subsequent interference. The spatial beam diffraction also depends on the wavelength of the incoming beams self-collimation which is being restrictive to a spectral range according to the double refractive image line in the calcite crystal. This wavelength-independent diffraction management is now a very broad frequency range covering up to 50% of the central frequency as shown in FIG. 1, #11 through #33 substrate plate that is placed below the metal box springs. The same article, Garanovich, et al., on page 2 depicts specifically the metal box springs broadband waveguide array that institutes the connective complex oxides to each broadband diffraction management is stated in this invention, as shown in FIG. 1, #11 through #33 substrate. This repetitive bending waveguide coupled with bending complex oxides stripes create the higher connective bands associated with broadband self-collimation. This metal box springs invention hybrid structure provides a dynamic improvement in band width for self-collimation effect of this new refluxtivity trapping, holding and folding of the incoming and outgoing wave frequency along the sectorial zoning metamaterial process. Also the management that is being considered in this metal box springs that separates white light into multicolored Talbot effect allows this device to massively manipulate billions of white light into color pattern signals on the entire aperture surface structure of this antennae. This will optimize the entire 20 mm×30 mm surface of the logical arrangement to all incoming incident light signal arrays, according to the new superconductors and metamaterial substrates in this design. The lossless metamaterial-calcite-opal prism with a suitable microstructure will enable a broadband cavity mode regime of anomalous dispersion, where the spectral components of light are separated in an unconventional way, so that “violet light” is less refracted than “red light” which makes this design on a microstructure and will make this multiple dual-deck cavity mode process a reality. According to Infinite Energy, Issue 71, 2007, page 20, “The refractive index for longer wavelengths (red) as lower than those for shorter wavelengths (violet). This results in a greater angle of refraction for the longer wavelengths than for the shorter wavelengths. This phenomenon is quantified as the index of refraction; the fact that refractive indices differ for each wavelength of light demonstrates that they propagate through the prism at a different velocity.” The Physical Review Letters, Vol. 103, 2 Oct. 2009, pages 1-4, in the article “Dynamical Casimir Effect in a Superconducting Coplanar Waveguide” by J. R. Johansson, article support the relationship to the metal box springs design created the same Casimir effect that is in the coplanar waveguide that is listed in this article. It concerns two parallel mirrors in empty space are attracted to each other due to the vacuum fluctuations of the electromagnetic fields because of the different mode density inside compared to the outside of the mirrors. According to the Physics of Waves by William C. Elmore, on page 67, concerning the “Interference Phenomena with Plane Traveling Waves,” that this “sending plane sinusoidal waves toward a rigid straight boundary along which the wave amplitude is necessarily zero at all times.” This diagram on page 67 FIG. 2.4.1 shows the wire line source as being image of the other dual stack arrangement in the rigid boundary and the boundary as being a plane mirror decks arranged in the lower deck, as shown in FIG. 2, #42 and #43. This striking effect of quantum electrodynamics was predicted by Casimir in 1948, and is now used in the metal box springs design layering as shown in FIG. 1, #1 and FIG. 2, which is the lower case wave line electrical circuits is in combination with FIG. 3 drawing showing the total combination of the two designs layered together in FIG. 3 which is a sandwiching of the two layers in between a liquid crystal made of a fiber crystal salts, as stated in “Casimir force, antennas, and salt water.” As famously predicted by Hendrik Casimir in 1948, parallel conductors in a vacuum will attract each other because the conductors impose boundary conditions that affect the vacuum energy of the electromagnetic field—see the article by Steve Lamoreaux in Physics Today, February 2007, page 40). In general the Casimir force depends on the shape of the conductors. Now a team at MIT has shown how tabletop measurements' might provide the key information needed for the general calculation. The Casimir force may be expressed as an integral over frequency, ω, of correlation functions that involve electric and magnetic field combinations associated with gravity that this quantum oval loop brings the three-field processes together. The key observation made by the MIT team is that their mathematical expressions always involve ω in the combination ∈ω², where E is the permittivity. Thus, the researchers predict a force integral with real vacuum permittivity and complex contour can be calculated from a tractable number of antenna measurements made at ω in a medium of complex permittivity—for example, salt water, as supported by A. W. Rodriguex, et al., Proc. Natl. Acad. Sci. US, 107, 9531, 2010. In this dual metal box springs as stated in Physical Review Letters, Vol. 104, 8 Jan. 2010, pages 1-4, Novel Defect Structures in a Strongly Confined Liquid-Crystalline Blue Phase by Jun-ichi Fukuda, that in this invention will be using the blue phase in chiral ferromagnets as MnSi liquid crystal and air interface structure instead of a liquid salt. The reason for the blue phase is because of the double twist cylinders called skymrions and it satisfies the two-layered dimensional electron systems in this new antenna dual-deck system. This is proven by the diagrams of this article on page 2, FIG. 1, showing the design formations that are identical to the metal box springs fourfold symmetry axis in a confined vacuum system. As shown in FIG. 1, #6, #13 to #25 is made of aluminum+base crystal line wire superconductor. The article in Physical Review Letters, Vol. 100, 4 Apr. 2008, pages, 1-4, Measurement of Terahertz Conductivity of Intense Laser-Heated Dense Aluminum Plasma, by K. Y. Kim, states that the Aluminum+creates the Drude model for warm dense matter, ion-ion interaction ultrafast terahertz frequency near zero frequency conductivity. As indicated in Physical Review Letters, Vol. 102, 27 Mar. 2009, Optical Nonlocalities and Additional Waves in Epsilon-Near Zero Metamaterials by R. J. Pollard and Victor A. Podolskiy pages 1-4, at near-zero regime such as this metal box springs being presented in this invention uses manmade metamaterials, optical composites with structural units smaller than the wavelength in this multi-scale light coupling antenna which uses the epsilon-near-zero metamaterials in which components of the real part of the dielectric permittivity becomes vanishingly small. This nonlocality accompanied by excitation of the additional polarized electromagnetic wave in this sectorial zoning of metamaterial systems will be the correct material function for this new side band horizontal metal box springs refluxtivity design application. In conjunction both the forgoing and the following article, Physical Review Letters, 100, 30 May 2008, by J. Nagel, Observation of the Negative Absolute Resistance in a Josephson Junction, pages 1-4, motion against the static force is termed negative absolute mobility or negative absolute resistance because of the nonlinear system's in this invention produces a negative differential resistance and also negative absolute resistance of Nb—Al—Al₀ₓNb complex oxides which will produce frequencies in the Ghz range, as shown in FIG. 1, #6 cladded on all north side repetitively of all the metal box springs Hertzian waveguides. In FIG. 1, #19 to #33 on the south end of this antenna, the concepts are stated in Nature, Vol. 45, 19 Feb. 2009, China's Crystal Cryanoski, this crystal is nonlinear, barium borate BaB₂O₄ is to generate zero to edge contact as shown in FIG. 1, #20, controls wavelengths of 200 nanometers in combination with the Mg+ substrate at the south end of this nano-framed antenna design. Each incident signal large wave packet compacts into and unto the antenna system's edge which compliments the energy system radiating on the surface plate that is folded under in the next surface plate edge. This is called refluxtivity folding. This refluxtivity phase movement is holding the frequencies and are being bumped and moved into the folding edge position in a reverse movement action into the electromagnetic metamaterial sectorial zoning cavity of this antenna. This incoherent incoming signal wave packet travels along the complex oxide stripes of the box springs design, using the complexity sizes and widths to the fullest extent of the traveling distance of each light bandwidth wave through the use of refluxtivity latching dragging and folding that holds in place and makes a manmade metamaterial reconnection to the integrated line superconductor design and surrounding space in the sectorial zoning lines boundaries for permanently holding the incoming signal which now will not break from the system device to which this antenna is attached. This rectangle surface mm×30 mm aperture and the metal box springs design receives a full incoming signal bounce of gravity into the electromagnetic oval loop quantum gravity design that induces a larger connection to the metal box springs broadband cavity mode product. The metal box springs design is flat and collapses the incoming incident wave that connects to the surface structure that has a very low electrical current connection. This incoming incident wave passes through this transparent crystal and connects to vertical, perpendicular, and horizontal design coupling constance and on to the superconducting parallel complex oxide stripe fringes and down through to the sectorial zoning reconnection to a manmade metamaterial layering to reconnect for holding and folding process. The use of anti-ferromagnetic crystal structure plates produces the holding in a constant forward and backward refluxtivity coupling phase folding reception of all incoming incoherent signals that are passing through the double electromagnetic gravity quantum oval loop based on a universal space and time design described by Einstein's Special Relativity Theory of expansion, contraction and collapsing. The Hertzian sine cosine cladded stripes of complex oxides attached to the metal box springs fabric Hertzian fringe line wires are on a nano-scale magnetic and antimagnetic superconducting material that stretches over a vast nano-micro-macro distance of this rectangle square that is 20 mm×30 mm and is 1 mm thick and is the perfect depth of this dual deck design that holds the invisible gravity force connection between the contradiction of movement versus broadband cavity mode distance of the incoming electromagnetic wave signal that collapses and compresses onto a nano-thickness of the metal box springs design. The use of manmade metamaterial sectorial zoning compresses the electromagnetic incoming light refraction reconnection that enables the incoherent light waves to expand and bounce naturally onto the electro-magnetically warped box springs' frame that receives and controls the vibration by strong pressure compression and the release expansion in combination of hooking the incoming light signal which reacts on to the complex oxide chemical striped formulation cladded to the metal box springs. The gravity movement pushes on the bed fabric and connects to the electromagnetic metal box springs design of the quantum oval loop which is the center of gravity position located in FIG. 1, #29 and all coupling constance 66 loops, 36 holes and 36 hooks that simultaneously hooks and disseminates the incoherent multiple signals that are entangled together by electromagnetic gravity process of refluxtivity and relativity process design. The metal box springs design is confirmed in Physical Review Letters, 99, 28 Sep. 2007, specifically showing the light wave guide which is the metal box springs design line wire structure. This is seen through a scanning electron micrograph around 100 nm scale bar of In As dot bridges which confirms the line design of a metal box springs that will be used in this invention. As discussed in this Physical Review Letters, 18 Nov. 2005, Vol. 95, #26, it is conclusively proven that the metal box springs design invention will produce the correct spatial dimension and complex proportional sizes in a scale position of singularity contradiction process in order to produce the necessary broadband cavity mode process that takes in the contradictions of size that ranges from the forbidden frequencies areas on the light spectrum that will encompass atto-10⁻¹⁸, nano 10⁻⁹, micro 10⁻⁶, milli-10⁻³, and mega 10⁶, megawatt, giga 10⁻⁹, gigahertza, terahertz 10⁻¹². These ranges in the spectrum will encompass the long and short milla microns of bandwidth cavity mode transmission operation. As stated in article Physical Review Letters, Vol. 101, 19 Dec. 2008, Metamaterial Analog of Electromagnetically Induced Transparency by N. Papasimakis and in this invention, FIG. 1, #1 depicts the outer square line of the frame of the antenna which is made of compressed NbGe. This outer frame has the ability to carry high current vibration in the present of high magnetic fields which is 100 nano-meters thick and 100 nano-meters wide, housed in a square form frame. This metal frame is holding the metal box springs design grid together, as shown in FIG. 1, #1. In this frame there are connective 36 empty holes drilled around the square form frame which amount to 36 empty holes and 36 hooks. The center hole ring is made of NbTiTc that activates the Maxwellian electromagnetic unit of magnetic reflux on to the connective spring, as shown in FIG. 1, #2. The creates a magnetic flux which, linking a circuit of one turn fold, produces in it an electromotive force of 1 ab V as it is reduced to zero in 1 then 1 Maxwell=10-8 weber electrical units and standards which is at 10-9 nano-size as stated above and shown in FIG. 1, #2, FIG. 4, #72, #73 and #75, FIG. 5, #94, #95, #96, #98, FIG. 6, #105, #106. This design produces an expanding and contracting that will facilitate all incoming signals and will hold all frequencies in place controlled by electro-magnetic refluxtivity reversing folding phrase process. FIG. 1, #3, depicts the spring coil connection between the 36 empty holes and oval loop quantum gravity in #4 on to #5 box springs, also #6, and oval loop quantum gravity connectors, #7 and #8, are the multiple overlapping hook loop quantum gravity ring connections from the empty hole at #9 which is described in detailed from FIG. 4, #75, FIG. 5, #98, #97, #96, #94, FIGS. 6, 7, 8, #96, #100, #102, #107, #109, #110, #108, #111, FIGS. 9 and 10, which show the coupling constance overview of all the design control manipulators of light transition process in the retrodiction refluxtivity in this trapping wave guide design device controlling process. This quantum oval loop center of gravity design is the connective link of the coupling constance conductivity of the lower deck electromagnetically coupling and controlling of the Hertzian striped parallel complex oxide fringes cladded to the superconductor line bandwidth. This complex oxide design material connects parallel to the ten empty holes located in the north with hooks on the top of square and ten empty holes with hooks on the south of the square, making a total of 20 empty holes with 20 hooks, as shown in FIG. 1, #2 and #20, running consecutively across the edge of the north and south square line. In FIG. 1, #9 and #27, the empty holes run consecutively on the east to west side of the square rim which total 16 empty holes with 16 hooks that connect the metal box springs horizontally which become the impedance coupler of empty holes which enter the asymmetric phase coupler ports areas which are placed on both east right and left west sides of the square of this metamaterial design. The east and west side hook to eight empty holes on the right and eight holes on the left side of the square structure frame. As stated in Physical Review Letters, Vol. 102, 30 Jan. 2009, Proposed for a Mesoscopic Optical Berry-Phase Interferometer by I. A. Shelykh, that these empty holes with hooks are a novel way to produce spin-optronic device based on the interference of polaritonic wave traveling in opposite direction and folding under and through the holes and hooks splitting on the Zeeman effect which are used to control the output of its peculiar orientation of its electro-magnetic field for polaritons where the spins of single particles are precisely manipulated and controlled as a spin transistor. As depicted on page 2 of the Shelykh, et al., article, and as maintained in this invention, this hole and hook microcavity waveguide is located in this invention design, as shown in FIG. 1, #2, hole north rail of ten empty holes transistors with splitting Zeeman effect hooks attached clockwise, ten empty holes on the south side of this rail which are transistors with hooks that are anticlockwise and with eight empty holes on the west rail side with hooks. These double dome holes are magnetic magnets for up and down folding manipulation of the light wave port holes, as shown in FIG. 1, #27 of eight empty holes and eight empty hooks on the east rail side which are made of antiferromagnetic properties for the first incoming incident wave signal for refluxtivity folding under and on to the first layering deck plate, as shown in FIG. 3, #58 and FIG. 2 vertical, #36. FIG. 1, #8 and #9, specifically, are isolated conventional points of backward-wave couplers on the right side of the square which are through the two empty port holes and hooks and on the left side are of hook and empty holes that are beginning forward-wave coupler input port. This is depicted in Metamaterials by Richard W. Ziolkowski, pages 198 and 199, metamaterials couplers in FIG. 7.7. This book's article explains the drawing configurations, as shown in FIG. 4, #73, #71, #72, FIG. 5, #90, #88, #89, #87, #86, and FIG. 10, which describes multiple parallel complex oxide stripes that produce interdigital electrodes on all of the metal box springs design waveguide and the coupling constance of quantum oval loop full field unified design connection to the gravity, #123. The above descriptions of the complex oxide stripes waveguides creates order out of this entanglement that will conserve the energy and coherent process of the entanglement of the enlargement of the waves multiple size of each broadband cavity mode within this design counterpuntal counterparts of the metal box springs. Metamaterials by Richard W. Ziolkowski, page 153, describes that Broadband Wilkinson Balum Using Microstrip Metamaterial boundary separation Lines which are used in this invention which is claiming that there are 18 wave guide horizontal and perpendicular parallel metal box springs stationary bandwidths in this two-layered antenna input port that are closely spaced on a nano-size development in order to create low-pass, high-pass output lines which are employed in this new metal box springs quantum oval loop design, as shown in FIG. 3, #66-#58=9 lines=×2 side 18. The pertinent parameters for each metal box springs wave guides and parallel Hertzian complex oxides bends at a −90° on the line wire and cladded alongside the metal box springs at a +90° waveguides Hertzian complex oxides is calculated in this metal box springs design shape of the phase responses to the design multi layerings of the +900 and −90° wire lines that match the 180° phase folding and Saint Andrews's cross gliding across the surface that regulates the incoming large bandwidth cavity mode. This will match the phase response of the −90° of the wave line with that of +900 multiple oxide stripes lines and therefore create a broadband cavity mode waveguides from an optical ferromagnetic superconducting differential output and input phase in the wideband peaks and collective valleys of their phase characteristics which will be equal to the design frequency structure waveguide laid out in this controlling metal box springs design. Each segment metamaterial sectorial zoning substrate does radiate and operate the inner reflective region line boundaries of the wave line which becomes a controlled circuit for the transparent light signal to pass through the superconductor stripes and down onto the substrate, as shown in FIG. 1, #11-#33, FIG. 4, #79, FIG. 5, #91, FIG. 6, #105 and #104, FIG. 8, #110, FIG. 9, #116 and FIG. 10 full field interdigital electrodes quantum oval loop gravity design, as shown in #122. This works well because it has to do with mutable miniaturized sizes in the design itself and the spatial sectorial zoning of metamaterials in a nano-micro-macro manmade repositioning in order to get the results necessary in holding and folding the light signal into a permanent position. This is the claim of this invention that it will produce a permanent holding coupling of the incoming light signal as compared to the antennas of today which are only a small aperture in size which creates the breaking effect of the incoming light signal. In this invention the aperture retrieval is 20 mm×30 mm in size which eliminates all the dysfunctions associated with breaking the connection when said device is under a tunnel or in a conflicted electronic area that breaks the incoming signal. This design improvement is the basis of the claims of this invention. The reality level may seem usual because of the use of the term of metal box springs is extenuated to the maximum of what new material research development can produce. Its design process has been proven in all of the advanced visual understandability as depicted in all of the journal articles mentioned in this document. As an example of the above statement, it is stated in Physical Review Letters, Vol. 101, 19 Dec. 2008, in Metamaterials Analog of Electromagnetically Induced Transparency by N. Papasimakis, that the studied metamaterials are based on a continuous description of fish-scaled metallic pattern which is to illustrate the difference between the two names of fish-scaled and this invention called a metal box springs design and are one and the same design. This metal box springs beam forming combination waveguide is a typical single band-gap resonant structure that guides the light signal down into trapped-mode directional metamaterial sectorial boundary separations of these two types of structures which are a combination of gas and solid state antenna processes. In the above-mentioned Papasimakis, et al., article, the manufacturing metallic pattern is etched on one side of the dielectric slab, while, in the trapped mode of the metamaterial, the pattern resides on both sides of dual deck and metal box springs refraction, so that the pattern on one side of the dielectric slab is shifted along the meandering metal box springs strips pattern on the other side at 15 nm×1.5 nm bi-layered of the fish scale and now called the metal box springs placed above the metamaterial substrate counter design, as depicted in FIG. 1, #6, #16, #18, #27 line narrow transmission resonances of #6 and the broadband cavity mode width transmission in #11, #12, #13, #14, #15, #16, #17, #18 on the right-hand side and #23, #24, #25, #26, #28, #30, #31, #32 and #33 on the left-hand side of the wire wave and the substrate broadband cavity beam-forming mode combination to produce a dual waveguide wire design and a metamaterial substrate composite design. The article in Physical Review Letters, Vol. 103, 6 Nov. 2009, Reversed Cherenkov-Transition Radiation by a Charge Crossing a Left-Handed Medium Boundary by Sergey N. Galyamin, describes the macroscopic metamaterials parameters of E and U. This sectorial metamaterials zoning is most importance in this metal box springs design process of holding and folding of the light wave. In the 1960s Veselago introduced the concept of left-handed media having simultaneously negative permittivity and permeability. The left-handed metamaterial: the electric field vector, magnetic field vector, and wave vector form a left-handed orthogonal sectorial zoning on to the substrate of the metal box springs. The beam controlling direction along with the energy flow and the re-direction of the phase velocity are opposite in the left-handed metamaterial folding, resulting in very unusual properties of electromagnetic wave propagating to reconnect the electrons in this metal box springs media design in order to correct the natural gap so that there will be no disconnect from the incoming light signal. This design will entail left-handed frequencies band as opposed to right-handed frequency band which will be in the range spectrum of the gigahertz frequency band. In these nano-stripes of complex oxides that chemically produce beam-forming combinations of coupling constance conducting through the chemical superconductor elements having their size and spacing much smaller than the wavelength and thus such media will be described by lengths of perfection as macroscopic parameters of E (w) and U (w), as described in the Galyamin article reference above. As stated in Physical Review Letters, Vol. 89, 16 Dec. 2002, pages 1-4, Power Propagation in Homogeneous Isotropic Frequency-Dispersive Left-Handed Media by J. Pacheco, article and this invention of the metal box springs which will be use in this new metamaterial boundary system sectorial zoning of directioning from the beam-forming combination substrate that produces a right-handed medium directional process holding and frequency dispersive left-handed reconnecting medium phase. As stated in book, Photonic crystals: Theory, Applications, and Fabrication by Dennis W. Prather on page 245 concerning left-handed behavior and negative refraction, this process material behavior “has profound consequences for the behavior of electromagnetic waves traversing such materials, as discovered by Beselago [12, 47] and by Pendry [13].” For example, in such materials, the Doppler shift is reversed, i.e., the frequency of light emitted by a source moving toward the observer is reduced, and Cherenkov radiation points the other way with respect to the moving particle that generates it which is the folding phase point. As stated on page 15 of the book, Modern Optics, by Grant R. Fowles, the Doppler effect on a source of Hertzian sine cosine waves and a receiver are in relative motion while the waves are being received; the observed frequency is being changed compared with that in which there is no motion. The refluxtivity of this metal box springs design connection with sound waves connects with the metamaterial sectorial zoning area for folding and holding the source of the incoming signal that is constantly moving away from the receiver and expanding across the 20 mm×30 mm aperture nano-distance that is the proper beam controlling combination of this dual metal box springs antenna. Also the book, Almost All About Waves, by John R. Pierce, page 24, states that waves “of different frequencies travel with the same velocity, all the sinusoidal component waves travel together, and the pulse retains the same shape” in the metal box springs design “as it travels along” the beam-forming Hertzian parallel complex oxide fringe wave guide. However, if the velocity is different for different frequencies, some sinusoidal frequency components lag behind or run ahead of other or the pulse is broadened or dispersed as it travels. Hence, a dispersive mode is one for which the velocity changes with frequency, so that pulses are broadened or dispelled” as they travel along the beaming forming metal box springs that in a horizontal flat mesh design grid. This horizontal flat design of Hertzian parallel striped complex oxides is designed for the expressed reason of the collapsing wave to a beam-forming pattern for controlling this collapsing beam. “Conversely, if the velocity does not change with frequencies, that is, if the . . . curve is a straight line through the origin,” is called a Saint Andrew's cross and the mode is non-dispersive and the pulse retains its original compact form as it travels through this metamaterial folding wave reversing process. In the Pierce book on page 65, FIG. 8.3 maps out this complex frequency relay and frequency scanning associated with the horizontal beam forming metal box springs in order to control the collapsing light signal before the coupling constance of it being trapped by the quantum oval double dome loop design, as shown in FIG. 1, #8 and FIG. 10, #119-#126, of this complex multiple beam-forming frequency division. Such a negative refraction makes an axis-free lens possible in this folding in upon itself in a palindrome. effect. In this case, light rays that originate at a point to the left of a negative-index slab undergoes refraction at each beam forming waveguide superconductive boundary between the multiple dual-deck reflective metamaterials. These metamaterials produce the coupling constance along with the quantum oval loop that converges and combines with both to focus from the loop and into the negative-index material substrate. This will produce the necessary beam-forming combination connection between both decks to produce an optical focal point connection on to the other lower deck. This antenna is a lens that translationally becomes invariant, no optical axis is present only the design of the metal box springs, and the same focusing and imaging takes place regardless of the position of the object along the surface. This phenomenon is being used for the collection and gathering of incoming radiational light waves of electromagnetic energy that moves in the dual first contact vector and only indirectly follows from the negative sign μ and ∈. In highly structured metamaterials, such as photonic crystals, using the Poynting vector to determine the energy flow can be exact. However, because group velocity also points in the direction of energy flow and is well defined in photonic crystals, it can be used instead of the Poynting vector. Thus left-handedness in this case can be defined as having group and phase velocities that point in opposite directions. As in this invention for a metal box springs design, the circular oval loop with a radius k, the effective refractive index for the frequency ω corresponding to such contour can be defined following Snell's law as k/ω/c, where c- is the speed of light in vacuum. The Pierce book on page 246, FIG. 5.43, indicates the same exact movement as in this metal box springs invention. As stated in the book, Quasioptical Systems Gaussian Beam Quasioptical Propagation and Applications, by Paul F. Goldsmith, page 125, In analyzing antenna feed systems and Gaussian beams it is very useful to take advantage of the reciprocity theorem Krauss, pages 410-413, which the metal box springs design employs here in the sense that it can be considered equally well a forward and a backward mode folding and holding for antenna operation. As is well known to antenna engineers, for the forward (or receive) mode, we deal with radiation collected by an antenna and brought to a focus, which then must be analyzed in terms of coupling to a quasioptical, generally Gaussian beam, system. In the reverse (or transmit) mode, we consider the quasioptical system to be radiating a specific Gaussian beam and determine the illumination of the antenna that results, this being the amplitude and phase distribution across the aperture of the antenna. This antenna is a nano-repetitive wire crystal design that captures the full spectrum because the aperture is 20 mm×30 mm that is both a gas and solid state system built in together. In combination with these two systems and sizes, it is accentuated by the use of maximum condensed complex oxides that become receptively attuned to the incoming light signals. These metamaterials are left-handed media, introduced by Veselago in 1968, and as well as in this invention for the metal box springs antenna. These negative permittivity and permeability on the left-handed metamaterial substrates, metallic wires and hole resonators are shown in FIG. 1, #2 and #3. In actuality, each hole on the west side of the interference front moves in the direction of the power flow downward and to the right. Both east and west movement in this invention, as shown in FIG. 1, #27 arrow, coupling constance incoming frequency relay from west to east of this signal is a Gaussian beam which connects to the incoming incident light wave signal vertically, as shown in FIG. 2, #36, which travels downward into this dual-deck cavity of the antenna. Since it has been shown that the negative refraction is now possible to pick up multi-frequency signals because of the new reconnective manmade metamaterial boundary structures associated with this design metal box springs wire overlays in order to produce a new refluxtivity hook of all incoming light waves sandwich between all of the stacks of this wafer design. The design and the metamaterial elements specifically are shown in Physical. Review Letters, Vol. 99, 21 Sep. 2007, page 1, “Reentrant Quantum Hall Effect and Anisotropic Transport in a Bi-layer System at High Filling Factors” by G. M. Gusev, depicts the same symmetric-antisymmetric energy gap that is controllable through the height and width of the optical wire waveguide that crisscrosses through a perpendicular magnetic field which is called a quantum Hall state. As shown in the same Gusev article, on page 2, the diagram in FIG. 1 of this article conclusively shows the metal box springs double well structure that proves that this new refluxtivity antenna directivity diagram can be used for perpendicular and parallel vertical magnetic holding, relay and scanning separation on a broadband level. This metal box springs system is extreme sensitive refluxtivity to two particles with energies lying within the energy range defined by two-layered metamaterials structures for the left-handed metamaterials. As stated in Physical Review Letters, Vol. 103, 6 Nov. 2009, in article Experimental Verification of Reversed Cherenkov Radiation in Left-Handed Metamaterials by Sheng Xi, the refluxtivity in the invention, that in 1968, Veselago predicted the abnormal reversed Cherenkov radiation in left-handed metamaterials with simultaneously negative permittivity and permeability that will allow the backward emitted wave to be folded easily and separable from the emitted particles and since this design uses overlapping edges and connective coupling constance that is adaptable to nature's natural quantum oval loop gravity resonators, located in FIG. 1, #7, FIG. 4, #82, FIG. 5, #98, #99, #87, #88, #90, FIG. 9, #115, #118, #116, #117 and FIG. 10, which is called the connective interdigital electrodes of this oval loop quantum gravity device, #119, #120, #121, #122, #123, #124, #125 and #126, respectively placed throughout the Hertzian sine cosine metal box springs making connection with the seinolide wave design function and universal connection. The dome double overlapping of the quantum oval loop gravity is the connectiveness of both decks, as shown in FIG. 4, #82, #81, #83, FIG. 5, #90, #88, #87, #99, FIG. 10, interdigital electrodes quantum oval loop gravity, #123, #126 are called quantum oval loop gravity resonators connectors in the reversing process which allows the radiation in the left-handed metamaterials with simultaneously negative permittivity and permeability allowing the backward emitted wave to be easily separable from the emitting particles, as shown in FIG. 1, #7, #29 zero order rediffracted beam, as shown in FIG. 2, #37, FIG. 3, #56, FIG. 4, #81, #82. #83, FIG. 5, #99, #87, #88, #89, #90, FIG. 9, #118, #116, #117, FIG. 10, #122, #124 is the wire connective quantum oval loop gravity in this metal box springs system. In Physical Review Letters, Vol. 98, 15 Jun. 2007, pages 1-4, NMR Probing of Spin Excitations of a Two-subband System by X. C. Zhang conclusively prove and observed this ring-like overlapping quantum oval loop structure with a quantized Hall conductance of the 6 e 2/h, in this phase diagram of two sub-band electron systems. The strong dynamic nuclear polarization by the biasing current has also been observed only inside the ring quantum oval loop gravity region being a ferromagnetic state that is accompanied by collective spin excitations. As shown in FIG. 4, #82, FIG. 5 #89, FIG. 9, #118, FIG. 10 #126 121, #124 connective quantum oval loop gravity Venn overlapping of the oval ring that electromagnetically draws the radiation down into the center of gravity, as shown in FIG. 1, #29 is a zero order rediffracted beam. This two-dimensional electron system, consisting of the connective wire sub-bands is now a reality brought forth by the use of reduplicating nature's conductive pathways being reproduced in this metal box springs design. This system is two different sub-band quantum systems that are solid state and gas oriented that use the ability to attract incoming magnetic field and/or carrier waveguide concentrations of manmade metamaterials for trapping and holding the incoming signal. This system is in a density-magnetic field plane, exhibits pronounced oval-like loop quantum gravity structures and represents ferromagnetic phases that can be reduced to single particle states with an enhanced exchange interaction within each sub-band in this space-time Einstein framework of a mean-field applied to this invention's metal box springs miniature size universe. Page 2 of X. C. Zhang's article shows a real time photo FIG. 1 of resistivity versus magnetic field and gate voltage at 240 Å thick. This article and reality photos specifically depict the coupling constance link of the loop quantum gravity, as shown in FIG. 10, #122 which is the gravity loop and #126 shows the lower deck vertical electrical link arching up at #23 connecting with #122 and #119 and #125 show the wave hall effect phase as described in this article and describing the Venn multiple overlapping as shown in #121 and #124 and the overlapping of the memristor folding and reversing line in FIG. 9, #116, all connecting in FIG. 10 of this invention. This metal box springs embodiment, as shown in FIG. 10 and all the specifications above and the core claims that said broadband antenna will not disconnect from the incoming signal which will reverse the Mossbauer effect which is now being corrected through the use of unnatural manmade sectorial zoning of metamaterials and complex oxide superconductors embedded into the metamaterials substrates sandwiched between frictionless helium-4 gas no. 3 which is converted into a solid. The substrate superfinely tuned frequencies for emission and absorption of light into this receptive material is reconnecting nature's abnormality gap in the refolding and holding process phase of the incoming spectral frequency combinations. The metamaterial atoms emit and absorb light differently near the frequencies in the quantum metamaterial and subconducting ferromagnetic receptors being developed in this invention using manmade reconnective metamaterials. The light is emitted and absorbed not at fixed and precise frequencies, but in frequency intervals of separation finite width which is trapped by the sectorial zoning of the metamaterials and complex oxides to produce the holding and phase folding of said interval of the incoming light signal. In the Mossbauer effect, emission and absorption happens not at the single atom but the entire cavity of the crystal which in this invention produces this effect and goes a step further in order to correct and to reconnect the gap separation produced by nature to the emission and absorption on the entire crystal structure's sectorial zoning of the manmade reconnection produced by these metamaterials which reconnects the frequency mismatch in order to complete the holding of the incoming signal. The reconnecting of the traveling light signal penetrating the crystal and an absorbing one of the same type are positioned at different broken altitudes, thus, general relativity comes into play by the used of manmade metamaterials that complete this broken altitude gap that nature produces. Time progresses differently for the emitting crystal than it does for the absorbing one, causing a frequency mismatch disconnection in the light that reaches the absorbing crystal in nature. But the re-construction of sectorial zoning and manmade optical metamaterials create a manmade optical metamaterial to reconnect to the emitting metamaterial crystals to complete the holding of the incoming light signal. This also re-connects to the absorbing sectorial zoning to this reversal of this natural mismatch connection that completes the light that passes into the absorbing crystal. This mismatch is now corrected through the unnatural manmade metamaterials sectorial zoning on the borderlines of the crystal optical media and superconducting complex oxides to the edges for folding and reversing under and down into the metamaterials. That which is being claimed in this invention has corrected nature's gap which is now the reconstruction and reconnection to this altitude mismatch in order to produce the folding and holding of said incoming light wave signal. The correction reconnection to the separation in the negative left-handed refraction reversal is now connecting to nature's mismatch that was preventing the light signal from being absorbed and held into the middle cavity which is made of frictionless helium-4 gas vacuum. The completion of the traveling coupling constance in this dual deck of the metal box springs and the lower deck emission and absorption process occurs in different states in continuous, traveling mode through all the crystal layerings stacks, as shown in FIG. 3, #58 through to #70. This simple fact between nature's dysfunction and manmade unnatural metamaterials corrects this disconnect to reconnect, hold, and reverse phases of this mismatch that reconnects by the use of left-handed negative refracted sectorial zoning metamaterials. This solves the disconnect signal frequency mismatch by which the light wave signal can be reconnected and held for it to be absorbed and held and never disconnected the incoming signal from the device, such as a cell phone whether it be in a deep tunnel or at a distance from the transmitting pole.

### BACKGROUND OF INVENTION

In 1997 in Washington, D.C., a bunk bed Hertzian sine cosine co-sine metal box springs experiment without the use of any electrical current was able to pick up radio waves, TV waves and all signals being passed within a one-mile radius of the largest communication triangle center. After two years of listening to sound waves bouncing between the bunk bed Hertzian sine cosine metal box springs design which picked up light wave and gravity transmitted communications, William F. DePree came to the conclusion that the ultimate antennae was based on a bunk bed Hertzian sine cosine box springs which operated with no electrical power source. Therefore, the true background of this invention in 1997 and the scientific design truth became a reality by the immense avalanche of advance research in visualizing the way the light wave travels along this Hertzian sine cosine interdigital electrodes complex oxides waveguide bunk bed. This is conclusively proved by the conclusive scientific documentation listed in the specifications above. Einstein's special theory of relativity and the Lorentz invariant and the Gauges invariant placed on a nano metamaterial vast miniature size universe development has now confirmed that the most perfect operating antenna for broadband or all receptions is based on a bunk bed Hertzian sine cosine metal box springs design which is composed of interdigital complex oxide electrodes. The use of left-handed metamaterials is sandwiching in between these stacked crystals with a frictionless helium-4 liquid crystal imbedded in between the surface crystal layering of both stacks. The incoming signal is received by the metal box springs waveguide which disentangles through the use of prisms becoming advantageous because the metamaterials reconnect, hold and separate each incoming surface wave rather than bulk waves so that attenuation can be lower resulting in potentially higher resolution from the scanning surface. When acoustic velocity is slower because smaller electrode devices and higher frequency transducers are now easier to fabricate, the metal box springs design will produce the superfine complex oxides superconductors and manmade metamaterials to reconnect and correct nature's gap, as shown in article by Yoshiro Ohmachi in the Journal of Applied Physics, Vol. 44, No 9, September 1973, pages 3928 to 3933, entitled Acoustic-optical Light Diffraction in Thin Films. Now the multi-layering metal box springs becomes an efficient type of interdigital wave electrodes of acoustic surface waveguides for folding and holding and reconverting the acoustic wave back into an electrical signal. The Riemann Hypothesis that computes the factorization of random primes to orderly zeros in the 1800's had mathematically configured prime numbers that produced a visual harmonic form. The Riemann Hypothesis is a mathematical statement that forms the design into a signal wave that decompose the primes into music, but what Riemann really discovered was the development through the use of zeta function that the prime number created the landscape of a nano antenna four-dimensional topography landscape of this flat metal box spring antenna design. Euler had made the surprising discovery that feeding an imaginary number into the exponential function produced a Hertzian sine cosine wave. Riemann could see that there was a way of mapping these zeros and saw how each of these points could be transformed by using the zeta function to create its own special wave. Each wave would look like a variation of the graph of an undulating Hertzian sine cosine function. The character of each wave was determined by the location of the zero responsible for the wave. The further north the point at sea level which is the metal box springs frame where the faster the wave corresponding to this zero would oscillate, as this wave is a sound wave, the note corresponding to a zero sounds higher the further north the zero is located in the zeta landscape. The Hertzian sine cosine-like waves that Riemann had created from the zero's in his zeta landscape reveled a hidden harmonic structure; this structure is the point movement of this box springs antenna, hidden in a sequence of a critical line, as shown in FIG. 1, #27, FIG. 2, #36 incoming incident wave, FIG. 4, #75, #76, #77, #74, #79, FIG. 5, #91, #92, #93, #94, #95, #96, #97, #98, #99, FIG. 6, #104, FIG. 8, #109, FIG. 9, #113, #116 is the mystical Ley Line which is now called memristor mencapacitor and meniductor passive component running through the landscape in a ½ configuration between, FIG. 10, #121 and #124. The north and south coordinates of each point at sea level are the frame holding the metal box springs controlling the folding of the frequency wave which is corresponding to a high note. The pickup in contrast from the east-west coordinate is controlled, as shown in FIG. 1 #27. Euler had learned how loud each note would be picked up at these coordinates, as shown in FIG. 1, #27, #29, FIG. 2, #36 and FIG. 10, #122. The louder the note, the larger the fluctuation of its undulating graph. The precise location of these points were arranged in a straight line running north to south through the landscapes, as shown in the invention in FIG. 1, #29 and FIG. 2, #36. And every point at sea level in FIG. 1, #2, #10, #20, #27, FIG. 4, #72, #73, FIG. 5, #94, #95, FIG. 6, #104 had the same east-west coordinate, equal to ½ of the quantum oval loop coupling constance. This ½ of the Venn overlapping is shown in FIG. 1, #29, FIG. 4, #72, #73, #82, FIG. 9, #113, #116, FIG. 10, #119, #120, #122, #124, #126. Therefore, the corresponding waves will be perfectly balanced so that each quantum oval loop will not be performing louder than any other. The first zero that Riemann calculated had coordinates of ½ 14.134725, steps. The next zero had coordinates of ½ 21.022049, which were lining up as if along some mystical Ley line which is used in this invention as a memristor size. Ley line. The distance, size and thickness of this Ley Line become a mencapitor's and a meninductor's passive component with memory between charged, current, and voltage flux in conjunction with the quantum oval loop that is running between the overlapping connection to the metal box springs and the oval loop that connects the coupling constance through the entire landscape, as shown in FIG. 1, #27, #29, FIG. 2, #36, FIG. 4, #72, #73, #76, #82, FIG. 5, #86, FIG. 9, #113, #116. In this invention it is called the design of the metal box springs with an aperture of 20 mm×30 mm and 1 mm thick that will be used for an antenna. The Riemann proof solution lies in a visual nanodesign metal box springs metamaterial, antiferro magnetic development for the use of an antenna receptor in this metal box springs landscape. The Riemann's magic Ley Line, passing through ½ of all empty holes and quantum oval loop gravity and Hertzian sine cosine waves shown in this invention are based on the zeta function generally. In the book Once before Time by Martin Bojowald, pages 83-108, Carlo Rovelli and Lee Smolin give the name to the field in a superstructure called quantum loop gravity. This quantum loop gravity is not a new idea and has a background in a universal thought and now is being applied to this invention. What matters in this invention is the continuous coupling constance and the relationship between the quantum oval loop gravity that interlinks the process with no applied function until this invention of the metal box springs brings together the whole connective design with manmade metamaterials and ferromagnetic complex oxides to produce a complete outcome that creates a broadband antenna that applies to a size, dimension and thickness of a nano-design metamaterial woven structure.

### BRIEF SUMMARY OF INVENTION

The book, Applicability of Mathematics as a Philosophical Problem, by Mark Steiner, discusses the ideas of Maxwell, Einstein, Lorentz, Schrodinger, Heisenberg, Dirac, Gauge, and Gauss and this combination of ideas becomes the detailed abstract core for this new antenna which is the transformation to this metal box springs and which is a gauge transformation, invariance of Maxwell's equation under gauge transformation is the metal box springs symmetry of two stacks design in analogues to the invariance of Einstein's equation under local arbitrary coordinate transformation's general covariance. This proved that Maxwell's equations are virtually the only equations that are both gauge and Lorentz invariants. In this metal box springs design symmetry becomes what these men produced in physics which now becomes an antenna between general covariance and gauge invariance which is the key to the unifying electromagnetism with gravity in this miniature nano universe. Therefore, the gauge transformation together with Lorentz transformation of special relativity determined Maxwell's equations. The conclusion is that the metal box springs moves from global to local invariance in quantum mechanics and is the equivalent to the existence of the classical electromagnetic field described by Maxwell. Specifically, this design feature in the metal box springs is directly related to the Dirac confined radiation to a box. This metal box springs is the box associated with Dirac energy that crisscrosses diagonally in Maxwell's theory which gives the radiation as a superposition of countability of many normal wire-layered complex oxide modes which are the layered superconducting metal box springs and each normal mode design is the equivalent formally to a harmonic oscillator which is controlled by this metal box springs vibration from the idea of gravity and light associated with relativity of Lorentz universal matrix. Each harmonic oscillator can be quantized, according to Schroedinger's equation, or Heisenberg's equivalent approach. Therefore, the quantized field, then, is the flat multi-dimensional superposition of countability of many flat horizontal layered crystal superconductor quantum oscillators in order for a new refluxtivity antenna. This process of refluxtivity motion is the folding back in upon its stacks dual deck layering on the nano-box according to Paul Dirac. The parallel north and south layerings attached to the metal box springs which contains energy bands that are obtained in the forbidden bands that produce second derivatives of space between the symmetry of miniature nano size thicknesses that forms the multiple spectral frequency ranges. As shown in FIG. 1, the entire design becomes the entire aperture and FIG. 10 shows the quantum oval loop that becomes coupling constance that connects the Hertzian sine cosine metal box springs design in the complex oxides movement in this band gap across the wire's energy levels spacing design and plane wave wire layering superconductors that produce the wide band transmission according to the metal box springs narrowing into the design shown in FIG. 10, which is called an interdigital electrodes quantum oval loop gravity structure, as shown in #119-#126 which is the space broken between the crossing symmetry and the surface powertrain of the Saint Andrew's diagonal matrix energy movement, as shown in FIG. 9, #118 and FIG. 10, #122. This symmetry predicts the phenomena of the unified field theory of events of combining the incoming light wave in association with gravity and electromagnetic waves that can be accomplished on a nanoscale dimension. The reason a four-dimensional system of a rectangular flat structure that houses a metal box spring waveguide resonator uses ferrite magnetic superconductors in a parallel repetitive design is because it produces a rectangular movement from north to south, west to east that is held along each beveled edge space and time that is folding the incoming light signal under in a reversal refluxtivity manner phase symmetry. These internal and external sectorial zoning metamaterial negative refraction fields exhibit very unique properties from nanoparticle dimensional thicknesses which are illuminated by the electromagnetic field and the energy sinking into the quantum oval gravity centers that create vortices with spiral energy flow line trajectories. These trajectories in the quantum oval loop region are seen in the nanoparticle's plasmon resonance, as depicted in the center of gravity sink, as shown in #29 which produces a zero order rediffracted beam, as shown in article in Physical Review Letters E, Vol. 74, 2006, Microwave whirlpools in a rectangular waveguide cavity with a thin ferrite disk, by E. O. Kamenetskii, pages 1-7. This bunk bed metal box springs design houses the entire method conduction modes as it transverses electric and magnetic field configurations referred to as the electric vector quantum loop gravity connection between the lower deck and the upper deck connection of FIG. 10, which is now called the transverse connection of electromagnetic vectors quantum oval loop gravity that travels perpendicular to the direction of the propagation, as shown in FIG. 10 between the hollow dome of the quantum oval loop gravity connector resonator which will house the entire energy bands that are thus obtained through this separated forbidden band area.

### BRIEF DESCRIPTION OF SEVERAL VIEWS OF THE DRAWINGS

In viewing this antenna invention, only in the infinitely small sizes that will be encountered, elementary and uniform laws are being used in a quantum nano-scale and comprehended through their behavior in the infinitely small which brings into reality the universal unified field laws to produce a complete wafer-thin antenna design. Viewed from the top down, the first crystal surface is where the first incident connects to the surface energy radiation sensitivity that flows along the crystal lattice that takes the form of a Saint Andrew's cross that guides the refracting incoming light wave signal. FIG. 1, #1, is a complete top view of the embodiment of the present invention which is a transparent crystal 30 mm×20 mm rectangle square with 1 mm thick wafer. Just below the top crystal surface can be seen the metal box springs design aperture that is a Hertzian sine cosine wave metal box springs bed design structure. This will clarify what is meant by north, south, east, and west, as depicted on the drawing of FIG. 1. All statements indicating in this document are as follows. North is shown in FIG. 1, #2; south is shown in FIG. 1, #22; west is indicated in FIG. 1, #2 arrow passing through bed structure hole; FIG. 1, indicating east, is #27 arrow passing through end of bed hole edge. In FIG. 1 the equator in the parameters of this metal box springs is located in FIG. 1, #29. Viewing the physical apparatus from the top down and through the surface crystal layerings and into the metal box springs unified field design, there is not just one metal wire strip but a multiple combination of superconductor wire stripes that are cladded, running parallel with cladded complex oxides placed on the north and south sides of the metal box springs running parallel to the Hertzian waves design at different thicknesses on a nano-size to control the distance wave length of the incoming light signal. The metal box springs travels flat and horizontal as a waveguide structure support in order to capture the incoming light signal that is processed along different size of layered oxide levels, thicknesses, and lengths for spectrum absorption, emissions to be rearranged according to the light spectrum. On a closer physical view of the horizontal metal box spring superconductor wire it is seen that this grid is attached to the metal frame by 36 magnetic holes connecting the hook springs that the grid is suspended in a closed vacuum area of Helium-4 between the upper plate and the metamaterial substrate. The metal box springs is suspended and rests on the metamaterial substrate. The parallel aligned complex oxides are designed in unison with the Hertzian wave design pattern of the metal box springs is cladded on the north and south sides of the peaks and valleys of the Hertzian pattern. The wave guide lengths vary with the design depth of the layerings of cladded parallel layerings that determine the range from 700 nm through to 400 nm. This nano buildup of layerings in the peaks and valleys produce the selective wave lengths that will be dependent on the distances of the layered complex oxide which build up in size relationship to each peak and valley closeness of its wave thickness and distance between waves. Each complex oxide that runs parallel north and south according to thicknesses will alternate in sizes between 0.0004 mm and 0.0007 mm. The distance, thickness, and layering combination determine the longer-wave length distance in the wave length and the lower energy wave of red light matches up with the correct thickness in the layering peaks and valleys so that the incoming light signal is selected on the reaction with the complex oxides. The shorter the wave length, the higher the energy wave of blue light matches up with the complex oxide spatial distance of the wave length layerings. The metal box springs is immersed in a vacuum space with Helium-4 between the top deck plate and the metamaterial substrate, as shown in FIG. 3, #58. The complex oxides strips become the spectrum locator, selector propagator of the light wave length distance in which to encompass the full broadband selective holding and controlling the wave length along the Hertzian complex oxide parallel layerings alongside the box springs design for light signal transfer in the distance between the wave length match up of light waves with wave lengths that are shorter than blue light-ultraviolet and the radiation of x-rays and longer than red light infrared radiation are the microwaves to terahertz to the forbidden zone which this multiple layerings will process this scientific contradiction of size and place. Each wave length bends at a different angle as it enters and leaves the top crystal deck. And the associated constance coupling continuum allows energy bands that are obtained from the separated contradiction of the forbidden band area. This interaction between electron's spin and an applied electric field in the forbidden range are allowed bands and forbidden bands on the energy axis and are strong enough in this quantum oval loop interaction known as spin-orbit coupling to provide the means of controlling spins using oscillating electric fields in the vibrating metal box springs unified field design in this complex antenna invention as set forth in Nature, Vol. 468, 23-30 Dec. 2010, pages 1046-1080, Election Spin in the Field by D. J. Reilly. Underneath the first crystal top plate is the metal frame, as shown in FIG. 1 and 36 magnetic holes with 36 springs stretching the box springs grid wave design in this rectangular frame aperture. In FIG. 1, #29, FIG. 4, #81, FIG. 5, #88, FIG. 10, #119-#125 is the coupling constance and the connective loop to the north peak and south valley in this view is a Gaussian wave packet that decreases and expands the multiple complex oxide width and amplitude function as it propagates through the superconductor metal wire of the metal box springs and complex oxide parallel stripes coupling to the north and south that create the broadband unification to the unified field coupling in this design for spectral frequency positioning connection of the forbidden bands in the spectrum energy axis. FIG. 3, #53-, #54, #55, #56, #58, #59, #60, #61 comprises the entire top deck from FIG. 1 down. The substrate metamaterial plates that create the holding and folding process in directional sectorial zoning capture is below or underneath the metal box springs, as shown in FIG. 1, #11-#33 and FIG. 3 #58-#61 which are called three metamaterial sectorial zoning plate slabs for the purpose of refracted negative movement of the incoming light signal to be directed in the magnetic folding under phases from right to left and left to right that will travel underneath each edge three times down to FIG. 3, #58-#61. This view of the drawings brings together FIG. 1, looking from the top down and FIG. 3, showing a side perspective of the top deck layerings numbered #1 through #33, depicting the reflective refractive frame of the Hertzian sine cosine metal box springs wave with traveling coupling constance connective quantum oval loop gravity. FIG. 2, #34-#52 is the lower deck side view perspective of the embodiment of the quantum electrical vertical loop nano-wire carbon conductor wires and is also shown in FIG. 3, #57, #63-#66 which is the lower layered deck comprising of three plates of mirrored crystal platform slabs. As shown in FIG. 2, #34, #35, #46, #44 and FIG. 3, #53, #55, #66, #67 are the energy connection of the Saint Andrew's Cross connection to #34 to #44 diagonally which is the incoming electrical power source produced by the batteries to which this antenna is connected. Also shown diagonally #35-#46 is the other diagonal crossing line of the Saint Andrews Cross that connects the transmission of the cable transfer connection to the incoming broadband radio waves that are being held in the sectorial zoning of the metamaterial slabs, as shown in FIG. 3, #58, #59, #60, #61. Number 62 is viewed as an empty vacuum area in the middle of both decks which is comprised of Helium-4 in this closed vacuum. FIG. 2, #36 vertical arrow and FIG. 1, horizontal arrow #27 and #29 that these arrows indicate the a priori dropping effect of gravity vibrating both in a horizontal and vertical movement off of the metal box springs design grid. FIG. 3 shows a side view of both decks with a cutting point that depicts the metal box springs and the lower vertical electrical carbon wire as shown in #57. This is also shown in parentheses indicating both decks at #67. FIG. 4, numbers 71 through 85 depict the left upper north corner side view showing the light wave of the north portal connection #75 magnetic hole and the west portal connection at #72 and #73 which also show the quantum loop gravity oval design which connects to the surface plate of the diagonally X energy connection of positive and negative up and down at #80 and #84 and dashed arrow line at #79 which is the exchange field loop quantum gravity connection. FIG. 4, #82 is the Memristor resistors with memory usual characteristic resistance increases as current flows through in one direction and decreases when the current is reversed. If the current is cut off the memristor line preserves, or remembers, the level of resistance reached when current last passed through it. The reason for this is that voltage exerts a slight chemical tracing force, subtly redistributing the atoms in the crystal structure of a semi-conductor altering its degree of resistance in the quantum oval loop region of the metal box spring's continuous coupling because of the scaled down in size and distance. These mencapacitors and meninductors passive components with memory between charged and current and voltage of flux conjunction of the memcapacitors and meniductors pass through the quantum oval loop. FIG. 4 is the horizontal coupling constance, as shown in #73, #72, #76, #79, #80, #82, #84. FIG. 5 depicts the vertical traveling coupling constance connection between FIG. 1, #29 and FIG. 2, #36, and is the side view of the frame and spring hook and hole into north at #94 and connects to the loop quantum gravity hole in #99 and connects to the metal box springs with quantum electrical vertical loop wave energy at #91, #92, #93 to the loop quantum gravity oval at #90 #89, #88 in this view is #86-#99. FIG. 5 depicts the connection vertically from the incoming light signal. The drawings in FIG. 6, FIG. 7 and FIG. 8 depict the holes with the hooks and spring connecting to the grid. The different process of the springs in FIG. 6 depicts the spring being expanded and FIG. 7 depicts the spring at one-half expansion and FIG. 8 depicts the spring in a relaxed mode. The springs hooks expand from the connection of the north to the connection of the south but the holes on the west-to-east side of the frame do not expand at the spring but expand throughout the entire Hertzian grid. FIG. 7 depicts same springs as in FIG. 6 but is one-half expansion in the process of receiving gravity mode of incoming light signal. The drawing in FIG. 8 depicts the same springs except it is in relaxed re-set mode #109 through #111. FIG. 9 depicts a left northwest corner showing the two different type of hook springs connecting on to the metal frame. It also shows at #113 and #116 the top overriding connection through the quantum oval loop connection which is called a memristor. The memristor resistor is a part of the usual reconfiguring of the backward folding characteristics which resistance increases as current flows through in one direction and decreases when the current is reversed. If the current is cut off the memristor line passing through it completes its connection with or without current. The reason for this is that voltage exerts a slight chemical tracing force, subtly redistributing the atoms in the crystal structure of a semi-conductor altering its degree of resistance in the quantum oval loop region of the metal box springs continuous coupling because of the scaled down in size and distance design. These mencapacitors and meninductors passive components with memory between charged, current, and voltage produces the necessary flux at conjunction of the mencapacitors and meninductors, which is the horizontal and vertical energy flow from the lower deck at #116 and the upper deck #113-#117. FIG. 10 is a top side view between the horizontal metal box springs, #119, #121, #120, #122, #124, #125 and oval loop and the lower deck carbon-based wire vertical wave shown in #126, #123. FIG. 10 depicts the horizontal multiple-stripe wire nano-scale dimensions of this miniature universe called a metal box springs at #119 and #125 and the lower deck at #126 and the double loop quantum gravity Venn diagram overlapping connection of all oval loop coupling constance of this unified field design. FIG. 10 design encompasses the coupling constance that will cause the electrons to pass from one potential valley well to peak, to the greater or lesser complex oxide bandwidths which represent the reason for the strip parallel layering traveling north and south that the energy levels are controlling by the complex oxides that chemically react with different light frequencies and the spatial extension, expansion, contraction collapse associated with the interlocking magnetically sandwiching the incoming light wave signal. And the electromagnetic associated continuum level allows energy bands optically are thus obtained in the complex forbidden band zone. This interaction between electron spin and an applied electric field in the forbidden range area allows bandwidth connection in the forbidden bands in conjunction with the flow on the energy axis which is strong enough to produce between the different deck combination connections of this coupling constance quantum oval loop interacting, known as spin-orbit coupling, that this expanding and contracting combination design provides the traveling means of controlling spins using oscillating electric fields in the gravity-oriented vibrating metal box springs that produces a unified field design to hold the incoming light signal in this complex antenna invention. This last description of the drawings shows the difference between narrow aperture and wide aperture that is stated here and in the claims. This overall description which is of importance is the wider the antenna surface aperture of said box springs will create a straighter broadband connection that connects to one particle that travels in the same path. Furthermore, traveling in an elevator traveling vertically combines space but also spacetime together creating two particles traveling in two different paths, causing the disconnect from today's antenna's that have a narrow aperture. The major difference between the narrow aperture system and the metal box springs invention aperture is that it is a wider rectangular aperture that combines and produces the process for a straight plain constance speed in a straight line across said antenna surface plate box springs aperture at #27 and a Einstein curvature in spacetime in space across said aperture, now in spacetime which said antenna connects with both particles traveling in different paths, as shown in FIG. 1, #27, particle 1 and #29, particle 2; hence the antenna will not disconnect the radio signal from the device while traveling in an elevator that creates a two-particle connection. The overriding issue is the Einstein General Theory of Curvature, associated with this new invention antenna, which bends gravity by the flexible box springs that is transparent optically to bend light rays and in combination with Nordstrom's contradictory theory and will now fit in this dual-deck antenna process because light always goes in straight lines and in a curvature line. Therefore because of the use of new material, the multiple size of scaled distances and the specialized design, Einstein's and Nordstrom's contradictory concepts are now combined in a geometric process in this new antenna invention aperture, as specifically shown in particle 1 connection, #27 and particle 2 connection, #29.

### DETAILED DESCRIPTION OF THE INVENTION

The book, Applicability of Mathematics as a Philosophical Problem, by Mark Steiner, discusses the ideas of Maxwell, Einstein, Lorentz, Schrodinger, Heisenberg, Dirac, Gauge, and Gauss and this combination of ideas becomes the detailed abstract core for this new antenna. These combinational ideas state that this metal box springs is a Gauge transformation, an invariance of Maxwell's equation under Gauge transformation which is the Hertzian sine cosine sine metal box springs symmetry of two-stacks design which is analogues to the invariance of Einstein's equation under local arbitrary coordinate transformation's general covariance. This proved that Maxwell's equations are virtually the only equations that are both Gauge and Lorentz invariant. In this metal box springs design symmetry becomes what these men produced in physics which now becomes an antenna between general covariance and Gauge invariance which is the key to the unifying electromagnetism in combination with gravity in this miniature nano universe. Therefore, the Gauge transformation together with Lorentz transformation of special relativity determined Maxwell's equations as demonstrated in this metal box springs design. The conclusion is that the Hertzian sine cosine wave is coupled to its counterpart waveguide that is the metal box springs that moves from global to local invariance in quantum mechanics. This is equivalent to the existence of the classical electromagnetic field described by Maxwell that produces the process that is already designed in nature. Specifically, this design feature in the metal box springs is also directly related to Dirac confined radiation that was studied in a box. As stated in Physical Review Letters, Vol. 99, 24 Aug. 2007, Utilization of Photon Orbital Angular Momentum in the Low-Frequency Radio Domain by B. Thide, pages 1-4, that this metal box springs antenna is fed the same signal but is delayed by the folding refluxtivity and holding to each separation directional metamaterial sectorial zoning boundary east to west and north to south producing a complete folding under into the metamaterial plates that produce a full turn around in the antenna array axis. This directional metamaterial sectorial zoning phase has been incremented by miniature dimensions of magnetic directional far field intensity in order to fold and hold along the wave guide and down into the metamaterial substrate. The natural movement traveling vertically now travels horizontally along the wave guide of the metal box springs design. The incoming light signal now passes down into the first domain of the metamaterial substrate from left to right, right to left of the directional magnetic sectorial zoning being directed by the electrical fields vectors, as shown on page 2 of the Thide article, arrows on the diagram's main lobe beams. The key to this metal box springs design is the miniaturized nano-sized universe coupled with the advent of metamaterials superconductors and complex oxides that when put in the nano-sized world becomes a gigantic celestial state of space time which makes this a novel, unified full-field, information-rich radar, and wireless communication concept methodology that can be used for a perfect receiving and sending antenna. Dirac's symmetrized form of the Maxwell-Lorentz electro-magnetic and Einstein's theory of gravity's unified field theory and the existence of a vast spatial distance on a nano-scale produces a monopole in a nano-miniature universe that creates a full aperture reception at 20 mm×30 mm. This metal box springs is the design combination box associated with Dirac energy that crisscrosses diagonally in Maxwell's theory which gives the radiation as a superposition of countability on the surface of the top plate. The metal box springs cladded parallel stripe modes which are the layered superconducting wire and cladded complex oxides parallel to the metal box springs for frequency, zone manipulation of the spectrum. This creates a harmonic oscillator which is controlled by the metal box springs waveguides design vibration from the idea of gravity and light associated with Lorentz's relativity of a universal matrix. Each harmonic oscillator can be quantized, according to Schroedinger's equation, or Heisenberg's equivalent approach. Therefore, the quantized field, then, is the flat multi-dimensional superposition of countability of many flat horizontal layered crystal superconductors on a metal box springs bed now used to control the vibration of receiving thousands of light signals hitting the top deck of this refluxtivity antenna. This process of refluxtivity traveling coupling constance motion of many thousands of incoming light signals will control the frictional vibration so that the light signal can fold back in upon its metamaterial directional sectorial zoning stacks of layered plates. This dual design contains second derivatives of space between its symmetry of miniature nano size and the helium-4 down to the second deck's electrically charged reflective mirror plates. FIG. 1, the entire design, and FIG. 10 show this metal box springs design's coupling constance of the metal box springs which is between the crystal plate and on to the surface energy movement in this band gap Hertzian waveguide that runs electromagnetically between the open spaces of the wire design optically. This is called an invisible energy movement described as a Saint Andrew's diagonal matrix energy movement across the plane on top of the metal box springs waveguide wire layerings of superconductors and complex oxides which makes a constance coupling junction from the metal box springs design, as shown in FIG. 10. This conjunction is an interdigital design electrodes of oval loop quantum gravity, #119-#126 which shows the spatial broken crossing symmetry of FIG. 10 that is the core of the constance coupling embodiment that is described in the specifications and claims in the invention, as is applied to all FIG. 10's noted in this invention. As stated in Nature article, Vol. 468, 11 Nov. 2010, pages 184-185, Mind the Pseudogap, by Chandra Verma, and the Letter article, Vol. 468, 11 Nov. 2010, pages 283-285, Hidden magnetic excitation in the pseudogap phase of a high-Tc superconductor by Yuan Li, that on pages 184 and 283 of these issues, Li, et al., reports observing a special kind of intense collective electronic fluctuation in the most mysterious phrase of matter exhibited by high-temperature superconducting copper-oxides materials. As shown in FIG. 1, page 184, phase diagram of the cuprates depicts the strange-metal region of a quantum critical point of sectorial zoning areas between antiferromagnetic materials and neighboring spin points in opposite directions. This is depicted in the invention FIG. 10, #121, #124 and between the crossover at #123. This crossover line in FIG. 10, #123, is a combinational transitional phase connecting all three designs to produce the electric holding of the incoming incident wave that is being directed by the Saint Andrews energy phase across the surface of the crystal plate and down on to the metal box springs and on to the quantum oval loop shown in FIG. 10, #122 and coupling to the lower deck of the quantum electrical vertical loop connection in FIG. 10, #123 and #126. This magnetic gap transition is a gradual crossover between all quantum oval loops of thermodynamic and electric transport properties. As stated in this invention, the multiple alternating layers of yttrium barium in which the quantum critical point is the cladded parallel complex oxides that create the frequency jumping of the multiple spectrum contradictions directed on to the top of the oval loop, creating a double overlapping dome in which to create a loop dome-shaped superconducting design region of this phase, as depicted in FIG. 10, #122. This dome extension point is a build-up of energy fluid placed on top of the oval loop region which occurs at zero temperature and would involve a change in symmetry expansion of the material's electronic structure as shown in FIG. 10, #119 through to #126. Because the high-Tc superconductor is determined by the materials' collective electronic excitations combinations in the non-superconducting state which is the constance coupling of electrons downward into the connective design to this excitation in the strange metal region of the oval loop which is the connection to the metal box springs and the quantum oval and quantum electrical vertical loop, as shown in FIG. 10, #119, #120, #126, #125. This produces a long-range order phase in the spectrum in which pairs of electron current vertical loops flow within each of the materials unit cells or upper and lower deck which is called quantum oval loop connection to the electron current vertical loop and produces a pair of oppositely directed magnetic movements, as shown in FIG. 4, #80 and #84 which is the lower deck crossover. The change of symmetry is indicated in the metal box springs ability for expansion and contraction movement vibration; therefore, these modes of fluctuations from these design materials across the directional sectorial zoning of metamaterials' opposite magnetic flow in nature are being controlled by the energy of Saint Andrews finite movement across the quantum oval loop and lower deck current quantum electrical vertical loop order, as shown in FIG. 4, #76, #79 overlapping #80. As shown the Chandra Varma, et. al., article, FIG. 2, the loop-current electronic order unit cell shows a negative one side and a positive on the other side on each end of the cell. This is also shown in the quantum oval loop showing a negative Venn diagram overlapping to create the double dome flux connection, as shown in FIG. 10, #121 and a positive Venn diagram overlapping connection, as shown in FIG. 10, #124. Both the article diagram and this invention's diagram are one and the same, showing the connection of the complex copper oxide CuO material onto the metal box springs overlapping the quantum oval loop depicted in the overall design of FIG. 10 and the quantum electrical vertical loop, as shown in FIG. 10, #126. Because of the size-distance and thick widths and metal box springs arrangement of the parallel superconductor wire and parallel complex oxides that travel down into the metamaterial substrates and the fluctuations of the width creates the different band widths because of the multi-layerings due to the variation of the medium's parameters, such as the dielectric constant, magnetic permeability, or barrier height for electrons in mixed systems such as this metal box springs method allowing the redirection to transport frequencies along the multi-layering dual deck system. This will not impede the transport along these boundary layered reversing ferro-nano separators that will not impede the frequency energy of the electromagnetic electron waves because of its optical nano-miniature design structure. This is not a conventional photonic stack so over barrier scattering transport is a good thing because each chemical oxide depends on all the rest during the transport of the incoming light wave for controlled placement. This multi-layered metal box springs Lorentzian line shape now centered on the longitudinal vibration frequency based on the bunk bed springs to bounce this vibrational wave relative magnitudes to transverse and flip-flop longitudinal refluxtivity folding at the edges of the cross sections of the scattering geometry and on the relative sizes distance separation and design of the parallel stripes multi-layerings that are cladded on to the wire line of the box spring waveguide that have opposite signs for many Zinc-blend structures in this crystal substrate, Hertzian wave design such as GaP, Faust and Henry 1966 and GaAs, Johnston and Kaminow 1969 and also have the same design in other crystal structures, Scott et al., 1971, and also the angular variations of polar-mode frequencies in biaxial crystals are those of Quilichini and Poulet 1974 on BaZnF₄ and of Quilichini 1975 BaMgF₄ orthorhombic with 27 polar modes in combination with uniaxial crystals ferroelectric BaTiO (Pinczuk et al., 1969, Laughman et al., 1972, Heiman and Ushioda, 1974, LilO₃ and BeO are all layered in the parallel spacing alternating alongside the north and south of the metal box springs wire multi-layering wave design on both deck plates of this antenna. Directly above is a listing of complex oxides and the listing of the complex oxides on pages 29 and 30 of the specifications of this document are a combination reflecting the use and placement in the same area that the specifications indicate. These complex oxides which housed free electron plasma and the plasmon frequency behavior are imbedded in the metamaterials substrates which are comprised of n-Si and n-Ge which have multi-layered conduction bands which support a richer variety of collective modes. This is discussed in the book, Scattering of Light by Crystals, by William Hayes, Dover Publications, page. 6-336. The Maximality Principle leads to the wave-particle duality, to interference phenomena which only arises when the coupling constance makes a nonuniform change of phases; therefore, this metal box springs has many momentum coordinates which is enough to position coordinates that can change because of the repetitive coordinate coupling constance design of this metal box springs. This quantum field grid miniature universe metal box springs, according to the science world and all visual experimental evidence and scientific thought, leads to a design invention for a nano-antenna. The Lorentz-Bose-Einstein-Maxwell invariance in this design is the equivalence of all inertial systems that require crossing symmetry refluxtivity folding and holding the light signal by a directional magnetic metamaterial plate substructure. This feature of this metal box springs rectangle of subatomic collision of metamaterial complex oxides imbedded into optical crystals is Pythagorean in design and in temperature it is near zero. In this metal box springs the scattering is in the spatial size that the incoming light signal passes through and conducted in a refluxtivity before the scattering collision and is already guided along the controlled complex oxide optical pathways to gravity's vibrating wave guide of the metal box springs to the directional magnetic metamaterial folding under of said light signal and crossing the Hertzian symmetry which is exactly what the electron moving backwards in a memristor time hooking and a refluxtivity fold and hold on both decks of this solid state and gas-oriented quantum antenna. And as proven in Wilczek 1991 experiment as shown in The Applicability of Mathematics as a Philosophical Problem by Mark Steiner, page 12, FIG. 4, particle 1 incoming from west, particle 2 coming from the east, particle 1 arrives at 135 degrees and the other at 315 degrees. Particle 1, incoming from the west to east is deflected backwards at an angle of 45 degrees from its path, is a refluxtivity fold. And particle 2 which is deflected forward at an angle of 135 degrees from its incoming path is done by the cutting edges of the layered crystal. The loop quantum gravity in FIG. 1, #7, is a mirror image in the substrate plate, FIG. 2, #36, #43, #48 and is called radio frequencies and it becomes the coupling constance in this resonant system of optical frequencies nanoscale highly polished gold metamaterial rectangle plate substrate where the folding and holding of collective oscillations of free electrons is known as imbedded surface plasmons, approximately 100 nm thick. The edge of north-south-east-west on this plate frame becomes a phenomena in design, unknown to classical mechanics until all of the mechanics are applied in a complete miniature size that will create the spin fold and hold of where the antimatter begins that produces this refluxtivity folding and holding of the spin up and hold spin down into the prepared cavity of the crystal aperture. This constance coupling connection is where the continuous constant holding of the collection of the incident light signal that is scattering onto the surface plate of this invention that now uses Dirac's antimatter concept of negative energy connecting with the negative indexing of metamaterials, which can now be reconnected and applied to this Gauge transformation together with Lorentz's transformation of special relativity refluxtivity determined by Maxwell's equations that become truth when placed and designed on a nano-local invariance in quantum mechanics which will be the new unified field reality equivalent to the existence of the miniaturized classical electromagnetic field being applied in nano-spacetime coupling constance continuum on the dimensions of a nano unified field quanta using these photons in this space-time miniature nano-continuum quantum antenna being presented for a patent.

What is claimed is:

1. In a 1 mm super-thin device for producing a quantum broadband frequency containment refluxtivity receiver-effect antenna, comprising:
(a.) a transparent crystal metamaterial, complex oxides layerings of piezoelectric substrate fashioned into a surface rectangle 20 mm×30 mm aperture and a 1 mm thick dual-deck metal box springs that lies flat on to said devices such as cell phones.
(a.) There are Abelian-Gauge gravity dual-deck stack layering crystal directional metamaterial sectorial zoning controlling paths carrying energy along said Hertzian sine cosine metal box springs wire design integrated to the quantum oval loop combination of said interdigital electrodes along a substrate plate form complementary composite with a quantum electrical vertical loop under layer of carbon wire connecting to the horizontal top deck of the metal box springs of said quantum oval loop interdigital electrodes introducing on the surface of said radiationally sensitively prepared substrate top plate of antenna that receives the incoming acoustic gravity light waves #6 in response to a very low electrical signal from said electrical signal source of the cell phone applied to said metal box springs interdigital electrodes #29 zero order rediffracted beam #36 illuminating light beam from said light source introduced into said substrate #11-#33 through the edge of said top plate #27 through the empty hole establishing a running coupling constance down into the cavity of said prepared crystal according to prepared plate distance scales connecting to the metal box springs at #27 and #29 zero order rediffracted beam #36 through a side adjacent to the side with said interdigital electrodes #6 repetitively connected to the parallel complex oxide claddings alongside of the metal box springs design, said beam being directed at said side edge of crystal at an angle such that the white light beam is split into prismatic internal reflection near the grazing incidence of the entire active surface where the acoustic waves of entire rectangular box's embodiment waves are guided and generated and said wave glides its energy electrical plane on surface of magnetically sensitive geometric movement of the Saint Andrew's Cross that moves diagonally opposite the direction of acoustic waves, the input beam being split and drawn in through to the active surface edge that begins the folding edges under said crystal plates layerings in a zero order that travels through, to the layering of prismatic diffracted redirectional splitting off into color spectrum and on to the Hertzian parallel layering of the complex oxides stripes that create the different bandwidths segregations that travel down along the quantum oval loop interdigital electrodes.
(a.) Quantum wire metal box springs made of a superconductor layered wiring design in a Hertzian sine cosine box springs bed, whether particles, devices arrays on or near the surface and edge to empty holes along the frame of said antenna layered multiple repetitive doped oxides create the different selection of bandwidths on the parallel wires distance in a wave design, which traps, receives, sends, records, holds, and folds said light signal down into the next plate layered deck form to hold said light wave signal and frequency modulation conversion on to this dual configuration antenna directivity diagram of charged carriers based on the strongly coupled ferromagnetic complex oxide and many-body anti-de-Sitter conformal AdS/CFT loop quantum gravity geometry and breaking boundaries in order for the Saint Andrew's energy-sensitive diagonal electromagnetics energy or energies in said control paths on top of both receptive decks, thus forming the retrodiction refluxtivity positive negative electric-optical holding and folding: of the Hertzian sine cosine light waves in a controlled conformal design by the Hertzian sine cosine waveguide position to align with a Hertzian sine cosine box spring directional magnetic metamaterial doped crystals multi-layered design. The design pattern itself is a running, traveling coupling constance down into the crystal cavity which produces the unified field design distance scales in order to create the connective wave associated with manmade metamaterials to enable the light signal to never disconnect from its applied device such as a cell phone even if the phone is in a deep tunnel or in an out-of-the-way place.
Whereby said metal box springs embodiment of the specifications and in these claims that said broadband antenna radio signal will not disconnect from the invention and the device that said invention is connected to that which is being applied to in order to hold the incoming radio signal because the Mossbauer effect is now corrected through the use of manmade negative refractive directional metamaterials based on the fact that light emitting signals in this mismatch of nature is now being corrected through the means that uses directional metamaterial magnetic sectorial zoning of manmade metamaterials left-handed double refracting negative optical corrective refractive connection produced by metamaterials that re-connects natures frequency mismatch between the absorptions magnetic permeability of the left-handed optical metamaterial and dielectric permittivity emission in order to have unnatural correction on both mismatches in order to make these two natural and unnatural mismatches re-connect in position altitude separation breaking disconnect to holding and connecting said broadband frequencies is now re-connected optically through the use of said metamaterials to magnetically hold on the metamaterial sectorial, directional boundary in order to connect and re-connect the re-matching of the said spectral frequency broadband for it then to continue on its processed phase through this media that enables said signal to never disconnect from the cell phone whether in a deep tunnel or out-of-way places to never disconnect the transmission signal from said cell phone.
Whereby said superconductor wire layered alongside are complex oxides can serve as the manipulation of the broadband spectrum upon first contact of light wave conversion convection to the horizontal and vertical flat rectangle frame metal box springs surface of this antenna is not a narrow aperture but is a wide aperture of said box springs and which will create a straighter broadband connection that connects to one particle that travels in the same path. Furthermore, traveling in an elevator traveling vertically combines space but also spacetime together creating two particles traveling in two different paths, causing the disconnect from today's antenna's that have a narrow aperture. The major difference between the narrow aperture system and the metal box springs invention aperture is that it is a wider rectangular aperture that combines and produces the process for a straight plain constance speed in a straight line across said antenna surface plate box springs aperture at #27 and a Einstein curvature in spacetime in space across said aperture, now in spacetime which said antenna connects with both particles traveling in different paths, as shown in FIG. 1, #27, particle 1 and #29, particle 2; hence the antenna will not disconnect the radio signal from the device while traveling in an elevator that creates a two-particle connection. The overriding issue is the Einstein General Theory of Curvature, associated with this new invention antenna, which bends gravity by the flexible box springs that is transparent optically to bend light rays and in combination with Nordstrom's contradictory theory and will now fit in this dual-deck antenna process because light always goes in straight lines and in a curvature line. Therefore because of the use of new material, the multiple size of scaled distances and the specialized design, Einstein's and Nordstrom's contradictory concepts are now combined in a geometric process in this new antenna invention aperture, as specifically shown in particle 1 connection, #27 and particle 2 connection, #29.
Whereby the quantum electrical vertical loop continuous coupling constance induced by electric current on the lower deck and optical metamaterial of the metal box springs antenna in combination with electro-magnetic and gravity coupling to the upper deck and the complex oxide Hertzian wave pattern of superconductor wire properties of said crystals design box springs connecting incoming signals that can be manipulated through the crystal oxide mixture adjustments that are parallel aligned to the metal box springs and the energy transformation between light signal and complex oxides selectors and metamaterial directional holding the spectral paths, and
Whereby said complex oxides running parallel to the metal box springs for selectivity of the full broadband spectrum that is aligning onto the design parallel layered oxides that are embedded in the two decks of crystal plate layering in combination in between, the boundary separation areas and the directional magnetic negative refractive metamaterials to serve as a selective holding and folding upon the turning clear light into color prism beams splitting effect which is capable of altering the electro-optical frequencies through contact with the layered wire metal box springs that travel into the substrate complex oxide parallel design and down into the cavity of the directional magnetic metamaterials for holding and folding of said light signals are trapped in sequence along the sectorial zoning separation line that is the area of the holding and folding of said light wave and is waiting to be bumped into the crystal electrodes complex oxides and double-mixed iron-based dome oval overlapping of the quantum oval loop and the quantum vertical lower-deck electric connection to FIG. 10 in real time based on the superconducting electricity being applied for suppression, compression and expansion process onto the metal box springs and parallel complex oxides by use of electric, magnetic and gravity source connecting to radational energy of the incoming light wave signal on to the light sensitive receptive surface coupling onto the Saint Andrews Cross movement of energy across said surface and into all said loop quantum gravity electrodes in the rectangle coupling constance field of complex oxide parallel Hertzian control paths, selectors of said paths and
Whereby this quantum critical point of the quantum oval loop in FIG. 10, #122 region and point of said line #123 and FIG. 9, #116 line phase transition coupling that separates on said gap between metal box springs and quantum oval loop is the pseudogap transition crossover phenomenon and electronic holding of the incoming light signal between this gap which produces a pair of oppositely directed magnetic movements, in FIG. 4, #80 and #84 that holds said incoming light signal in place between the two decks and moving of incoming signal controlled by the Saint Andrews cross light-sensitive electro-optically magnetically placing the incoming said signal on to the metal box springs design.
Whereby these three design modes of connective fluctuations between gravity state and electromagnetic state is controlled by manmade metamaterials that direct said finite energy at all point movements that are done in this quantum oval loop transition, in FIG. 10. This mode of fluctuations between the complex oxides parallel design and the metal box springs Tc superconductors wires and the different level of charged carriers of said electron connecting onto said directional negative refractive metamaterial sectorial zoning of the magnetic polarized opposite neutron that is being controlled by manmade metamaterial properties in the strange phenomenon zone that reconnects what nature separates from the position below the metal box springs and quantum oval loop connection phase and the d-wave symmetry of the metamaterial electron magnetic structure in combination with the complex superconducting phase to control the folding and holding of the said incoming light signal.
Whereby the light wave Hertzian sine cosine in said metal box springs design can be directed, folded, held in place on the folds to receive, send, record, decipher which never disconnect according to the effect between the complex oxide superconductor separating light into prismatic color frequencies, which are re-arranged in two-deck process dimensional structures, the sectorial boundary zone separations of magnetic metamaterials become selectors and holders whose characteristics are electro-optically programmable in real time by means of the diagonally spatial boundary movement separating between the Hertzian wave in the loop oval quantum gravity junction which brings into play the full field design that connects the said energies in said control transition transistors paths.

2. The device of claim 1 wherein said control transition electrodes and transistors paths are electrical magnetically clear complex metal oxide parallel Hertzian crystal wires formation, whether conductors, semiconductors, or superconductors and a combination in design, which carry electro-optical voltages.

3. The device of claim 1 wherein said control transitional transistors complex oxides interdigital electrode paths of the Hertzian sine cosine metal box springs are complex oxide transparent doped superconductors crystals and parallel the wire box spring design that transports multiple light spectrum energy ranges that span radio waves, microwaves, submillimeter, infrared, terahertz, visible light, ultraviolet x-rays and gamma rays, all within this Hertzian complex oxide selectors that encompass these broadband functions in the metal box springs wave design antenna.

4. The device of claim 1 wherein said control transitional electrodes and transistors paths range from x-rays radio waves, microwaves, submillimeter, infrared, terahertz, visible light, ultraviolet x-rays and gamma rays, all within this broadband flat metal box springs Hertzian antenna.

5. The device of claim 1 wherein the quantum broadband antenna are a transparent doped superconducting layered crystal design imbedded in a repetitive design form on the line and opposite bottom substrate design of the metal box springs, creating interdigital electrodes.

6. The device of claim 1 wherein the quantum nano broadband metal box springs produces multi-kinds of frequency dividers, frequency doublers, frequency relay, frequency scanner, holder of refluxtivity of the light wave being trapped in between the oval loop quantum gravity coupling constance connector that connects to the dual stack in a unified field design of a Lorentz invariant and Gauge invariant process.

7. This directional negative refractive metamaterial magnetic boundary left-handed separator spin up and spin down design method is for controlling the said light signal wave for process folding and holding conversions and selectivity of different spectral frequencies through the use of these controlling complex oxide dopants Hertzian design and said directional magnetic metamaterials sectorial zoning in the interior cavity of this bulk stack plates comprised of said directional metamaterials boundary separators and holders called sectorial zoning opposite magnetic areas of said crystal, comprising:
(a.) Confining and suppressing of charge carrier in layered solid medium is the piezo-electric crystal, and said compression of said light wave signal in said crystals generates an electrostatic voltage across the Saint Andrews cross making a cross upon which electric current will travel across said surface which will conversely produce application of a small electric field which will cause the crystal to expand and contract which the metal box springs will respond to the massive incoming light signals gravity through to said frictionless helium-4 liquid crystal in which said substrate is immersed in a dimension smaller than the De Broglie wave length of said carriers, such that the carriers that the folding process of refluxtivity re-emission of the backward quantum wavelike behavior created in both decks that are electro-magnetically held and flattened into a compressed sectorial zoning area of the directional metamaterial magnetic reversal boundary layering lines.
(a.) Carrying electro-optical energy through loosely doped empty holes; these 36 empty holes are toroidal dipolar magnetic holes used to produce toroidal rotation symmetry to rotate polarization of the incoming light signal, coupling constance connection of negative index of refraction, interacting between electrical currents producing toroidal monopoles in all the 36 empty holes on the edge frame of said metal box springs grid that now is connected to and by the spring hooks. This was reported in the Science article, “Toroidal Dipolar Response in a Metamaterial” by T. Kaelberer, 10 Dec. 2010, Vol. 330, pages 1510-1512. The article on page 1510 specifically depicts the empty holes in FIGS. 1, A, B and C, doped wires, doped chirial springs, doped quantum electrical vertical loop metal wire waveguide and doped crystal high temperature superconductor conduits to said carriers while embedded between the transparent solid liquid helium-4 gas which optically converts in conjunction with complex oxides, Hertzian wave guide down into said directional metamaterials with said energy directly contacting into the cavity of the negative refraction of said metamaterial magnetic reversal boundaries to reconnect what nature disconnect through the said frequency selectors and converters to hold said light signal for said signal to never disconnect from said device.
Whereby said carriers are formed by configuration conversion Hertzian waveguide sine cosine metal box springs parallel cladded complex oxides which are capable of serving as programmable dopants to alter the incoming electro-optical selection of frequencies in multiple array combination with manmade directional metamaterial magnetic line spatial gravity compression, expansion, and linear contraction of said metal box springs and metamaterial substrate plate crystals in real time, and
Whereby a multi-parallel cladded complex oxides dopened-crystal-layered metal box springs method in design is combined, creating a means for producing the selective broadband frequency ranges all within a flat rectangular aperture whose electro-optical frequencies are divided properties in the full spectrum range by said magnetic, gravity electro-optical chemical dopent properties materials that will produce multi-kinds of frequency selectivity simultaneously and massively across the full spectrum frequency range modulation that covers the full field spectrum phase modulation taken from the scanning of the prism-opal top surface to the reflective color prism separators that travel and connect to the quantum oval loop coupling constance to create a nano-miniature universe in this unified field design phenomenon on a nano-micro-macro scaled design imbedded in a transparent crystal plate.

8. The method of claim 6 wherein the means of confirming said charge carriers of the multi-layering complex oxide superconductor wire configuration in a repetitive parallel design of this metal box springs design that produces the holding, folding and reconnecting what nature disconnects; these negative refractive directional metamaterials reconnect to produce the quantum broadband full spectral line processing on this antenna; and said conduits are consolidated into a coupling constance transition translational onto the directional negative refractive metamaterial substrate that is a transparent crystal stack for holding and folding to which said quantum broadband design is attached in a complete design to produce a new antenna aperture with no outside or inside interference and no improper entanglement of frequencies on the spectral ranges with manmade metamaterials that enable the follow through conduction in order to hold and fold which this antenna device is claiming.
